(19) United States
(12) Patent Application Publication
(10) Pub. No.: US 2025/0011348 A1
(43) Pub. Date: Jan. 9, 2025

(54) Synthesis Process of X-IPM, Stable Crystal Form and Application Thereof

(71) Applicant: ASCENTAWITS PHARMACEUTICALS, LTD., Shenzhen (CN)

(72) Inventors: Jianxin Duan, Shenzhen (CN); Zhaoqiang Lu, Shenzhen (CN); Xiaohong Cai, Shenzhen (CN); Jinwei Fan, Shenzhen (CN); Wei Qin, Shenzhen (CN); Qunhui Huang, Shenzhen (CN); Yanjun Zhang, Shenzhen (CN); Weisu Chen, Shenzhen (CN)

(21) Appl. No.: 18/209,314

(22) Filed: Jun. 13, 2023

(51) Int. Cl. C07F 9/22; C07F 9/02; C07F 9/564; C07F 9/572; C07F 9/6506; C07F 9/6539; C07F 9/655; C07F 9/6553; C07F 9/6558; G01N 30/74; G01N 30/86

(52) U.S. Cl. CPC C07F 9/22; C07F 9/025; C07F 9/564; C07F 9/572; C07F 9/6506; C07F 9/6539; C07F 9/65515; C07F 9/655345; C07F 9/65583; C07F 9/65586; G01N 30/74; G01N 30/8631; C07B 2200/13; G01N 2030/027

(57) ABSTRACT

The present application relates to a new method for synthesizing isophosphoramide nitrogen mustard (X-IPM) that is suitable for industrialized production, involves fewer types of solvents, and leads to stable products with high yield. This method is charazterized mainly by the batchwise addition of M (e.g., M is R₃N with R being ethyl; i.e., M is triethylamine) and the specific post-reaction treatment, which make it possible for the reaction to fully proceed, lead to products with less impurities, high yield and relatively stable properties, and can lead to stable crystallized substances with specific crystal structures. The present application also relates to stable crystal forms of the isophosphoramide nitrogen mustard (X-IPM) prepared by the aforementioned method, and use of the same as reactants for the synthesis of aziridine structure-containing compounds.

### TECHNICAL FIELD

The present invention relates to a process for the synthesis of X-IPM (a compound which is a key intermediate for synthesizing TH-302 analogues and aziridine structure-containing anticancer drugs), and stable crystal forms and uses thereof, belonging to the field of pharmaceutical chemistry.

### BACKGROUND ART

Alkylating agents used in cancer chemotherapy encompass a diverse group of chemicals that have the ability to alkylate the biologically vital macromolecule DNA under physiological conditions (see Hardman et al., The Pharmacological Basis of Therapeutics, 2001, 1389-1399, McGraw-Hill, New York, USA). Isophosphoramide nitrogen mustard has been proved to have the effect of killing tumor cells, and if the active alkylators are released away from the tumor, DNA and other nucleophilic moieties such as the phosphate, amino, sulfhydryl, hydroxyl, carboxyl and imidazolyl groups of biomolecules of healthy non-cancerous cells, can get alkylated. Such alkylation of healthy cells can result in unwanted toxic events in patients. Therefore, it is necessary to link isophosphoramide nitrogen mustard to a group which can specifically target tumor cells, to form a relatively stable new compound, which is stably present in normal healthy cells and metabolized out of the body, or is metabolized into a non-toxic compound in healthy cells and excreted from the body. In tumor cells, under the action of specific enzymes, this new compound releases isophosphoramide nitrogen mustard, thereby specifically killing the tumor cells.

TH-302 (Evofosfamide, CAS No. 918633-87-1) is a 2-nitroimidazole-induced hypoxia-activated prodrug (HAP) of bromoisophosphoramide. Under hypoxia condition, an inactive TH-302 prodrug can release the highly toxic isophosphoramide nitrogen mustard (Br-IPM). TH-302 has a broad spectrum of in vitro and in vivo biological activities, specific hypoxia-selective activation activities, and activities of inducing H2AX phosphorylation and DNA crossing-linking, and thus cell cycle arrest. Therefore, this compound is used by many pharmaceutical companies and scientific research institutes for the development of anticancer drugs.

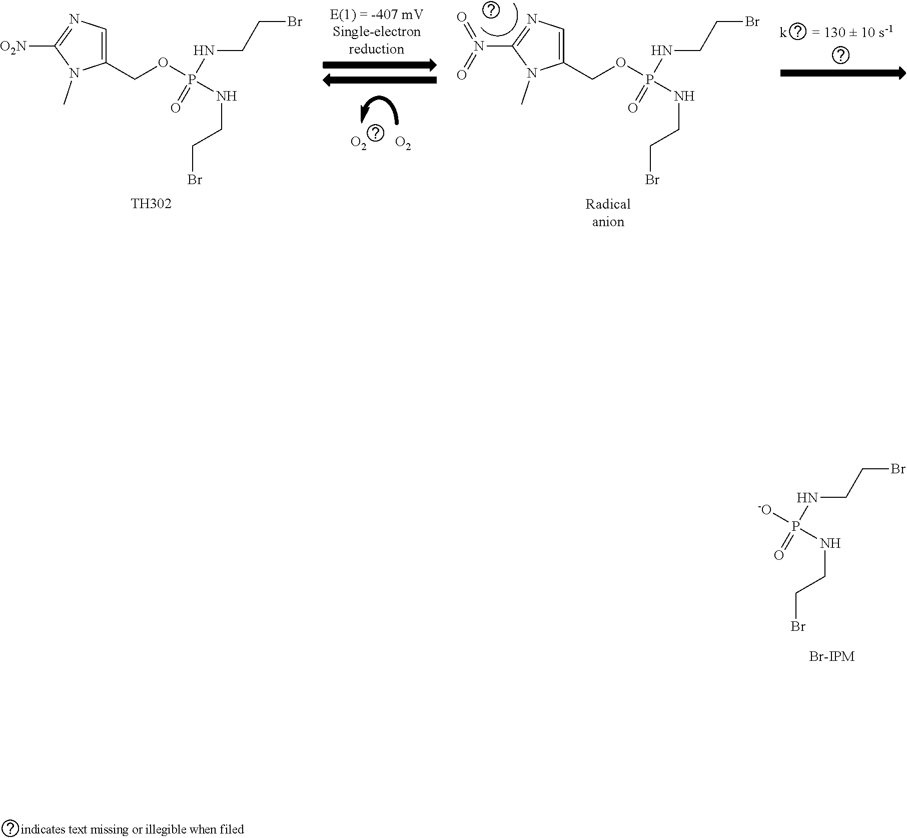

The Class One new drug developed by the applicant, AST-3424, which is a DNA alkylating anti-cancer agent targeting overexpressed aldo-keto reductase 1C3 (AKR1C3) (Patent Document 1: DNA Alkylating Agents (PCT Patent Application No. PCT/US2016/021581; Publication No. WO2016/145092A1, which corresponds to Chinese Application No. 201680015078.8; Publication No. CN107530556A)) is an aziridine structure-containing compound, which is a derivative of isophosphoramide nitrogen mustard and is formed by the ring-closure reaction of isophosphoramide nitrogen mustard; the compound is currently in phase II clinical trials in both China and the United States

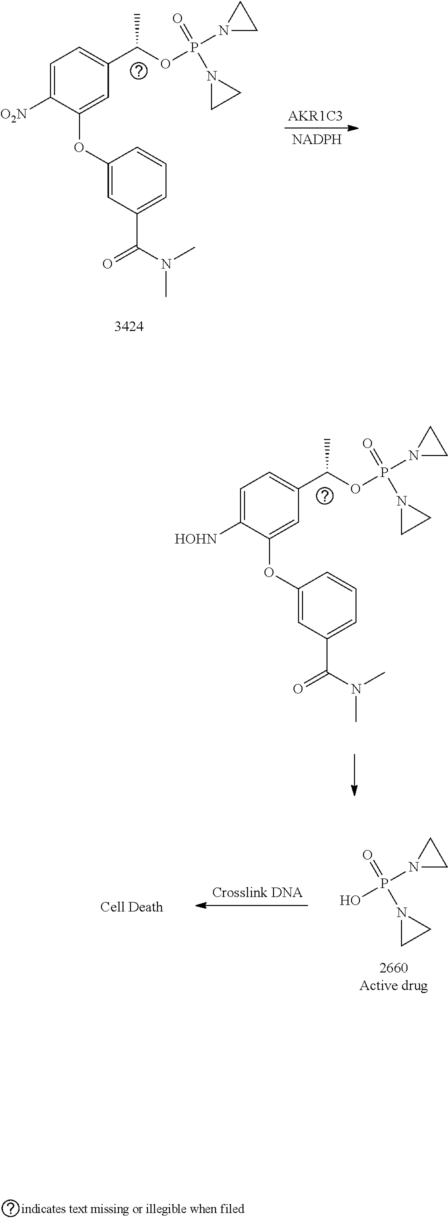

Another class of AKR1C3-activated drugs designed by the applicant is also a derivative of isophosphoramide nitrogen mustard, and is an aziridine structure-containing compound formed by the ring-closure reaction of isophosphoramide nitrogen mustard (Patent Document 2: PCT/CN2020/089692 (Publication No. WO2020228685A9), which corresponds to Chinese Application CN2020800355889.0).

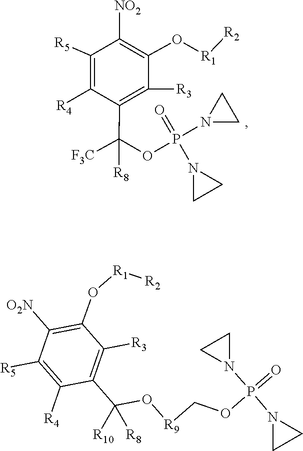

Analogously, the patent application WO2021068952A1 (Patent Document 3) filed by MEDSHINE DISCOVERY INC. also discloses a similar aziridine structure-containing compound.

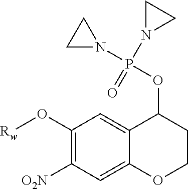

All of the above compounds can be synthesized from isophosphoramide nitrogen mustard. Therefore, the synthesis of isophosphoramide nitrogen mustard has become a key step in the synthesis of new compounds that specifically target tumor cells. The inventors Duan Jianxin et al., have disclosed methods for the synthesis of Br-IPM or Cl-IPM in patents CN102746336A and US20190127404A1, but the methods have relatively low yield. X-IPM, Cl-IPM and Br-IPM have the following structural formulae:

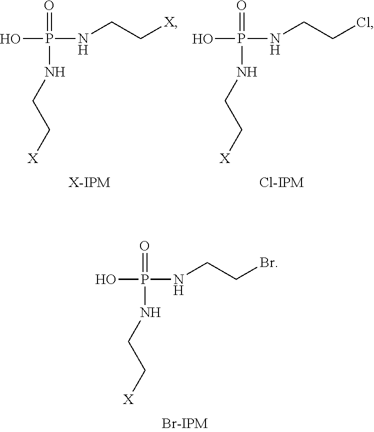

The inventors Duan Jianxin et al., have presented the following methods for the synthesis of Br-IPM or Cl-IPM.

### Method 1

To a solution of 2-bromoethylammonium bromide (19.4 g) in DCM (90 mL) at 10° C. was added a solution of POCl₃ (2.3 mL) in DCM (4 mL) followed by addition of a solution of TEA (14.1 mL) in DCM (25 mL). The reaction mixture was filtered, and the filtrate was concentrated to ca. 30% of the original volume and filtered. The residue was washed with DCM (3×25 mL) and the combined DCM portions were concentrated to yield a solid to which a mixture of THF (6 mL) and water (8 mL) was added. THF was removed in a rotary evaporator, and the resulting solution chilled overnight in a fridge. The precipitate obtained was filtered, washed with water (10 mL) and ether (30 mL), and dried in vacuo to yield 2.1 g of Br-IPM (it is calculated that the yield is 27.46%).

The Br-IPM synthesized by this method has relatively low yield. Cl-IPM can be synthesized employing the same method as above, except that 2-bromoethylammonium bromide is replaced with 2-chloroethylammonium chloride.

### Method 2

2-Bromoethylamine hydrobromide (1:1.0 w/w) and POBr₃ (1:0.7 w/w) were dissolved in DCM (1:2 w/v) under nitrogen atmosphere. The reaction mixture was cooled to −70±5° C. Triethylamine (1:1.36 w/v) in DCM (1:5 w/v) was added to the reaction mass at −70±5° C. The reaction mass was stirred for 30 min at −70±5° C. The reaction mass was warmed to 0±3° C. and water (1:1.72 w/v) was added. The reaction mixture was stirred at 0±3° C. for 4 hrs. The solid was obtained by filtration and filter cake was washed with cold water (2×1:0.86 w/v) and then with chilled acetone (2×1:0.86 w/v). The solid was dried at 20±5° C. to obtain Br-IPM.

### SUMMARY OF THE INVENTION

In both the above methods 1 and 2 for synthesizing X-IPM, the dichloromethane solution containing triethylamine was added to the reaction system in a single addition, and the temperature at which POCl₃ or POBr₃ was added was not precisely controlled. The applicant carried out repeated experiments by referring to these methods, and found that the methods had low yield and involved many types of solvents, which led to complex operation, making those methods not suitable for industrialized large-scale application.

In addition, the applicant found in the repeated experiments that the X-IPM synthesized by the above methods 1 and 2 had poor stability and must be prepared on site every time it needs to be used.

Therefore, the applicant carried out experimental exploration and improvement, and finally proposed a method of adding triethylamine or its analogues many times, carrying out reaction under different temperature conditions in batches, and carrying out post-treatment to obtain a product with high purity and high yield, which is identified to have a stable crystal structure and can serve as a stable intermediate for the synthesis of the drugs in the aforementioned Patent Documents 1-3.

The present invention proposes a new method for synthesizing isophosphoramide nitrogen mustard (X-IPM) that is suitable for industrialized production, involves fewer types of solvents, and leads to stable products with high yield. This method differs from the prior art mainly in that R₃N (e.g., R is ethyl; i.e., R₃N is triethylamine) is added in batches depending on the size of the reaction system, making it possible for the reaction to fully proceed, and leading to products with less impurities and relatively stable properties; after post-treatment, crystallized substances with specific crystal structures can be obtained.

The present invention provides the following technical solutions.

A process for producing X-IPM of formula III, comprising the following steps:

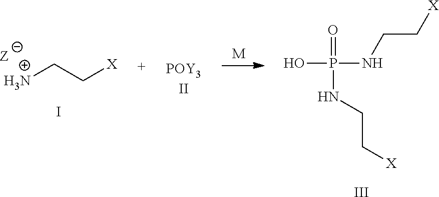

(1) mixing dichloromethane with 2-haloethylamine hydrohalide I, starting stirring and setting the temperature down to −70° C. to −60° C., and when the temperature is reduced to −30° C. to −20° C., adding phosphorus oxyhalide II;
(2) adding dropwise a solution of compound M in dichloromethane in batches at a temperature range of −70° C. to −40° C.:
\textcircled{1} for the first dropwise addition, the solution of compound M in dichloromethane comprises compound M in an amount 1.8 to 2.2 times the molar equivalent of phosphorus oxyhalide II, and the rate of the dropwise addition should ensures that the temperature change of the reaction system is within 10° C.;
\textcircled{2} for the second dropwise addition, the solution of compound M in dichloromethane comprises compound M in an amount 0.9 to 1.1 times the molar equivalent of phosphorus oxyhalide II, and the rate of the dropwise addition should ensures that the temperature change of the reaction system is within 10° C.; and
\textcircled{3} for the nth dropwise addition, the aforementioned dropwise addition step is repeated, the temperature of the system is increased by 5° C. to 15° C. with each addition, and the molar equivalent of compound M is decreased with each addition since the second dropwise addition;
(3) after the completion of the reaction, carrying out post-treatment to obtain a product.

In particular, the n is an integer, and n≥2; X in the 2-haloethylamine hydrohalide I and X-IPM are identical and both are Br or Cl; Z in the 2-haloethylamine hydrohalide I is Br or Cl; Y in the phosphorus oxyhalide II is Br or Cl; and M is pyridine or M is R₃N, wherein the three R groups are each independently methyl, ethyl, propyl or isopropyl, preferably ethyl.

Those skilled in the art should know that R₃N should be a liquid, or be able to achieve the solubility required to dissolve in dichloromethane when R₃N is a gas. Therefore, when R is methyl and R₃N is trimethylamine, the solution of trimethylamine in dichloromethane is a solution formulated under specific environments and conditions.

Those skilled in the art should know that when X and Z in 2-haloethylamine hydrohalide I are identical, 2-haloethylamine hydrohalide I is 2-chloroethylamine hydrochloride or 2-bromoethylamine hydrobromide; when X and Z in 2-haloethylamine hydrohalide I are different, 2-haloethylamine hydrohalide I is 2-chloroethylamine hydrobromide or 2-bromoethylamine hydrochloride.

Since chlorine atoms and bromine atoms may be mutually exchanged during the actual storage or preparation processes, the raw material 2-haloethylamine hydrohalide I used in the reaction may actually be a mixture; that is, when 2-haloethylamine hydrohalide I is either 2-chloroethylamine hydrobromide or 2-bromoethylamine hydrochloride, the reactant 2-haloethylamine hydrohalide I may actually be a mixture of at least two of 2-chloroethylamine hydrobromide, 2-bromoethylamine hydrochloride, 2-chloroethylamine hydrochloride and 2-bromoethylamine hydrobromide.

All the 2-haloethylamine hydrohalides I in the aforementioned cases can be used as a reaction raw material to react with phosphorus oxyhalide II, and therefore all fall within the protection scope of the present invention.

When R is ethyl, and R₃N is triethylamine, the process for producing X-IPM of formula III provided by the present invention comprises the following steps:
mixing dichloromethane with 2-haloethylamine hydrohalide I, starting stirring and setting the temperature down to −70° C. to −60° C., and when the temperature is reduced to −30° C. to −20° C., adding phosphorus oxyhalide II;
adding triethylamine for the first time: when the temperature is lowered to a range of −70° C. to −60° C., adding dropwise a solution of triethylamine in dichloromethane, which comprises triethylamine in an amount 1.8 to 2.2 times the molar equivalent of phosphorus oxyhalide II, and the rate of the dropwise addition should ensures that the temperature of the reaction system is below −60° C.;
adding triethylamine for the second time: when the temperature is raised to a range of −60° C. to −50° C., adding dropwise a solution of triethylamine in dichloromethane, which comprises triethylamine in an amount 0.9 to 1.1 times the molar equivalent of phosphorus oxyhalide II, and the rate of the dropwise addition should ensures that the temperature of the reaction system is below −50° C.;
adding triethylamine for the third time: when the temperature is raised to a range of −50° C. to −40° C., adding dropwise a solution of triethylamine in dichloromethane, which comprises triethylamine in an amount 0.9 to 1.1 times the molar equivalent of phosphorus oxyhalide II, and the rate of the dropwise addition should ensures that the temperature of the reaction system is below −40° C.;
after adding dropwise the solution of triethylamine in dichloromethane, raising the temperature to −20° C. to −10° C. for reaction until the reaction is completed, and carrying out post-treatment to obtain a product.

In particular, X in the 2-haloethylamine hydrohalide I and X-IPM are identical and both are Br or Cl; Z in the 2-haloethylamine hydrohalide I is Br or Cl; and Y in the phosphorus oxyhalide II is Br or Cl.

Further, in the above-mentioned process for producing X-IPM, when X in 2-haloethylamine hydrohalide I and X-IPM, Y in phosphorus oxyhalide II, and Z in 2-haloethylamine hydrohalide I are all Br, the post-treatment process for obtaining a product is as follows: starting to add water dropwise at −20° C. to −10° C. at a rate which should ensure that the temperature of the reaction system is below −10° C., after the dropwise addition, raising the temperature to −5° C. to 5° C., maintaining this temperature and continuing to stir for 8-12 hours, filtering the reaction solution, beating the obtained filter cake with water, dichloromethane, and acetone in sequence, and collecting and drying the filter cake to obtain Br-IPM as a solid.

Further, in the above-mentioned process for producing X-IPM, when X in 2-haloethylamine hydrohalide I and X-IPM, and Z in 2-haloethylamine hydrohalide I are all Cl, and Y in phosphorus oxyhalide II is Br, the post-treatment process for obtaining a product is as follows: performing filtration, washing the filter residue with dichloromethane, combining the filtrate and washing liquid to obtain a combined reaction solution, cooling the reaction solution to 0° C. to 5° C., then adding ice water at a rate which should ensure that the temperature of the reaction system is below 5° C., stirring for 2-6 h, filtering the reaction solution, beating the obtained filter cake with ice water and acetone in sequence, and collecting and drying the filter cake to obtain Cl-IPM as a solid.

“Beating” refers to a purification method which, using the difference in solubility of substances in solvents, comprises stirring a solid and a solvent together to enable full contact between them so as to make the impurities dissolved into the solvent and thus removed. Beating purification can remove part of the impurities on the solid surface.

In particular, dichloromethane and 2-haloethylamine hydrohalide I are mixed in a ratio of 1 ml of dichloromethane to 0.04 to 0.18 g of 2-haloethylamine hydrohalide I.

In particular, where R in R₃N is ethyl (i.e., where a solution of triethylamine in dichloromethane is added dropwise),
when triethylamine is added for the first time, the solution of triethylamine in dichloromethane added dropwise comprises triethylamine and dichloromethane in a volume ratio of 0.40-1.20 ml of triethylamine to 1 ml of dichloromethane;
when triethylamine is added for the second time, the solution of triethylamine in dichloromethane added dropwise comprises triethylamine and dichloromethane in a volume ratio of 0.20-0.60 ml of triethylamine to 1 ml of dichloromethane; and
when triethylamine is added for the third time, the solution of triethylamine in dichloromethane added dropwise comprises triethylamine and dichloromethane in a volume ratio of 0.20-0.60 ml of triethylamine to 1 ml of dichloromethane.

In particular, the water contents of 2-haloethylamine hydrohalide I, dichloromethane and triethylamine used in the above reaction process are controlled within 0.5% by mass, preferably within 0.2% by mass, more preferably within 0.10% by mass.

In particular, the temperature for drying the solid Br-IPM or Cl-IPM does not exceed 35° C., and is preferably 20±5° C.

The present invention further provides a crystal form of Br-IPM, which meets one of the following conditions:
a melting point of 106 to 107° C. as determined by melting point measurements;
an endothermic peak at 117.5-119.5° C. and an endothermic value of 1.65 to 1.85 mW/mg as determined by differential scanning calorimetry; and
an X-ray powder diffraction pattern represented by the diffraction angle 2θ with characteristic peaks at 7.77°, 15.57° and 19.01°, with an error range not greater than 0.010 as determined by X-ray powder diffraction using Cu-Kα radiation.

Preferably, the crystal form of Br-IPM has an endothermic peak at 118.41° C. (with an error of ±1° C.), and has an endothermic value of 1.75 mW/mg as determined by differential scanning calorimetry.

Preferably, the X-ray powder diffraction pattern represented by the diffraction angle 2θ shows characteristic peaks at 7.77°, 15.57°, 19.01°, 21.93°, 22.71°, 23.45°, 23.84°, 24.42°, 25.05°, 27.44°, 27.99°, 30.43°, 31.42°, 33.40°, 33.75°, 36.78°, 39.55°, 43.03° and 44.97°, with an error not greater than 0.01°, as determined by X-ray powder diffraction using Cu-Kα radiation.

In a preferred embodiment, the crystal form of Br-IPM has a pattern that meets one of the following conditions:
the X-ray powder diffraction pattern as shown in FIG. 9; and
the differential scanning calorimetry pattern as shown in FIG. 10.

The present application summarizes the data of characteristic peaks with a relative intensity greater than 10% in the X-ray powder diffraction data of the crystal form of Br-IPM, as shown in Table 1. The error range of the characteristic peaks in the X-ray powder diffraction pattern represented by the diffraction angle 2θ is not greater than 0.01°.

TABLE 1

| | Peak | Relative |
|---|---|---|
| Position | height | intensity |
| (2θ) | (cts) | (%) |
| 7.7772 | 3061.84 | 32.6 |
| 15.5768 | 1410.41 | 15.02 |
| 19.0179 | 1170.98 | 12.47 |
| 21.9302 | 3045.02 | 32.42 |
| 22.7161 | 4435.18 | 47.22 |
| 23.4525 | 9392.62 | 100 |
| 23.8415 | 1801.87 | 19.18 |
| 24.4215 | 958.9 | 10.21 |
| 25.0523 | 2499.45 | 26.61 |
| 27.4451 | 1512.8 | 16.11 |
| 27.9992 | 947.74 | 10.09 |
| 30.4321 | 1706.9 | 18.17 |
| 31.4206 | 7033.43 | 74.88 |
| 33.4052 | 1678.02 | 17.87 |
| 33.752 | 2890.69 | 30.78 |
| 36.7837 | 2070.73 | 22.05 |
| 39.5584 | 1341.7 | 14.28 |
| 43.0389 | 1407.52 | 14.99 |
| 44.9706 | 1049.42 | 11.17 |

In particular, the HPLC purity of the crystal form of Br-IPM is ≥93%; preferably, the HPLC purity of the crystal form of Br-IPM is ≥95%; and more preferably, the HPLC purity of the crystal form of Br-IPM is ≥97%.

Preferred test conditions for the aforementioned HPLC test of the Br-IPM are as follows:

Preferred chromatographic conditions for determination of purity of Br-IPM

Chromatographic column: Thermo Acclaim ™ 120A C18 250*4.6 mm, 5 um
Flow rate: 0.7 ml/min
Detection wavelength: 210 nm
Column temperature: 5° C.
Mobile phase A: 0.1% phosphoric acid aqueous solution Mobile phase B: acetonitrile
Elution procedure:

| Time | A % | B % |
|---|---|---|
| 0 | 90 | 10 |
| 5 | 90 | 10 |
| 35 | 20 | 80 |
| 40 | 20 | 80 |
| 40.1 | 90 | 10 |
| 45 | 90 | 10 |

These preferred chromatographic conditions are merely preferred embodiments recommended by the inventors. The skilled person, under the conditions of using a C18 reversed-phase chromatographic column and the aforementioned mobile phases A and B, can make adaptive modifications to other elements: the size of the chromatographic column, flow rate, and column temperature; especially, in addition to the conventional ultraviolet detector with a wavelength of 210 nm as used in the preferred embodiments, other detectors can also be used.

The 0.1% phosphoric acid aqueous solution is used to adjust the acidity and alkalinity of the mobile phases. In the above preferred conditions, the medium-strength inorganic acid, phosphoric acid, is used; other acids such as organic acids (acetic acid, formic acid, etc.) can also be used. Therefore, based on the knowledge of those skilled in the art, it is easy to conceive of and implement the use of an aqueous solution of other medium-strength inorganic acids and organic acids (acetic acid, formic acid, etc.) at a suitable concentration as mobile phase A. These alternative solutions produce equivalent effects to those produced by the aforementioned solutions of preferred chromatographic conditions, and are equivalent technical solutions.

The present invention further provides a crystal form of Cl-IPM, which meets one of the following conditions:
a melting point of 108 to 110° C. as determined by melting point measurements;
an endothermic peak at 120 to 128° C., and an endothermic value of 2.5 to 3.5 mW/mg
as determined by differential scanning calorimetry; and
an X-ray powder diffraction pattern represented by the diffraction angle 2θ with characteristic peaks at 23.22°, 30.75° and 44.29°, with an error not greater than 0.01° as determined by X-ray powder diffraction using Cu-Kα radiation.

Preferably, the crystal form of Cl-IPM has an endothermic peak at 124.81° C. (with an error of ±1° C.), and has an endothermic value of 3.108 mW/mg, as determined by differential scanning calorimetry.

Preferably, the X-ray powder diffraction pattern represented by the diffraction angle 2θ shows characteristic peaks at 8.02°, 16.01°, 19.39°, 20.51°, 22.03°, 23.22°, 24.26°, 24.79°, 25.36°, 30.75°, 32.53°, 34.31°, 34.50°, 37.91° and 44.29°, with an error range not greater than 0.01°, as determined by X-ray powder diffraction using Cu-Kα radiation.

In a preferred embodiment, the crystal form of Cl-IPM has a pattern that meets one of the following conditions:
the X-ray powder diffraction pattern as shown in FIG. 3; and
the differential scanning calorimetry pattern as shown in FIG. 4.

The present application summarized the data of characteristic peaks with a relative intensity greater than 3% in the X-ray powder diffraction data of the crystal form of Cl-IPM, as shown in Table 2. The error range of the characteristic peaks in the X-ray powder diffraction pattern represented by the diffraction angle 2θ is not greater than 0.01°.

TABLE 2

| | Peak | Relative |
|---|---|---|
| Position | height | intensity |
| (2θ) | (cts) | (%) |
| 8.0209 | 22560.43 | 100 |
| 16.1087 | 1373.14 | 6.09 |
| 19.3901 | 745.01 | 3.3 |
| 20.5104 | 1185.97 | 5.26 |
| 22.0369 | 1751.51 | 7.76 |
| 23.2285 | 3008.18 | 13.33 |
| 24.2629 | 4742.66 | 21.02 |
| 24.7915 | 1310.07 | 5.81 |
| 25.3655 | 1077.28 | 4.78 |
| 30.7579 | 792.6 | 3.51 |
| 32.5394 | 3283.25 | 14.55 |
| 34.3143 | 1207.96 | 5.35 |
| 34.503 | 1875.94 | 8.32 |
| 37.914 | 1274.95 | 5.65 |
| 44.2974 | 711.95 | 3.16 |

The present invention further provides use of the aforementioned crystal forms or the Br-IPM and Cl-IPM obtained by the aforementioned production processes as reactants in the synthesis and preparation of Compound A, Compound B, Compound C, Compound D, Compound E, Compound F, Compound G, and Compound H. Compound A, Compound B, Compound C, Compound D, Compound E, Compound F, Compound G and Compound H are represented as follows.

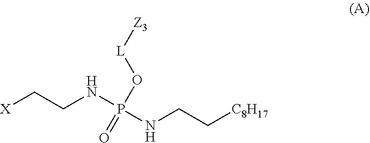

wherein L is selected from the group consisting of —CH₂—, —CD₂—, —CH(CH₃)—, —CD(CD₃)—, —CD(CH₃)—, —C(CH₃)₂—, —C(CD₃)₂—,

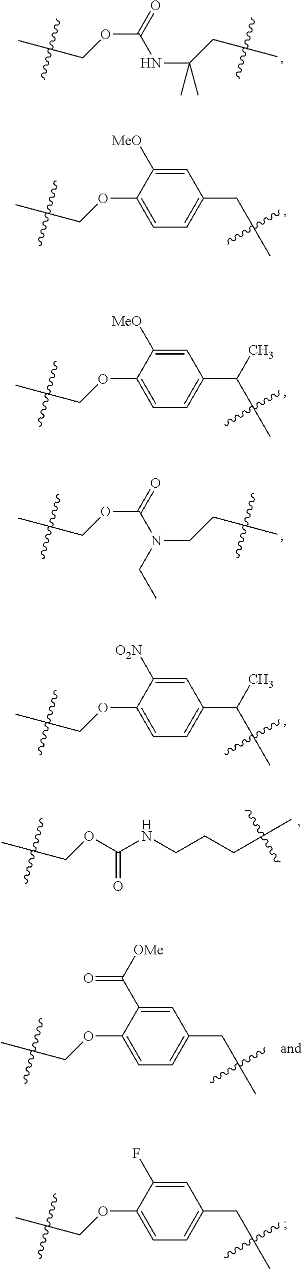

Z₃ is selected from the group consisting of

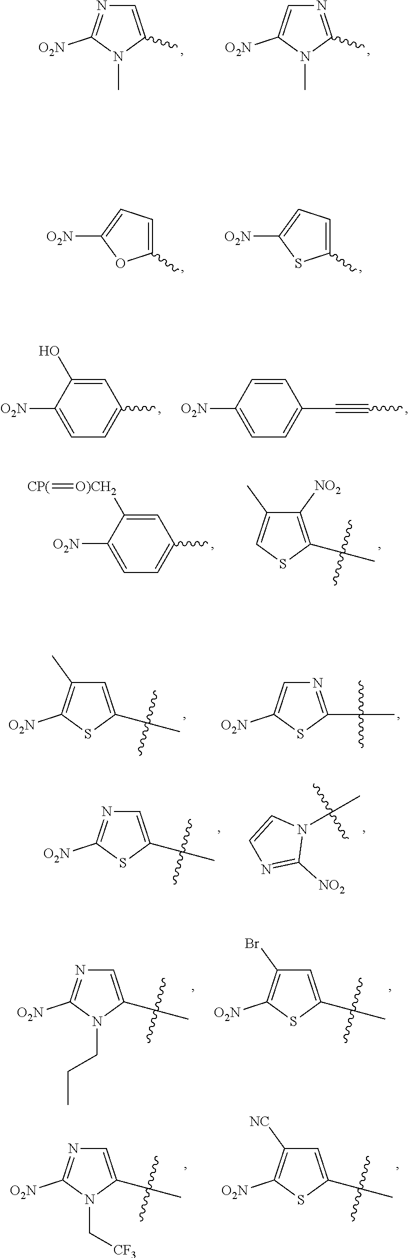

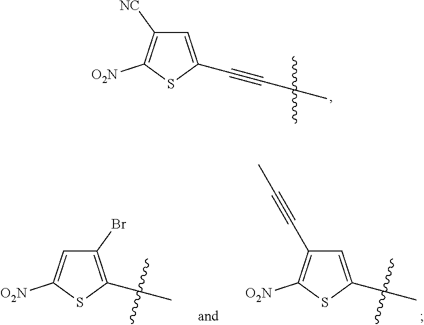 [SMILES: *C#Cc1cc(C#N)c([N+](=O)[O-])s1 ; *c1sc([N+](=O)[O-])cc1Br ; *c1cc(C#CC)c([N+](=O)[O-])s1]

in particular, X in Compound A is Br or Cl; D in the L is deuterium, an isotope of hydrogen.

Specifically, Compound A is selected from compounds having the following structures.

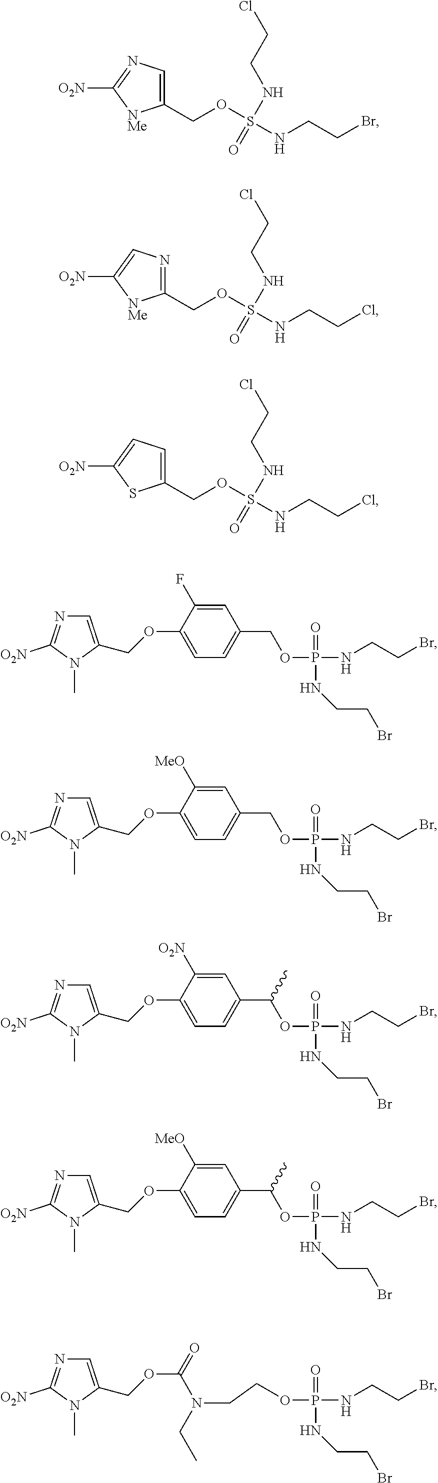

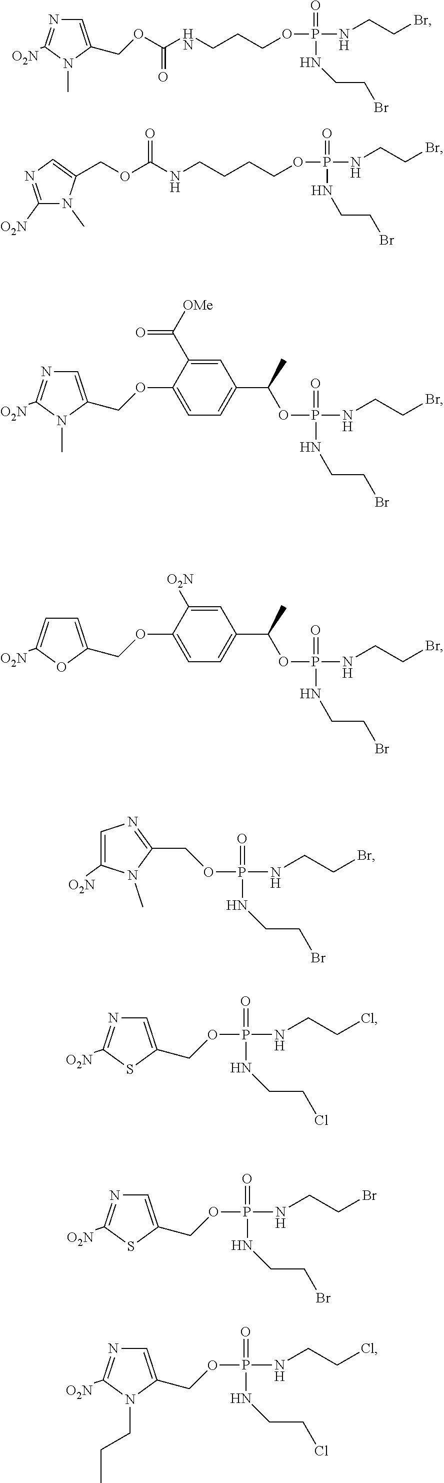

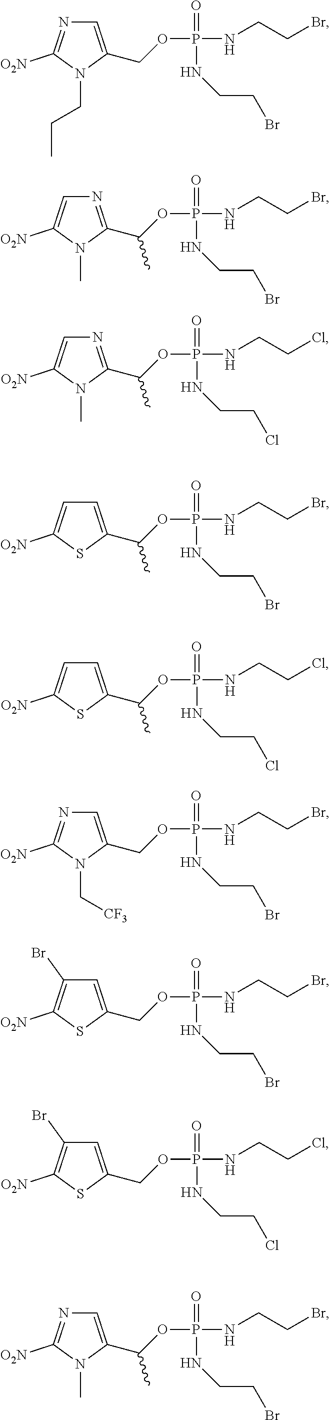

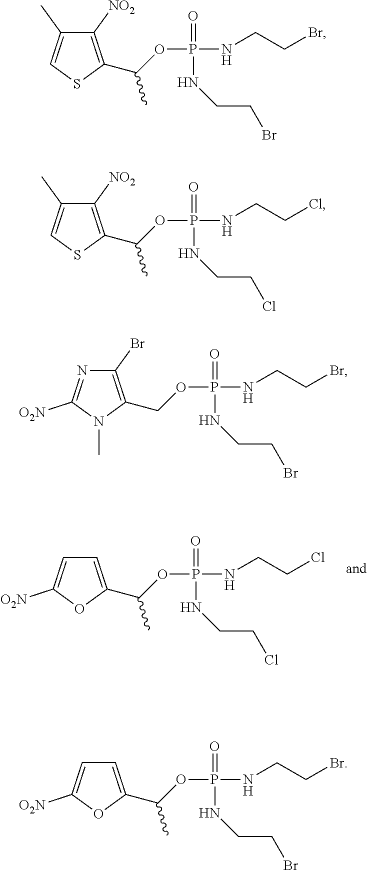

For the specific definitions and meanings, and the preparation methods and spectral data, please refer to Patent Application PCT/US2006/025881 (Publication No. WO2007002931A3), which corresponds to Chinese Application No. CN201210251557.3 (Publication No. CN102746336), and this application is incorporated herein in its entirety by reference.

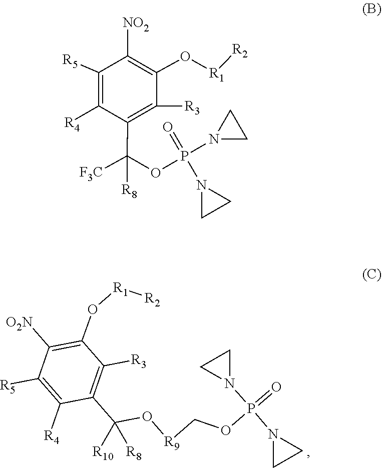

wherein the definitions of R₁, R₂, R₃, R₄, R₅, R₈, R₉ and R₁₀ are as described in the claims of Patent Application PCT/CN2020/089692 (Publication No. WO2020228685A9). Specifically, the definitions are as follows:
R₁ is C₆-C₁₀ aryl or Z-substituted aryl, 4-15 membered heterocycle or Z-substituted heterocycle, 5-15 membered heteroaryl or Z-substituted heteroaryl, or a 7-15 membered fused ring or Z-substituted fused ring;
R₂ is hydrogen, a halogen atom, cyano or isocyano, hydroxy, sulfhydryl, amino, OTs, OLCMS, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, ether having from 1 to 6 carbon atoms or Z-substituted alkoxy having from 1 to 6 carbon atoms, —CONR⁶R₇, —SO₂NR⁶R⁷, —SO₂R⁶, —OCOO—R⁶, —COOR⁶, —NR⁶COR⁷, —OCOR⁶, —NR⁶SO₂R⁷ or —NR⁶SO₂NR⁶R⁷, or R² together with the atom in the group R₁ to which it is bonded to form a 7-15 membered fused ring or Z-substituted fused ring;
R₃ is hydrogen, halogen, cyano or isocyano, hydroxy, sulfhydryl, amino, OTs, OLCMS, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, C₁-C₆ alkoxy or Z-substituted C₁-C₆ alkoxy, —CONR⁶R⁷, —SO₂NR⁶R⁷, —SO₂R⁶, —OCO—R⁶, —OCOO—R⁶, —COOR⁶, —NR⁶COR⁷, —OCOR⁶, or —NR⁶SO₂R⁷;
R₄ and R₅ are each independently hydrogen, a halogen atom, cyano or isocyano, hydroxy, sulfhydryl, amino, OTs, OLCMS, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, C₁-C₆ alkoxy or Z-substituted C₁-C₆ alkoxy, —CONR⁶R⁷, —SO₂NR⁶R⁷, —SO₂R⁶, —OCOO—R⁶, —COOR⁶, —NR⁶COR⁶, —OCOR⁶ or —NR⁶SO₂R⁷, or R₄ and R₅ together with the atom in the benzene ring to which they are bonded to form a 7-15 membered fused ring or Z-substituted fused ring;
R⁶ and R⁷ are each independently hydrogen, cyano or isocyano, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, C₆-C₁₀ aryl or Z-substituted aryl, 4-15 membered heterocycle or Z-substituted heterocycle, 5-15 membered heteroaryl or Z-substituted heteroaryl, or C₁-C₆ alkoxy or Z-substituted C₁-C₆ alkoxy, or R⁶ and R⁷ together with the atom to which they are bonded to form 5-7 membered heterocyclyl or Z-substituted 5-7 membered heterocyclyl;
R₈ and R₁₀ are each independently hydrogen, deuterium, aryl or Z-substituted aryl, C₁-C₆ alkyl or Z-substituted alkyl, C₂-C₆ alkenyl or Z-substituted alkenyl, C₂-C₆ alkynyl or Z-substituted alkynyl, C₃-C₈ cycloalkyl or Z-substituted cycloalkyl, and at least one of R₈ and R₁₀ must be hydrogen or deuterium;
R₉ is substituted C₆-C₁₀ aryl which is substitued with at least one fluorine atom or nitro group, substituted 4-15 membered heterocycle which is substitued with at least one fluorine atom or nitro group, or substituted 5-15 membered heteroaryl which is substitued with at least one fluorine atom or nitro group;
the substituent Z is a halogen atom, cyano or isocyano, hydroxy, sulfhydryl, amino, OTs, OLCMS, C₁-C₃ alkyl or substituted alkyl, C₁-C₃ alkoxy or substituted alkoxy, C₂-C₃ alkenyl or substituted alkenyl, C₂-C₃ alkynyl or substituted alkynyl, C₃-C₈ cycloalkyl or substituted cycloalkyl, an aromatic ring, heterocycle, a heteroaromatic ring and fused ring or a substituted aromatic ring, heterocycle, a heteroaromatic ring and fused ring, the pattern of substitution being mono- or di-substitution;
the substitution in the substituted C₆-C₁₀ aryl, substituted 4-15 membered heterocycle or substituted 5-15 membered heteroaryl in R₉ is a halogen atom, nitro, cyano or isocyano, hydroxy, amino, C₁-C₃ alkyl or alkoxy, alkenyl, alkynyl, cycloalkyl or benzene ring, substituted benzene ring, C₁-C₃ alkoxy or halogen atom-substituted alkoxy.

Specifically, Compound B is selected from compounds having the following structures:

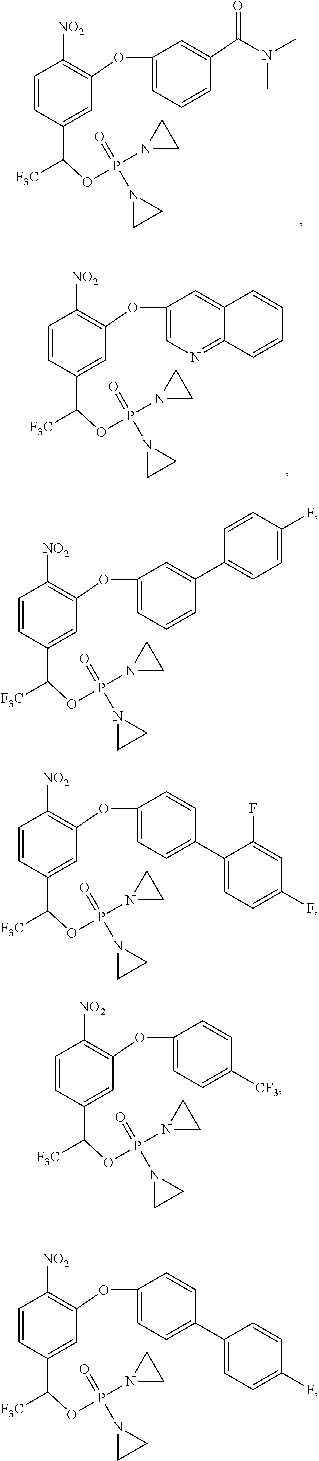

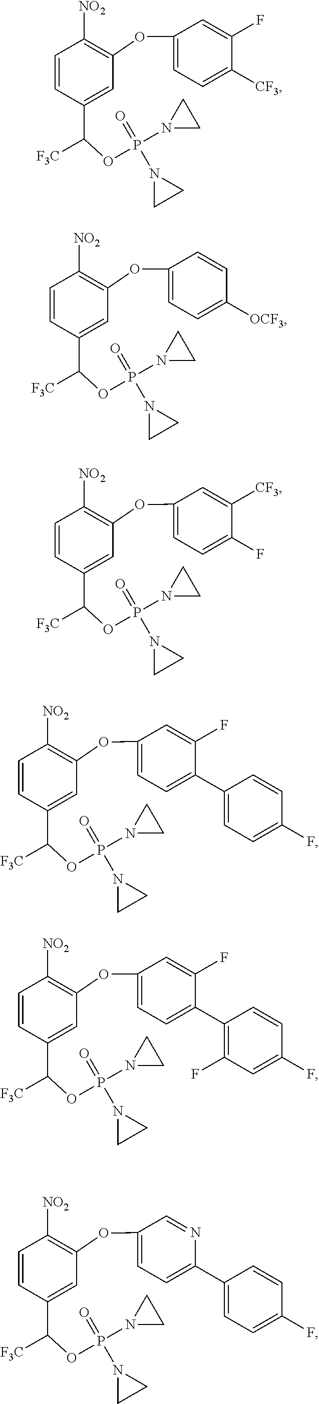 [SMILES: O=[N+]([O-])c1ccc(C(OP(=O)(N2CC2)N2CC2)C(F)(F)F)cc1Oc1ccc(C(F)(F)F)c(F)c1 ; O=[N+]([O-])c1ccc(C(OP(=O)(N2CC2)N2CC2)C(F)(F)F)cc1Oc1ccc(OC(F)(F)F)cc1 ; O=[N+]([O-])c1ccc(C(OP(=O)(N2CC2)N2CC2)C(F)(F)F)cc1Oc1ccc(F)c(C(F)(F)F)c1 ; O=[N+]([O-])c1ccc(C(OP(=O)(N2CC2)N2CC2)C(F)(F)F)cc1Oc1ccc(-c2ccc(F)cc2)c(F)c1 ; O=[N+]([O-])c1ccc(C(OP(=O)(N2CC2)N2CC2)C(F)(F)F)cc1Oc1ccc(-c2ccc(F)cc2F)c(F)c1 ; O=[N+]([O-])c1ccc(C(OP(=O)(N2CC2)N2CC2)C(F)(F)F)cc1Oc1ccc(-c2ccc(F)cc2)nc1]

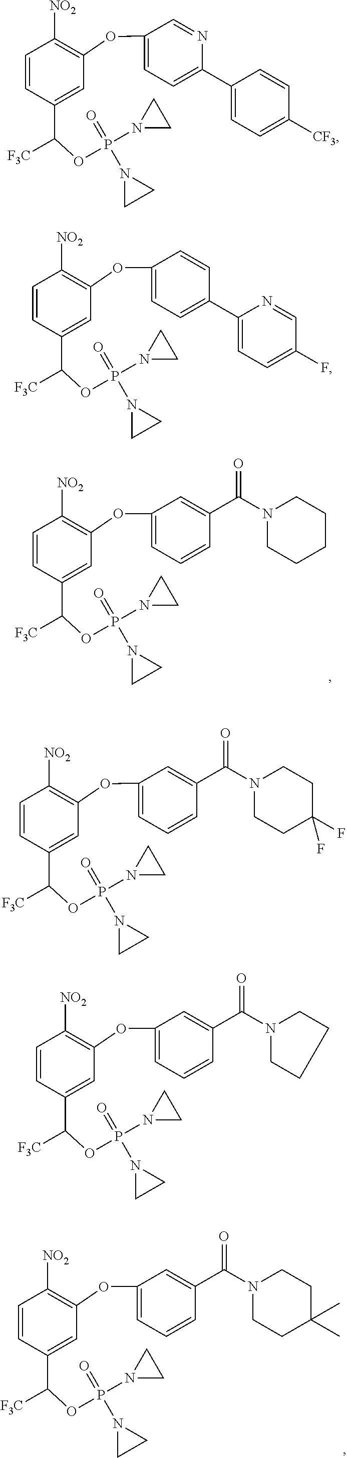 [SMILES: O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(F)cn2)cc1 ; O=C(c1cccc(Oc2cc(C(OP(=O)(N3CC3)N3CC3)C(F)(F)F)ccc2[N+](=O)[O-])c1)N1CCCCC1 ; O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1]

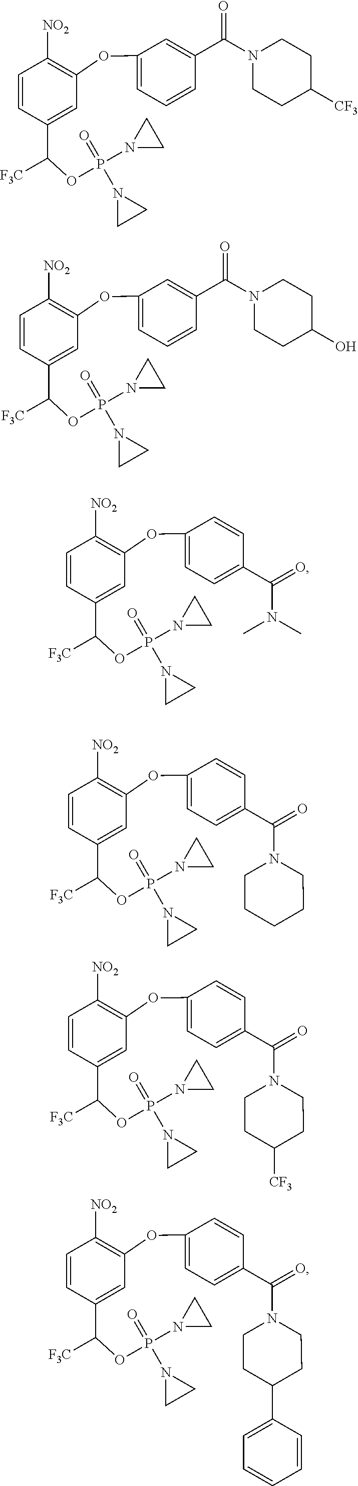

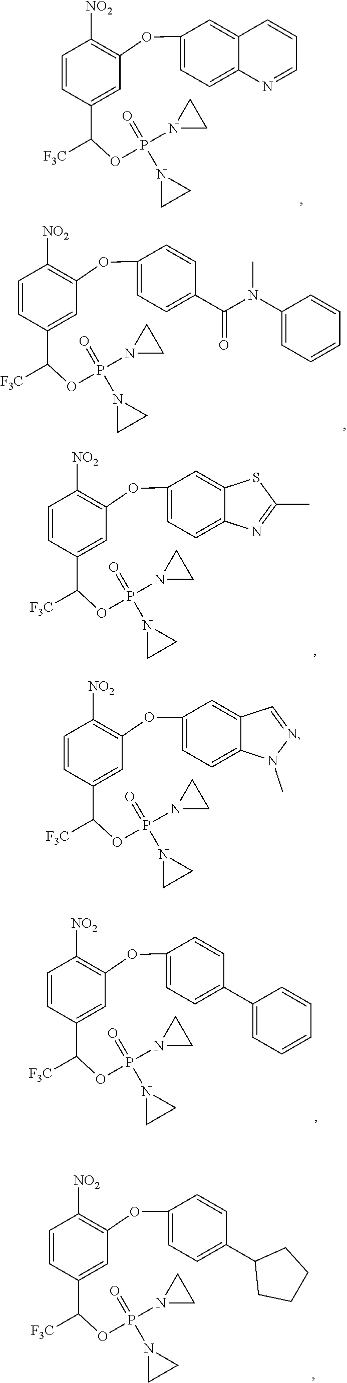

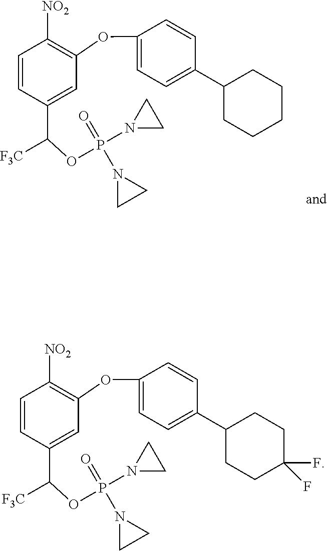 [SMILES: O=[N+]([O-])c1ccc(C(OP(=O)(N2CC2)N2CC2)C(F)(F)F)cc1Oc1ccc(C2CCCCC2)cc1 ; O=[N+]([O-])c1ccc(C(OP(=O)(N2CC2)N2CC2)C(F)(F)F)cc1Oc1ccc(C2CCC(F)(F)CC2)cc1]

Specifically, Compound C is selected from compounds having the following structures:

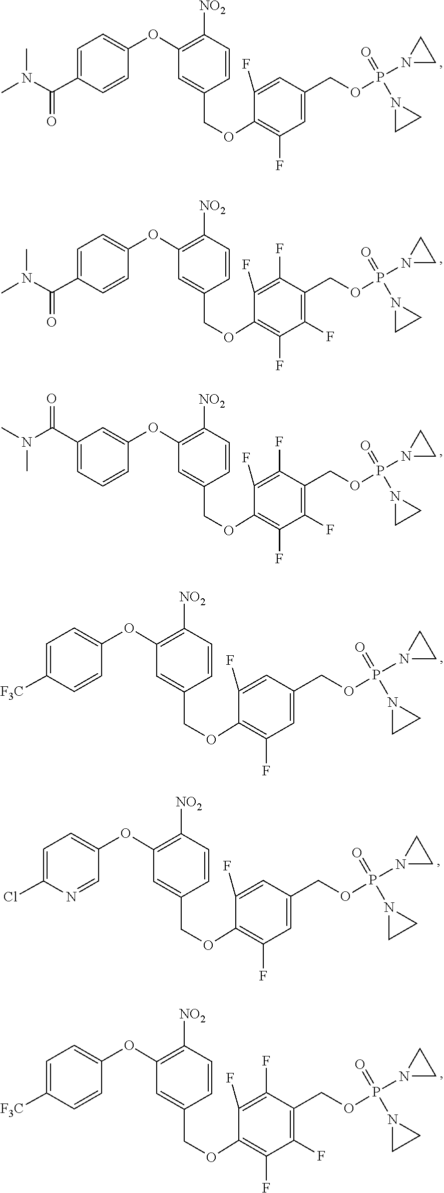

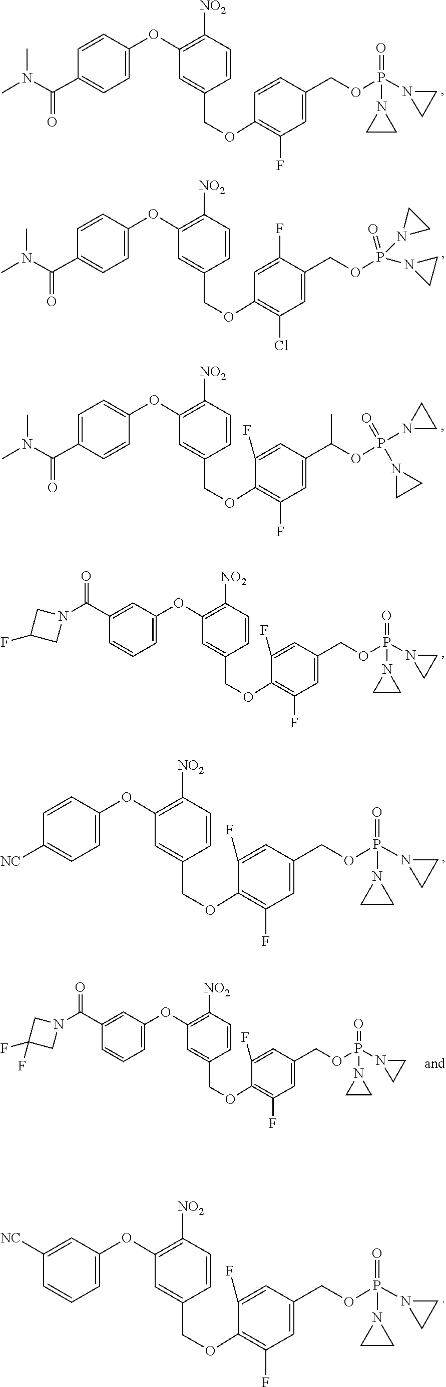

As for the specific definitions and meanings, and the preparation methods and spectral data for Compounds B and C, please refer to Patent Application PCT/CN2020/089692 (Publication No. WO2020228685A9), which is incorporated herein in its entirety by reference.

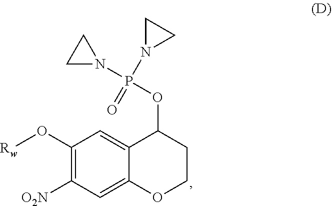

wherein the definitions of Rw are as described in the claims of Patent Application PCT/CN2020/120281 (Publication No. WO2021068952A1). Specifically, the definitions are as follows:
Rw is

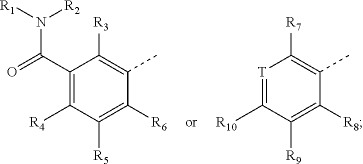

R₁ is H, C₁₋₆ alkyl, C₃₋₆ cycloalkyl 4-6 membered heterocycloalkyl, 5-6 membered heteroaryl or phenyl, wherein C₁₋₆ alkyl, C₃₋₆ cycloalkyl, 4-6 membered heterocycloalkyl, 5-6 membered heteroaryl and phenyl are optionally substituted with one, two or three R^{a};
each R^{a} is independently H, F, Cl, Br, I, —CN, —OH, C₁₋₃ alkoxy or C₁₋₃ alkyl;
R₂ is H or C₁₋₆ alkyl;
or R₁ and R₂ are linked to each other and, together with the atom to which they are attached, form a 4-6 membered heterocycloalkyl, wherein the 4-6 membered heterocycloalkyl is optionally substituted with one, two or three R^{b};
each R^{b} is independently H, F, Cl, Br, I, —CN, —OH, —NH₂, —OCH₃, —OCH₂CH₃, —CH₃ or —CH₂CH₃;
R₃ is H, F, Cl, Br, I, —OH, —NH₂, C₁₋₃ alkoxy or C₁₋₃ alkyl;
or, R₂ and R₃ are linked to each other so that the structural unit

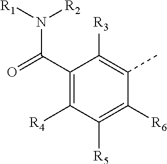

is

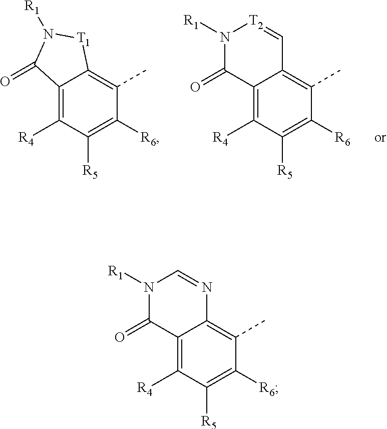

T₁ is —(CR^{c}R^{d})ₘ— or —(CR^{c}R^{d})ₙ—O—;
m is 1, 2 or 3;
n is 1 or 2;
T₂ is N or CH;
R^{c} and R^{d} each independently are H, F, C₁₋₃ alkyl or C₁₋₃ alkoxy;
R₄, R₅ and R₆ each independently are H, F, Cl, Br, I, C₁₋₃ alkyl or C₁₋₃ alkoxy;
T is N or CH;
R₇ and R₈ each independently are H, F, Cl, Br or I;
R₉ and R₁₀ each independently are H, F, Cl, Br, I, —CN or
the 4-6 membered heterocycloalkyl and 5-6 membered heteroaryl each contain 1, 2, 3 or 4 heteroatoms independently selected from N, —O— and —S—.

Specifically, Compound D is selected from compounds having the following structures:

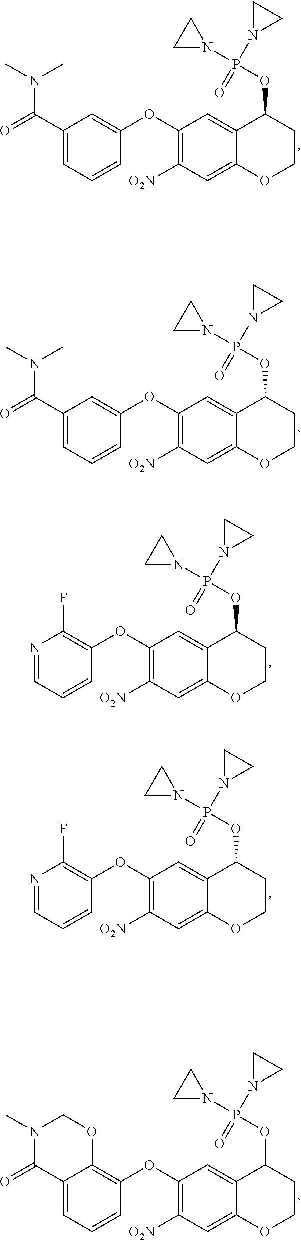 [SMILES: CN(C)C(=O)c1cccc(Oc2cc3c(cc2[N+](=O)[O-])OCC[C@@H]3OP(=O)(N2CC2)N2CC2)c1 ; CN(C)C(=O)c1cccc(Oc2cc3c(cc2[N+](=O)[O-])OCC[C@H]3OP(=O)(N2CC2)N2CC2)c1 ; O=[N+]([O-])c1cc2c(cc1Oc1cccnc1F)[C@@H](OP(=O)(N1CC1)N1CC1)CCO2 ; O=[N+]([O-])c1cc2c(cc1Oc1cccnc1F)[C@H](OP(=O)(N1CC1)N1CC1)CCO2 ; CN1COc2c(Oc3cc4c(cc3[N+](=O)[O-])OCCC4OP(=O)(N3CC3)N3CC3)cccc2C1=O]

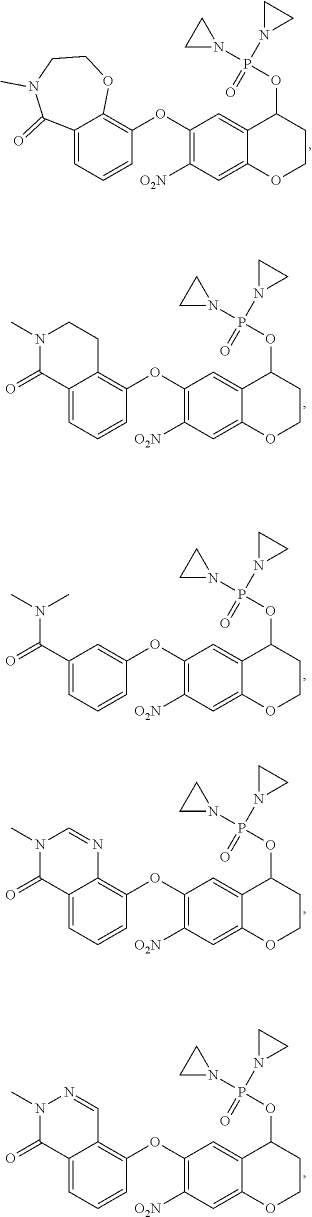 [SMILES: CN1CCOc2c(Oc3cc4c(cc3[N+](=O)[O-])OCCC4OP(=O)(N3CC3)N3CC3)cccc2C1=O ; CN1CCc2c(Oc3cc4c(cc3[N+](=O)[O-])OCCC4OP(=O)(N3CC3)N3CC3)cccc2C1=O ; CN(C)C(=O)c1cccc(Oc2cc3c(cc2[N+](=O)[O-])OCCC3OP(=O)(N2CC2)N2CC2)c1 ; Cn1cnc2c(Oc3cc4c(cc3[N+](=O)[O-])OCCC4OP(=O)(N3CC3)N3CC3)cccc2c1=O ; Cn1ncc2c(Oc3cc4c(cc3[N+](=O)[O-])OCCC4OP(=O)(N3CC3)N3CC3)cccc2c1=O]

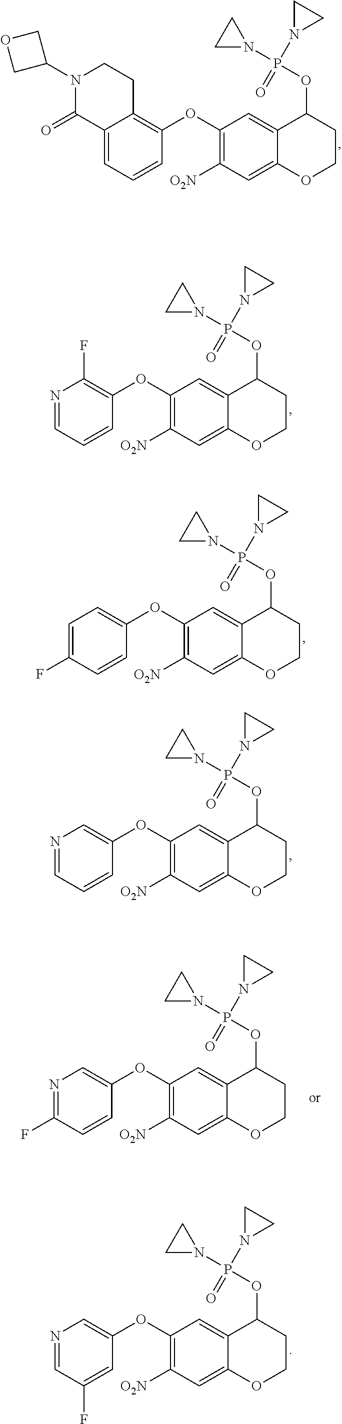

For the specific definitions and meanings, and the preparation methods and spectral data, please refer to Patent Application PCT/CN2020/120281 (Publication No. WO2021068952A1), which is incorporated herein in their entirety by reference.

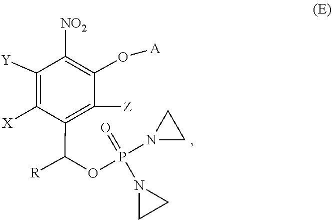

wherein the respecitive groups in Compound E are defined as follows:
A is substituted or unsubstituted C₆-C₁₀ aryl, biaryl or substituted biaryl, or 5-15
membered heteroaryl or —N═CR¹R², wherein the substituent is selected from the group consisting of halo, —CN, —NO₂, —O—(CH₂)—O—, —CO₂H and its salts, —OR¹⁰⁰, —CO₂R¹⁰⁰, —CONR¹⁰¹R¹⁰², —NR¹⁰¹R¹⁰², —NR¹⁰⁰SO₂R¹⁰⁰, —SO₂R¹⁰⁰, —SO₂NR¹⁰¹R¹⁰², C1-C6 alkyl, and C3-C10 heterocyclyl;
wherein R¹⁰⁰, R¹⁰¹ and R¹⁰² are each independently hydrogen, C1-C8 alkyl or C6-C12 aryl; or R¹⁰¹ and R¹⁰² together with the nitrogen atom to which they are attached form a 5-7 membered heterocyclic ring;
wherein alkyl and aryl are each substituted with 1-3 halo or 1-3 C1-C6 alkyl;
wherein R¹ and R² are each independently phenyl or methyl;
X, Y and Z are each independently hydrogen or halo;
R is hydrogen or C1-C6 alkyl or halogen-substituted alkyl.

Evidently, the “compound” also includes the compound itself, as well as solvates, salts, esters or isotopic isomers, etc. thereof.
“Cx-Cy” or “Cx-y” before a group refers to a range of the number of carbon atoms that are present in that group. For example, C₁-C₆ alkyl refers to an alkyl group having at least 1 and up to 6 carbon atoms.

“Alkyl” refers to monovalent saturated aliphatic hydrocarbyl groups having from 1 to 10 carbon atoms and, in some embodiments, from 1 to 6 carbon atoms. “Cx-y alkyl” refers to alkyl groups having from x to y carbon atoms. This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—).

“Aryl” refers to an aromatic group having from 6 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” or “Ar” applies when the point of attachment is at an aromatic carbon atom (e.g., 5, 6, 7, 8 tetrahydronaphthalene-2-yl is an aryl group as its point of attachment is at the 2-position of the aromatic phenyl ring). “Arylene” refers to a divalent aryl radical having the appropriate hydrogen content.

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g. 5,6,7,8-tetrahydronaphthalene-5-yl). The term “cycloalkyl” includes cycloalkenyl groups. Examples of cycloalkyl groups include, for instance, adamantyl, cyclopropyl, cyclobutyl, cyclopentyl, cyclooctyl, and cyclohexenyl. “Cycloalkylene” refers to a divalent cycloalkyl radical having the appropriate hydrogen content.

“Halo” refers to one or more of fluoro, chloro, bromo, and iodo.

“Heteroaryl” refers to an aromatic group of from 1 to 14 carbon atoms and 1 to 6 heteroatoms selected from the group consisting of oxygen, nitrogen, and sulfur and includes single ring (e.g. imidazol-2-yl and imidazol-5-yl) and multiple ring systems (e.g. imidazopyridyl, benzotriazolyl, benzimidazol-2-yl and benzimidazol-6-yl). For multiple ring systems, including fused, bridged, and spiro ring systems having aromatic and non-aromatic rings, the term “heteroaryl” applies if there is at least one ring heteroatom, and the point of attachment is at an atom of an aromatic ring (e.g. 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N-oxide (N→O), sulfinyl, or sulfonyl moieties. The term heteroaryl includes, but is not limited to, acridinyl, azocinyl, benzimidazolyl, benzofuranyl, benzothiofuranyl, benzothiophenyl, benzoxazolyl, benzothiazolyl, benzotriazolyl, benzotetrazolyl, benzisoxazolyl, benzisothiazolyl, benzothienyl, benzimidazolinyl, carbazolyl, NH-carbazolyl, carbolinyl, chromanyl, chromenyl, cinnolinyl, dithiazinyl, furanyl, furazanyl, imidazolidinyl, imidazolinyl, imidazopyridyl, imidazolyl, indazolyl, indolenyl, indolinyl, indolizinyl, indolyl, isobenzofuranyl, isochromanyl, isoindazolyl, isoindolinyl, isoindolyl, isoquinolinyl, isoquinolyl, isothiazolyl, isoxazolyl, naphthyridinyl, octahydroisoquinolinyl, oxadiazolyl, oxazolidinyl, oxazolyl, pyrimidinyl, phenanthridinyl, phenanthrolinyl, phenazinyl, phenothiazinyl, phenoxathiinyl, phenoxazinyl, phthalazinyl, piperazinyl, pteridinyl, purinyl, pyranyl, pyrazinyl, pyrazolidinyl, pyrazolinyl, pyrazolyl, pyridazinyl, pyridooxazolyl, pyridoimidazolyl, pyridothiazole, pyridinyl, pyridyl, pyrimidinyl, pyrrolyl, quinazolinyl, quinolinyl, quinoxalinyl, quinuclidinyl, tetrahydroisoquinolinyl, tetrahydroquinolinyl, tetrazolyl, thiadiazinyl, thiadiazolyl, thianthrenyl, thiazolyl, thienyl, thienothiazolyl, thienooxazolyl, thienoimidazolyl, thiophenyl, triazinyl and xanthenyl. “Heteroarylene” refers to a divalent heteroaryl radical having the appropriate hydrogen content.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from the group consisting of nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” applies when there is at least one ring heteroatom, and the point of attachment is at an atom of a non-aromatic ring (e.g. 1,2,3,4-tetrahydroquinoline-3-yl, 5,6,7,8-tetrahydroquinoline-6-yl, and decahydroquinolin-6-yl). In some embodiments, the heterocyclic groups herein are 3-15 membered, 4-14 membered, 5-13 membered, 7-12 membered, or 5-7 membered heterocycles. In some other embodiments, the heterocycles contain 4 heteroatoms. In some other embodiments, the heterocycles contain 3 heteroatoms. In another embodiment, the heterocycles contain up to 2 heteroatoms. In some embodiments, the nitrogen and/or sulfur atom(s) of the heterocyclic group are optionally oxidized to provide the N-oxide, sulfinyl, sulfonyl moieties. Heterocyclyl includes, but is not limited to, tetrahydropyranyl, piperidinyl, N-methylpiperidin-3-yl, piperazinyl, N-methylpyrrolizidin-3-yl, 3-pyrrolizidinyl, 2-pyrrolidon-1-yl, morpholinyl, and pyrrolizidinyl. A prefix indicating the number of carbon atoms (e.g., C₃₋₁₀) refers to the total number of carbon atoms in the portion of the heterocyclyl group exclusive of the number of heteroatoms. A divalent heterocyclic radical will have the appropriately adjusted hydrogen content. “Biaryl” refers to a structure in which two aromatic rings are linked by a C—C single bond, such as biphenyl, bipyridine, and the like.

The term “optionally substituted” refers to a substituted or unsubstituted group. The group may be substituted with one or more substituents, such as 1, 2, 3, 4 or 5 substituents. Preferably, the substituents are selected from the group consisting of oxo, halo, —CN, NO₂, —N₂+, —CO₂R¹⁰⁰, —OR¹⁰⁰, —SR¹⁰⁰, —SOR¹⁰⁰, —SO₂R¹⁰⁰, —NR¹⁰⁰SO₂R¹⁰⁰, —NR¹⁰¹R¹⁰², —CONR¹⁰¹R¹⁰², —SO₂NR¹⁰¹R¹⁰², C₁-C₆ alkyl, C₁-C₆ alkoxy, —CR¹⁰⁰═C(R¹⁰⁰)₂, —CCR¹⁰⁰, C₃-C₁₀ cycloalkyl, C₃-C₁₀ heterocyclyl, C₆-C₁₂ aryl and C₂-C₁₂ heteroaryl, or a divalent substituent such as —O—(CH₂)—O—, —O—(CH₂)₂—O—, and 1-4 methyl substituted version thereof, wherein each R¹⁰⁰, R¹⁰¹ and R¹⁰² independently is hydrogen or C₁-C₈ alkyl; C₃-C₁₂ cycloalkyl; C₃-C₁₀ heterocyclyl; C₆-C₁₂ aryl; or C₂-C₁₂ heteroaryl; or R¹⁰¹ and R¹⁰² together with the nitrogen atom they are attached to form a 5-7 membered heterocycle; wherein each alkyl, cycloalkyl, heterocyclyl, aryl, or heteroaryl is optionally substituted with 1-3 halo, 1-3 C₁-C₆ alkyl, 1-3 C₁-C₆ haloalkyl or 1-3 C₁-C₆ alkoxy groups. Preferably, the substituents are selected from the group consisting of chloro, fluoro, —OCH₃, methyl, ethyl, iso-propyl, cyclopropyl, —CO₂H and salts and C₁-C₆ alkyl esters thereof, CONMe₂, CONHMe, CONH₂, —SO₂Me, —SO₂NH₂, —SO₂NMe₂, —SO₂NHMe, —NHSO₂Me, —NHSO₂CF₃, —NHSO₂CH₂C₁, —NH₂, —OCF₃, —CF₃ and —OCHF₂.

Specifically, Compound E is selected from compounds having the following structures:

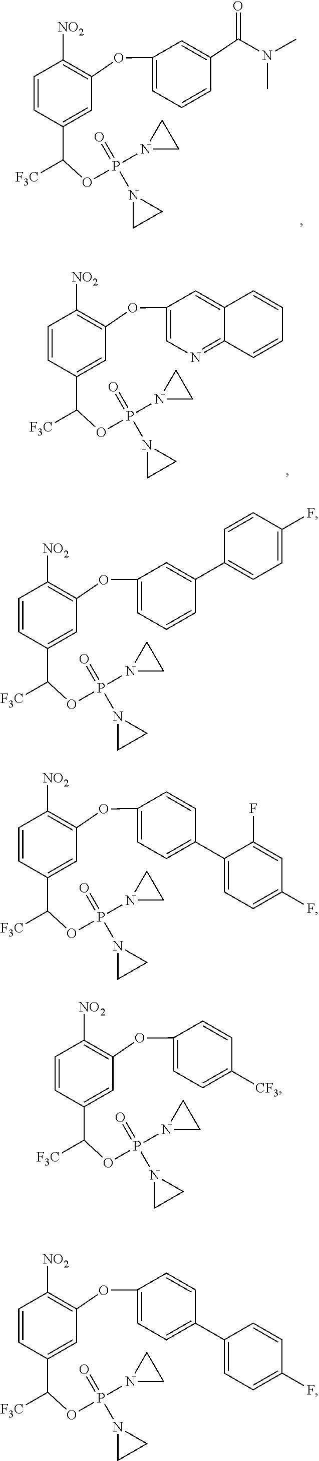

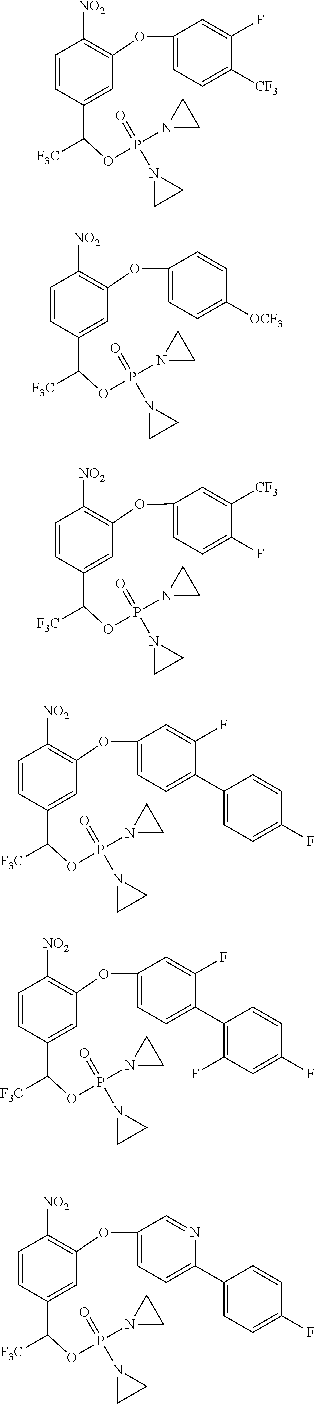 [SMILES: O=[N+]([O-])c1ccc(C(OP(=O)(N2CC2)N2CC2)C(F)(F)F)cc1Oc1ccc(C(F)(F)F)c(F)c1 ; O=[N+]([O-])c1ccc(C(OP(=O)(N2CC2)N2CC2)C(F)(F)F)cc1Oc1ccc(OC(F)(F)F)cc1 ; O=[N+]([O-])c1ccc(C(OP(=O)(N2CC2)N2CC2)C(F)(F)F)cc1Oc1ccc(F)c(C(F)(F)F)c1 ; O=[N+]([O-])c1ccc(C(OP(=O)(N2CC2)N2CC2)C(F)(F)F)cc1Oc1ccc(-c2ccc(F)cc2)c(F)c1 ; O=[N+]([O-])c1ccc(C(OP(=O)(N2CC2)N2CC2)C(F)(F)F)cc1Oc1ccc(-c2ccc(F)cc2F)c(F)c1 ; O=[N+]([O-])c1ccc(C(OP(=O)(N2CC2)N2CC2)C(F)(F)F)cc1Oc1ccc(-c2ccc(F)cc2)nc1]

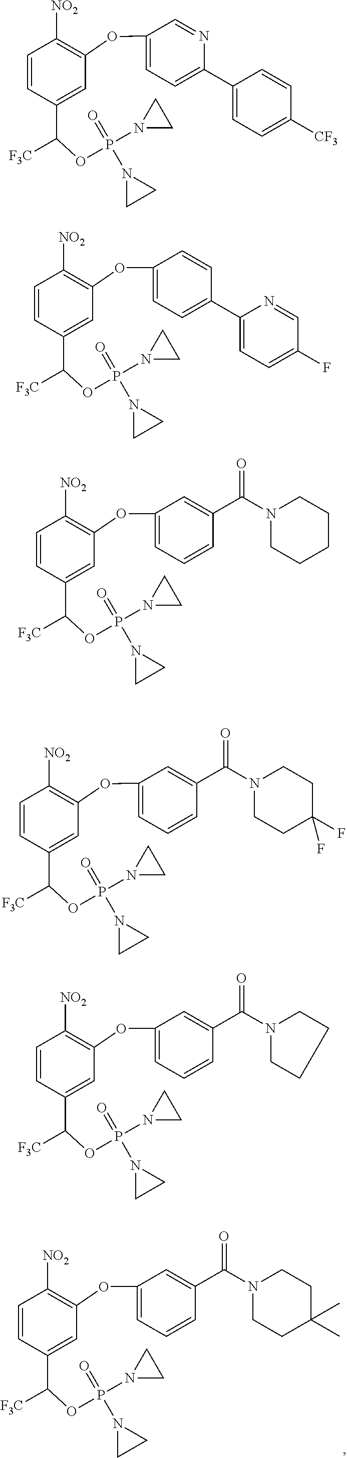 [SMILES: O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(F)cn2)cc1 ; O=C(c1cccc(Oc2cc(C(OP(=O)(N3CC3)N3CC3)C(F)(F)F)ccc2[N+](=O)[O-])c1)N1CCCCC1 ; O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1]

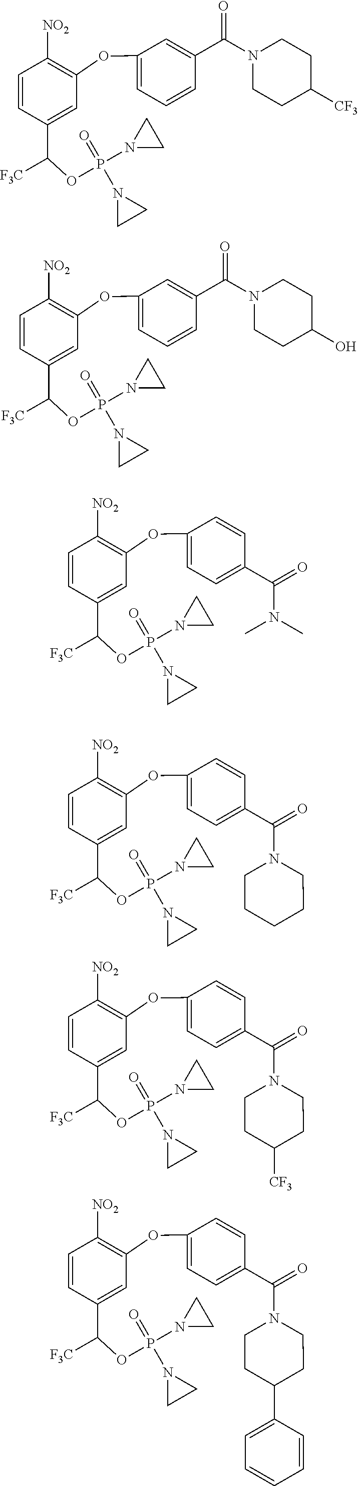

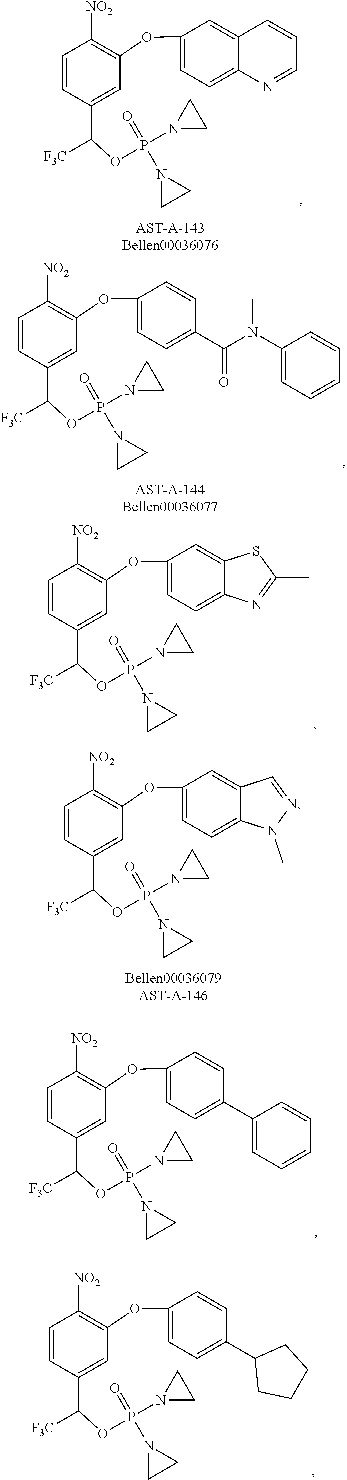 [SMILES: O=[N+]([O-])c1ccc(C(OP(=O)(N2CC2)N2CC2)C(F)(F)F)cc1Oc1ccc2ncccc2c1 ; CN(C(=O)c1ccc(Oc2cc(C(OP(=O)(N3CC3)N3CC3)C(F)(F)F)ccc2[N+](=O)[O-])cc1)c1ccccc1 ; Cc1nc2ccc(Oc3cc(C(OP(=O)(N4CC4)N4CC4)C(F)(F)F)ccc3[N+](=O)[O-])cc2s1 ; Cn1ncc2cc(Oc3cc(C(OP(=O)(N4CC4)N4CC4)C(F)(F)F)ccc3[N+](=O)[O-])ccc21 ; O=[N+]([O-])c1ccc(C(OP(=O)(N2CC2)N2CC2)C(F)(F)F)cc1Oc1ccc(-c2ccccc2)cc1 ; O=[N+]([O-])c1ccc(C(OP(=O)(N2CC2)N2CC2)C(F)(F)F)cc1Oc1ccc(C2CCCC2)cc1]

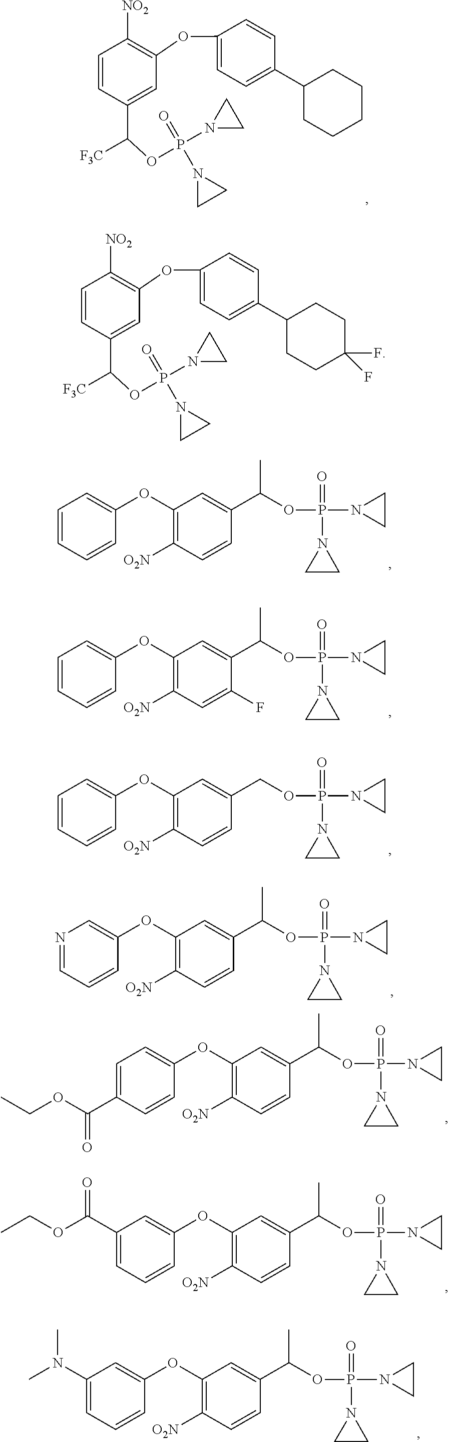

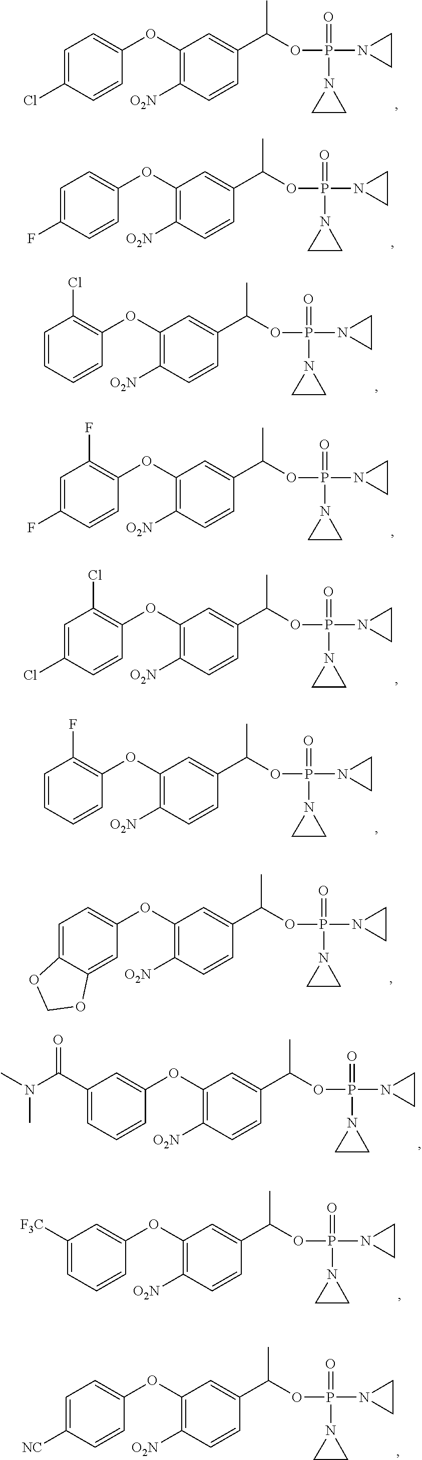

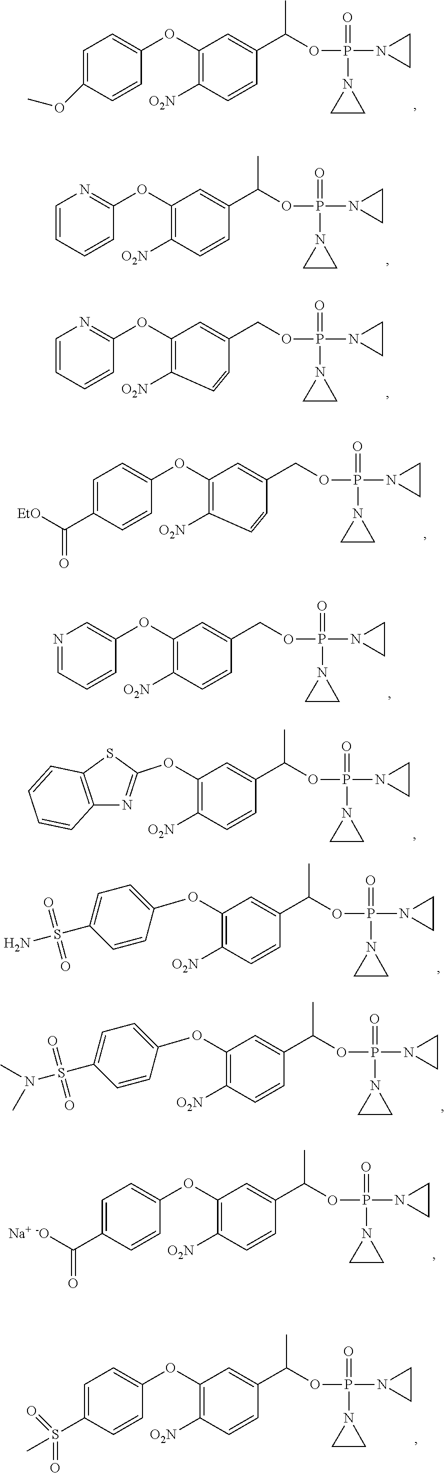

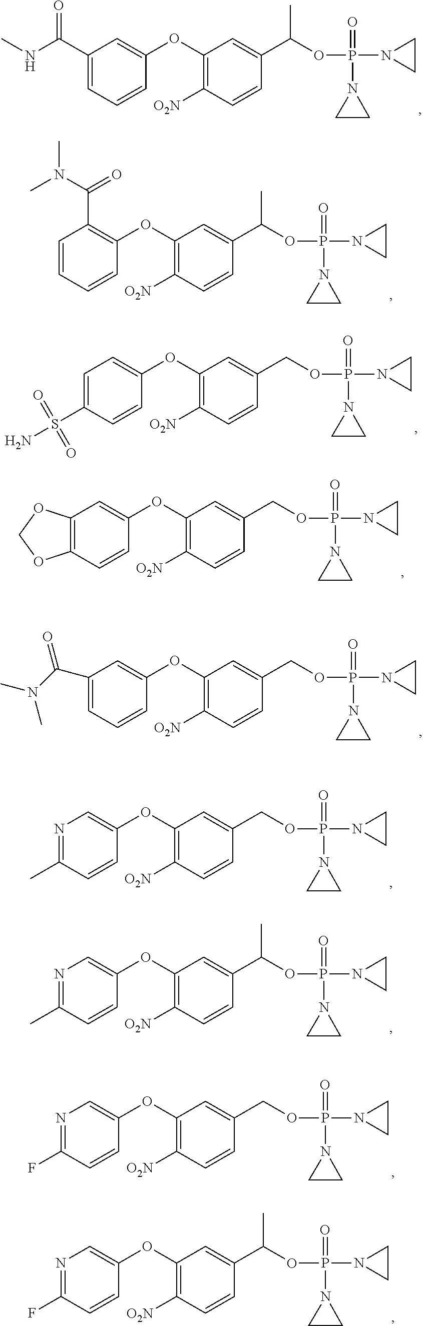

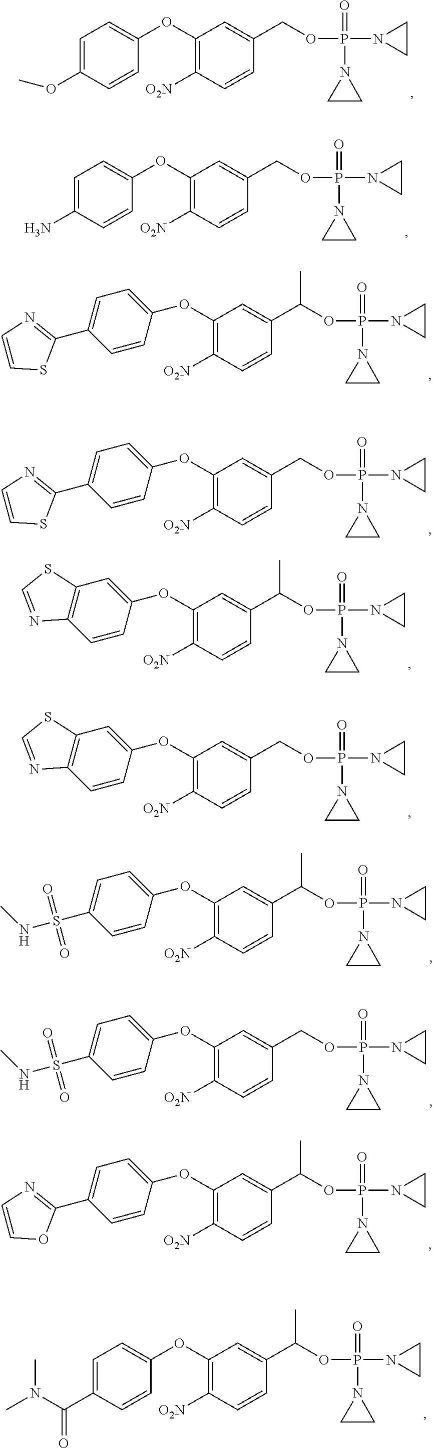

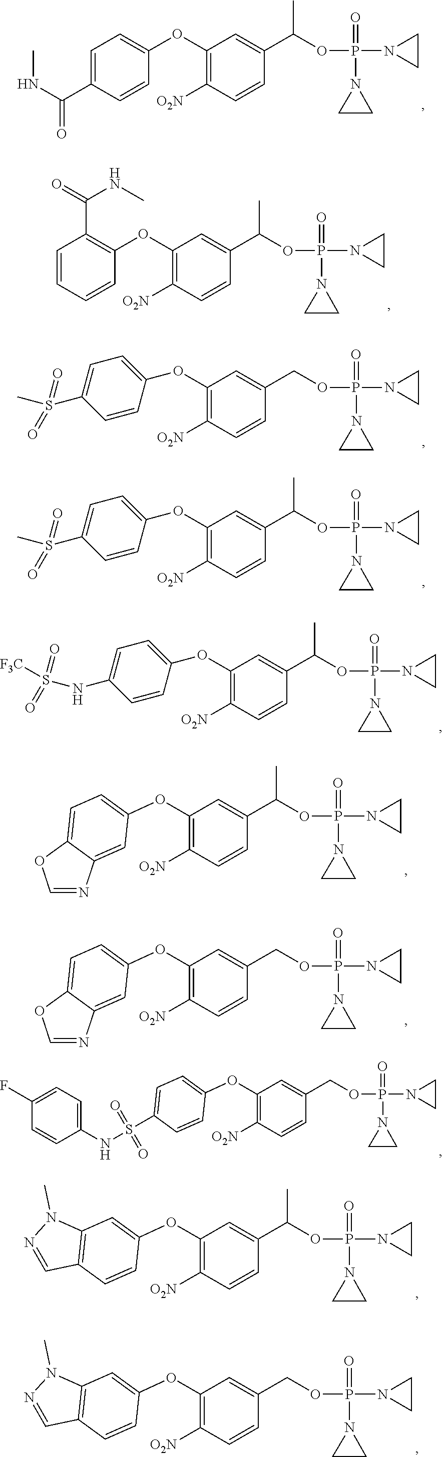

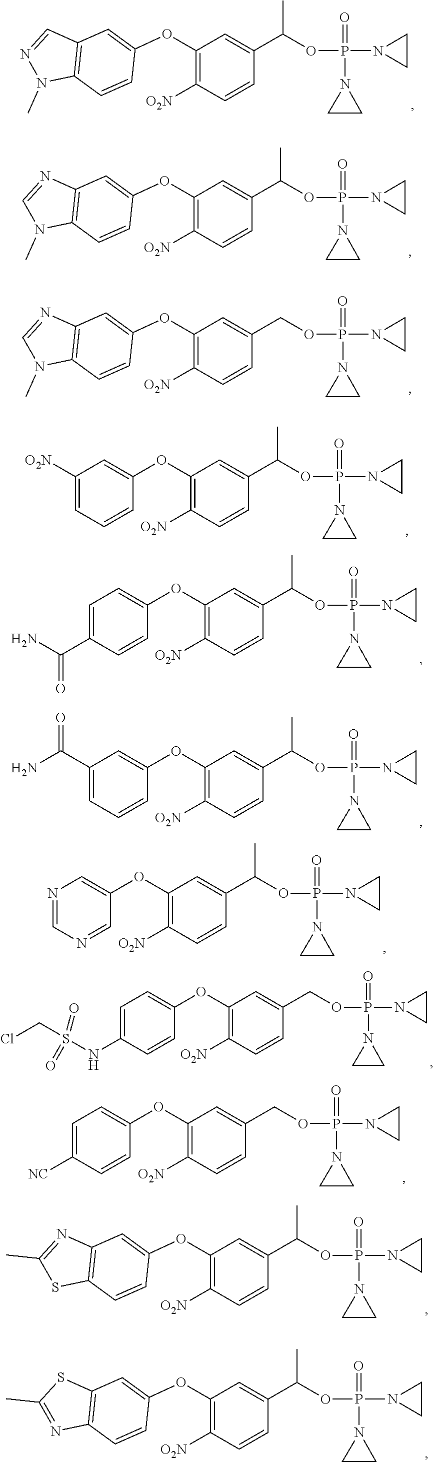

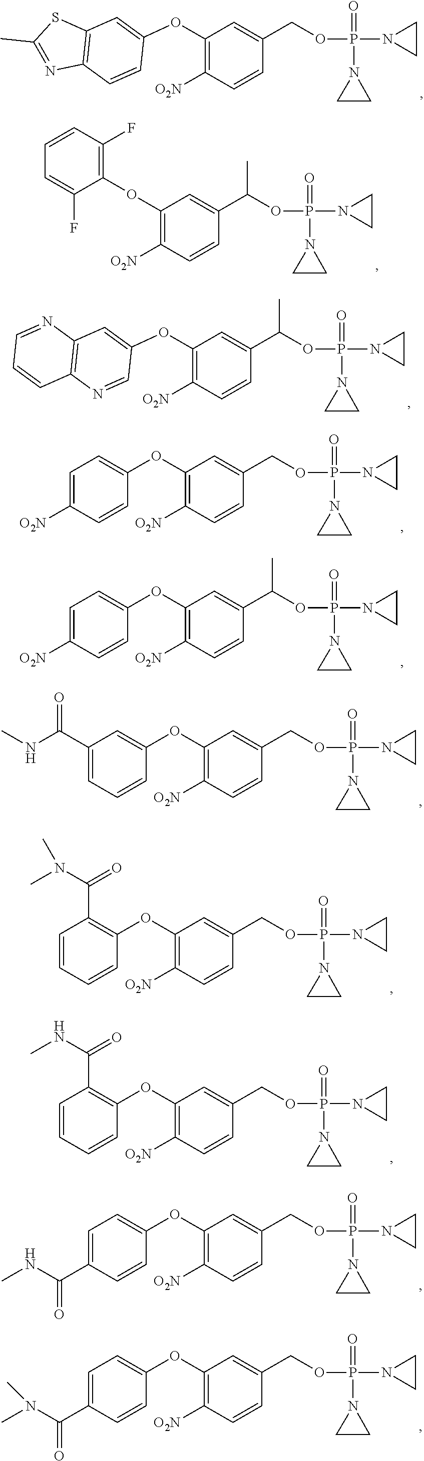

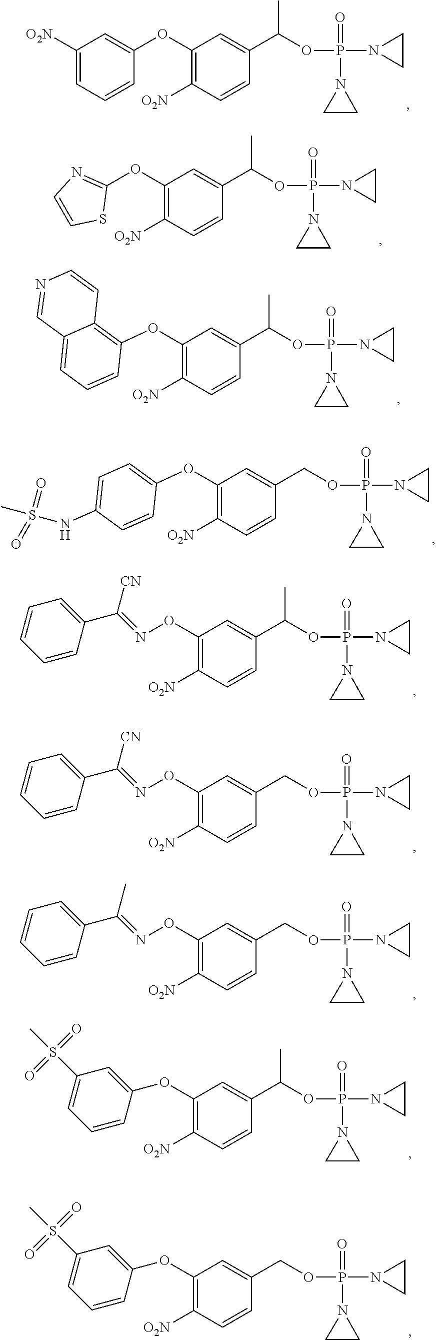

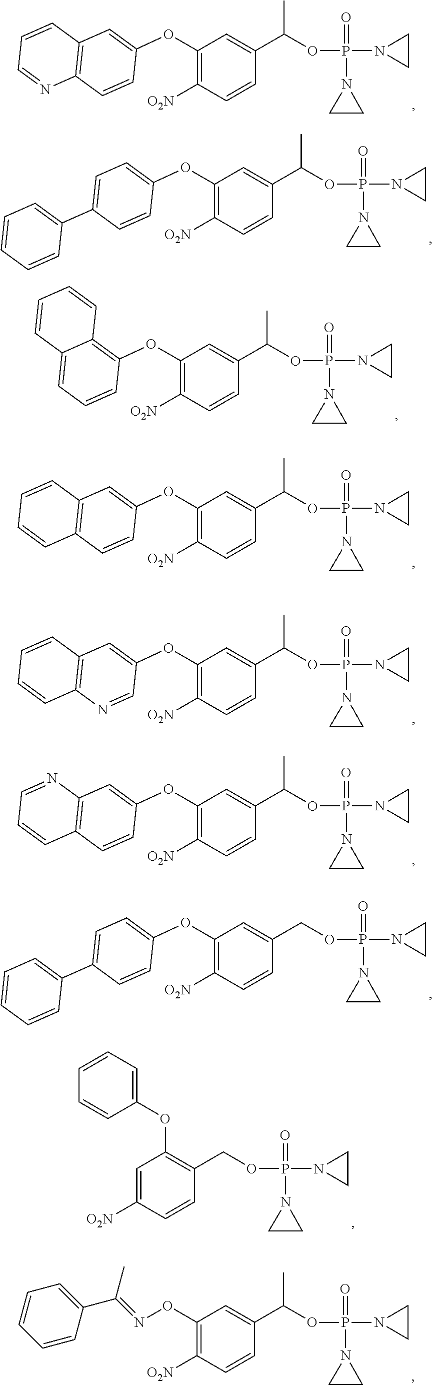

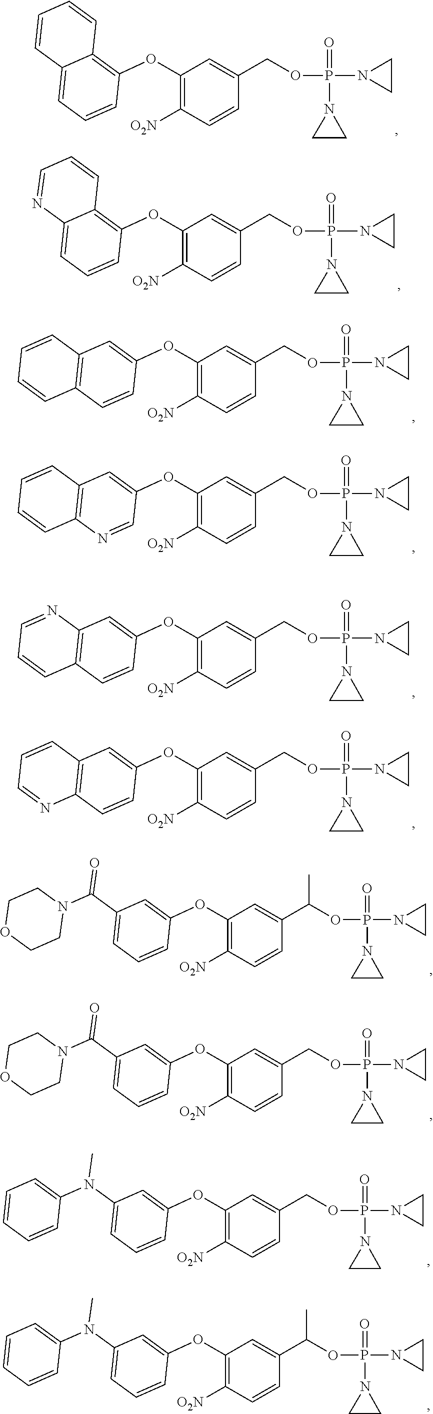

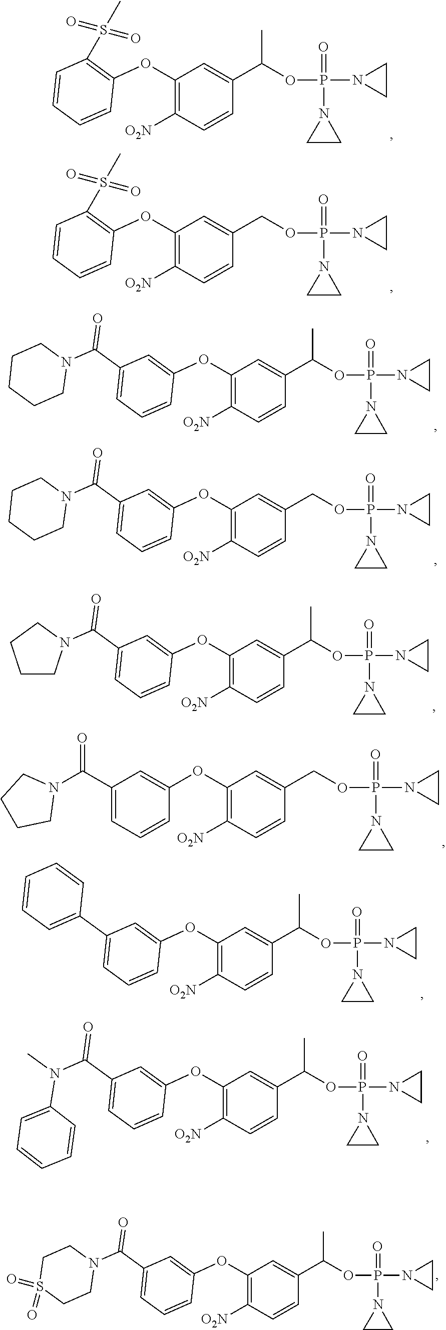

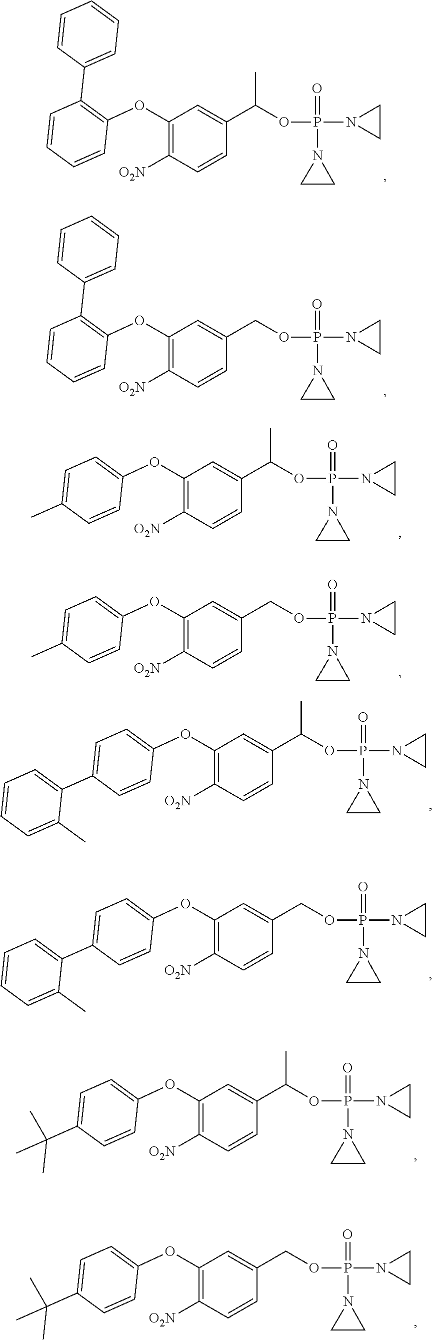

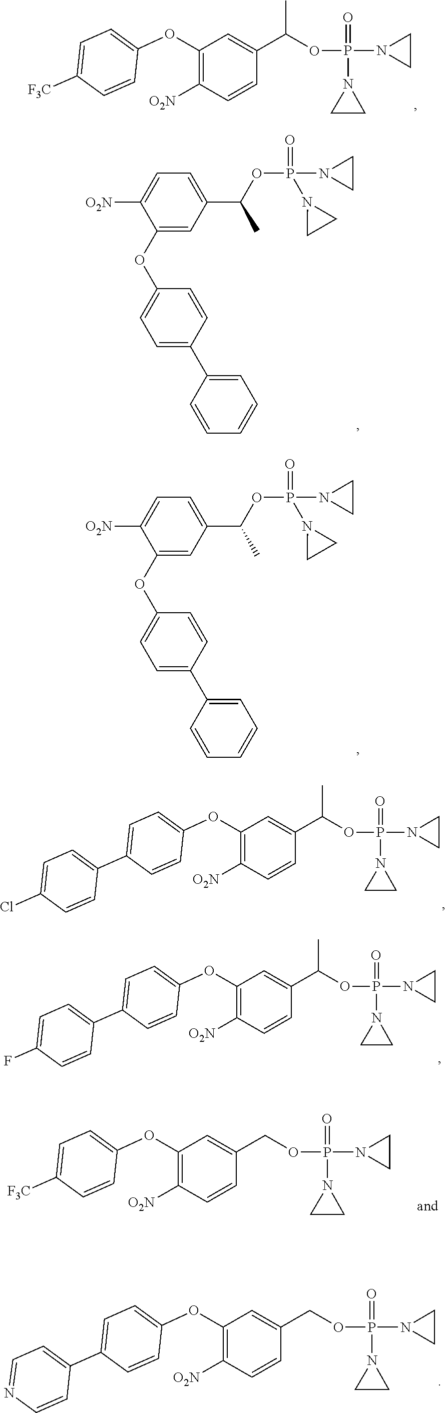

For the specific definitions and meanings, and the preparation methods and spectral data, please refer to PCT/US2016/021581 (Publication No. WO2016145092A1), which corresponds to Chinese Application No. 2016800150788 (Publication No. CN107530556A); and PCT/CN2020/089692 (Publication No. WO2020228685A9), which are incorporated herein by reference in their entirety.

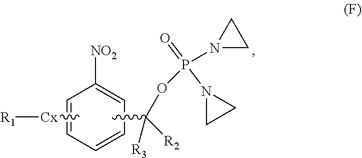

wherein the definitions of R1, R2, R3, and Cx are as described in the claims of Patent Application PCT/CN2020/114519 (Publication No. WO2021120717A1), which corresponds to Chinese Application No. 2020800673113 (Publication No. CN114466853A), and the methods for synthesizing and preparing the specific compounds are also described in the aforementioned application, which is incorporated in its entirety into the present application. The specific definitions are as follows:
Cx is a 5- to 10-membered aryl ring or heteroaryl ring, a heteroaliphatic ring or a cycloalkane, and the Cx shares two carbons with the nitrobenzene ring to form a fused ring structure;
R₁ is attached to any skeleton atom of the Cx ring, and the R₁ is selected from a hydrogen, a halogen atom, a cyano or isocyano group, an hydroxyl group, an thiol group, an amine, an OTs, a C₁-C₆ alkyl group or a Z-substituted alkyl group, a C₂-C₆ alkenyl group or a Z-substituted alkenyl group, a C₂-C₆ alkynyl group or a Z-substituted alkynyl group, a C₃-C₈ cycloalkyl group or a Z-substituted cycloalkyl group, a C₆-C₁₀ aryl group or a Z-substituted aryl group, a 4- to 15-membered heterocycle or a Z-substituted heterocycle, a 5- to 15-membered heteroaryl group or a Z-substituted heteroaryl group, an alkoxyl group with 1-6 carbon atoms or a Z-substituted alkoxyl group with 1-6 carbon atoms, —CONR⁶R⁷, —SO₂NR⁶R⁷, —SO₂R⁶, —OCOO—R⁶, —COOR⁶, —NR⁶COR⁷, —OCOR⁶, —NR⁶SO₂R⁷ and —NR⁶SO₂NR⁶R⁷;
R₂ and R₃ are each independently a hydrogen, a C₁-C₆ alkyl group or a Z-substituted alkyl group, a C₂-C₆ alkenyl group or a Z-substituted alkenyl group, a C₂-C₆ alkynyl group or a Z-substituted alkynyl group, a C₃-C₈ cycloalkyl group or a Z-substituted cycloalkyl group, a C₆-C₁₀ aryl group or a Z-substituted aryl group, a 4- to 15-membered heterocycle or a Z-substituted heterocycle, a 5- to 15-membered heteroaryl group or a Z-substituted heteroaryl group, or R₂ and R₃, together with the carbon atom of benzyl to which they are bound, to form a 3-6 membered ring;
the

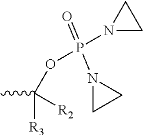

group can substitute the hydrogen atom at any position on the carbon atom of the fused ring, and the number of substitution is 1;
the substituent Z is a halogen atom, a cyano or isocyano group, a hydroxyl group, a thiol group, an amine group, a C₁-C₃ alkyl group or a substituted alkyl group, a C₁-C₃ alkoxyl group or a substituted alkoxyl group, a C₂-C₃ alkenyl group or a substituted alkenyl group, C₂-C₃ alkynyl group or a substituted alkynyl group, a C₃-C₈ cycloalkyl group or a substituted cycloalkyl group;
R⁶ and R⁷ are each independently a hydrogen, a C₁-C₆ alkyl group or a Z-substituted alkyl group, a C₂-C₆ alkenyl group or a Z-substituted C₂-C₆ alkenyl group, a C₂-C₆ alkynyl group or a Z-substituted C₂-C₆ alkynyl group, C₃-C₈ cycloalkyl group or a Z-substituted cycloalkyl group, a C₆-C₁₀ aryl group or a Z-substituted C₆-C₁₀ aryl group, a 4- to 15-membered heterocylic group or a Z-substituted 4- to 15-membered heterocyclic group, 5- to 15-membered heteroaryl group or a Z-substituted 5- to 15-membered heteroaryl group, or R⁶ and R⁷, together with the atom to which they are bound to form a 5-7 membered heterocyclyl or Z-substituted 5-7 membered heterocyclyl.

Specifically, Compound F is selected from compounds having the following structures:

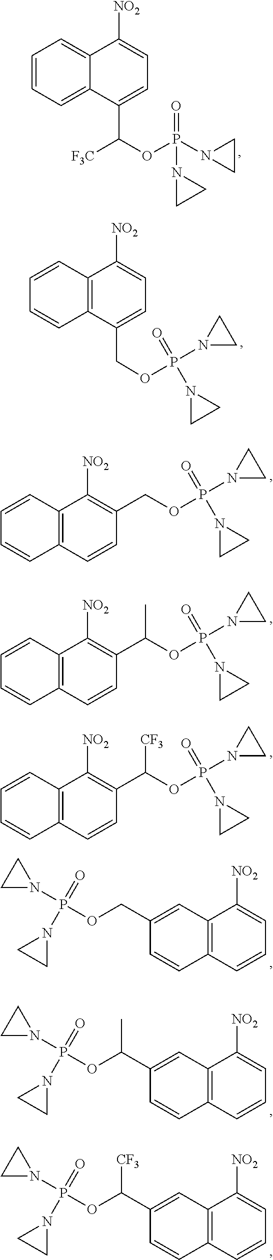

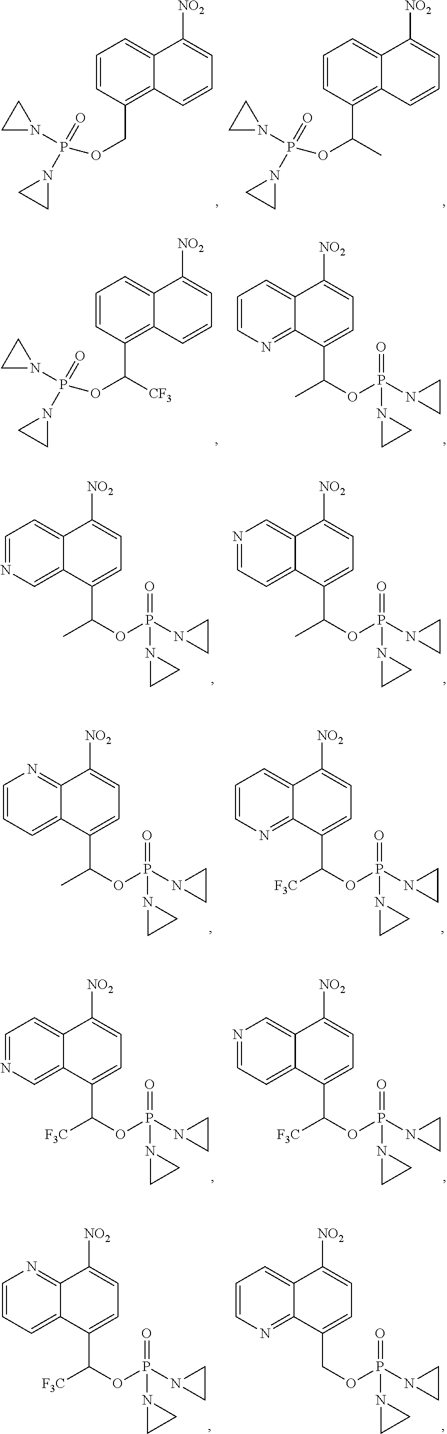

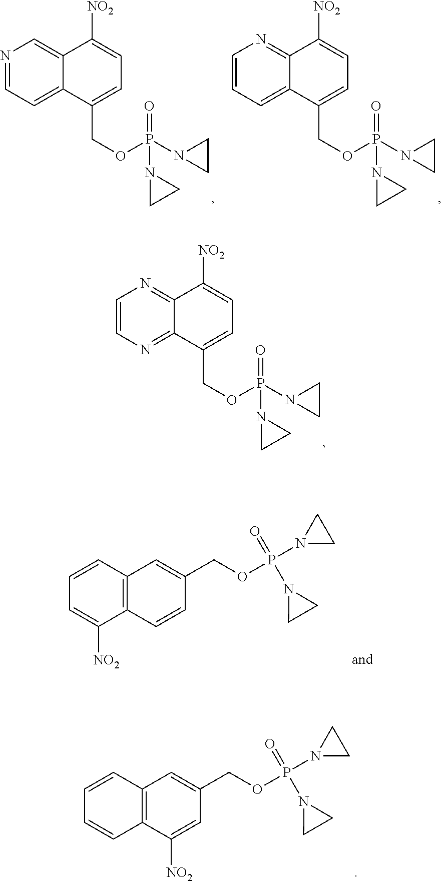 [SMILES: O=[N+]([O-])c1ccc(COP(=O)(N2CC2)N2CC2)c2ccncc12 ; O=[N+]([O-])c1ccc(COP(=O)(N2CC2)N2CC2)c2cccnc12 ; O=[N+]([O-])c1ccc(COP(=O)(N2CC2)N2CC2)c2nccnc12 ; O=[N+]([O-])c1cccc2cc(COP(=O)(N3CC3)N3CC3)ccc12 ; O=[N+]([O-])c1cc(COP(=O)(N2CC2)N2CC2)cc2ccccc12]

The specific methods for synthesizing the compounds of formula (F) and the corresponding spectral data are disclosed in WO2021120717A1 (corresponding to Chinese Publication CN114466853A, which is incorporated herein by reference in its entirety.

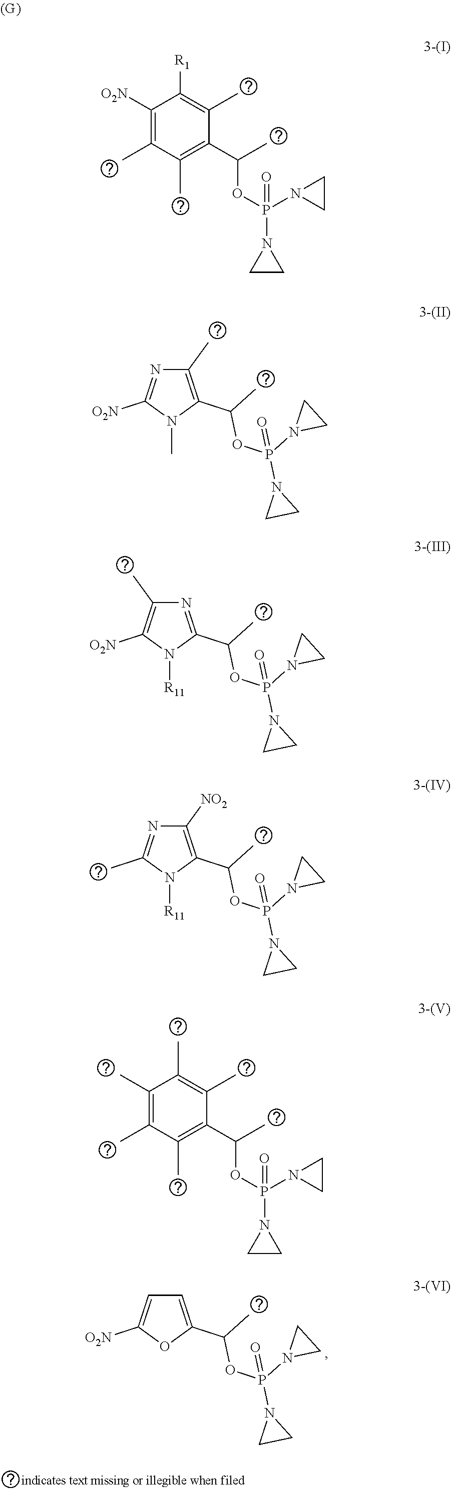

wherein the definitions of R₁, R₂, R₃, R₄, R₅, R₆, R₇, R₈, R₉, R¹⁰, R₁₁, R₁₂, R₁₃, R₁₄, R₁₅, R₁₆ and R₁₇ are as described in the claims of Patent Application PCT/US2016/039092 (Publication No. WO2016210175A1), which corresponds to Chinese Application No. 2016800368985 (Publication No. CN108024974A), and the methods for synthesizing and preparing the specific compounds are also described in the aforementioned application, which is incorporated in its entirety into the present application. The specific definitions are as follows:
R₁ is hydrogen, —N₃, CN, halo, NR²¹R²², —OR²³, —SO₂(C₁-C₆ alkyl), C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl, or ether;
each R²¹ and R²² independently is hydrogen, hydroxy, C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl, or —SO₂ (C₁-C₆ alkyl); or R²¹ and R²² together with the nitrogen atom they are bonded to form a 4-15 membered heterocycle or a 5-15 membered heteroaryl;
R²³ is hydrogen, C₁-C₆ alkyl, or C₆-C₁₀ aryl;
R₂ and R₃ are independently hydrogen or halo;
R₄ is hydrogen, halo, C₁-C₆ alkoxy, C₁-C₆ alkyl, or C₆-C₁₀ aryl,
R₅, R₇, R₉, R₁₂ and R₁₅ independently are hydrogen, C₁-C₆ alkyl, C₂-C₆ alkenyl, C₂-C₆ alkynyl, C₃-C₈ cycloalkyl, C₆-C₁₀ aryl, 4-15 membered heterocycle, 5-15 membered heteroaryl; or R₄ and R₅ together with the intervening carbon atoms between them form a C₅-C₆ cycloalkyl ring;
R₆ and R₁₀ independently are hydrogen or halo;
R₈ is hydrogen, C₁-C₆ alkyl, C₂-C₆ alkenyl, C₂-C₆ alkynyl, or 5-15 membered heteroaryl;
each R₁₁ independently is C₁-C₆ alkyl, C₂-C₆ alkenyl, C₂-C₆ alkynyl, C₃-C₈ cycloalkyl, or C₆-C₁₀ aryl;
R₁₃, R₁₄, R₁₆, and R₁₇ are independently hydrogen, halo, C₁-C₆ alkyl, C₂-C₆ alkenyl, C₂-C₆ alkyny, or C₁-C₆ alkoxy;
wherein the alkyl, alkenyl, alkynyl, cycloalkyl, aryl, heterocycle, heteroaryl, alkoxy and ether groups are optionally substituted.

Specifically, Compound G is selected from compounds having the following structures:

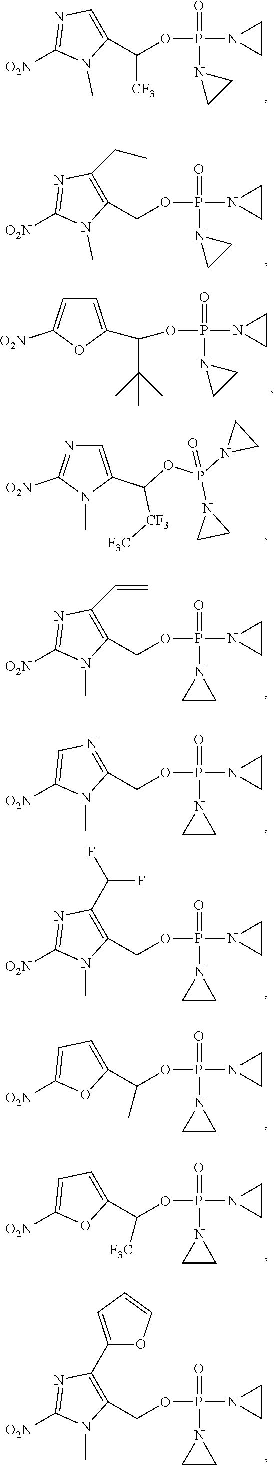

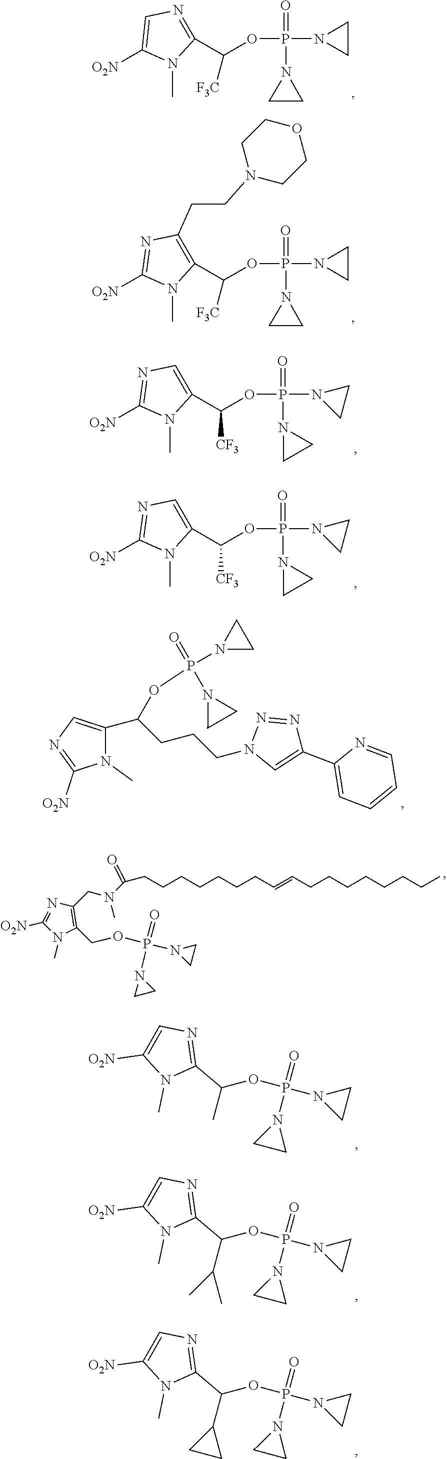

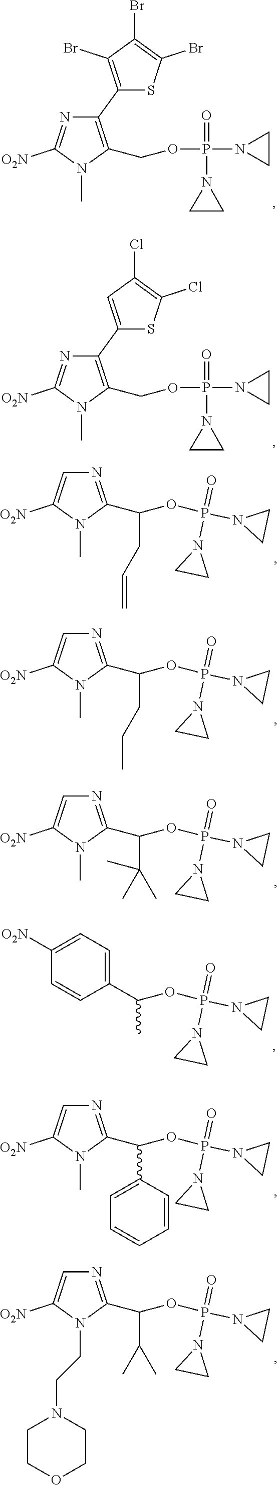

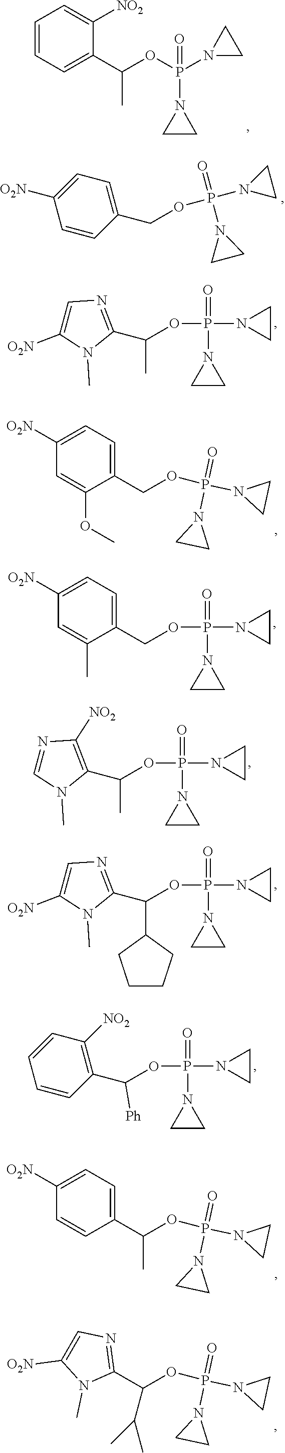

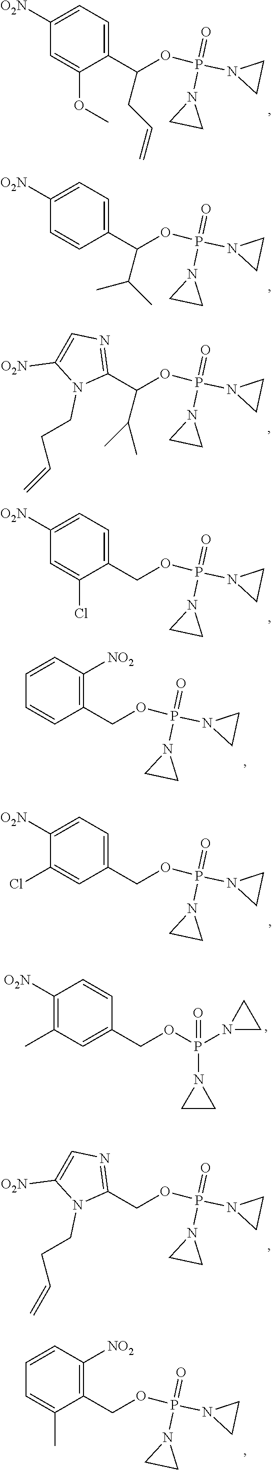

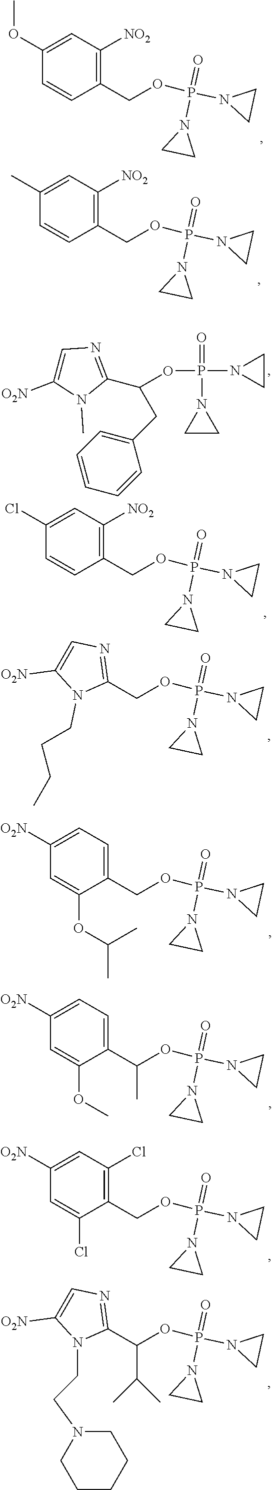

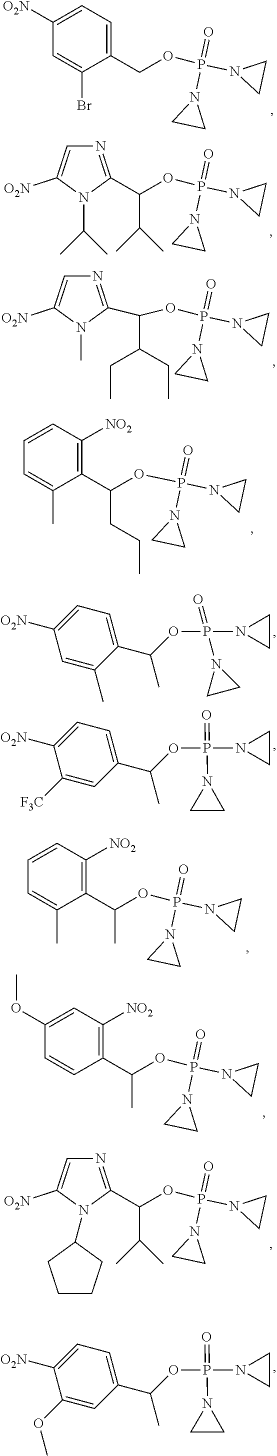

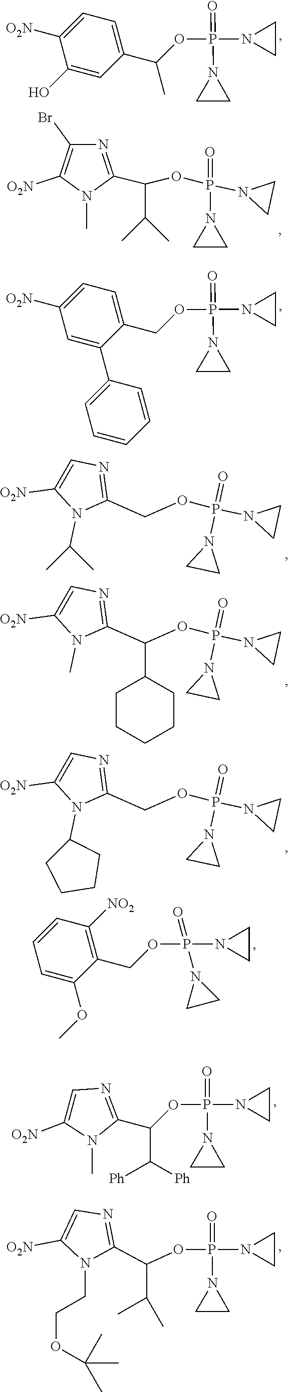

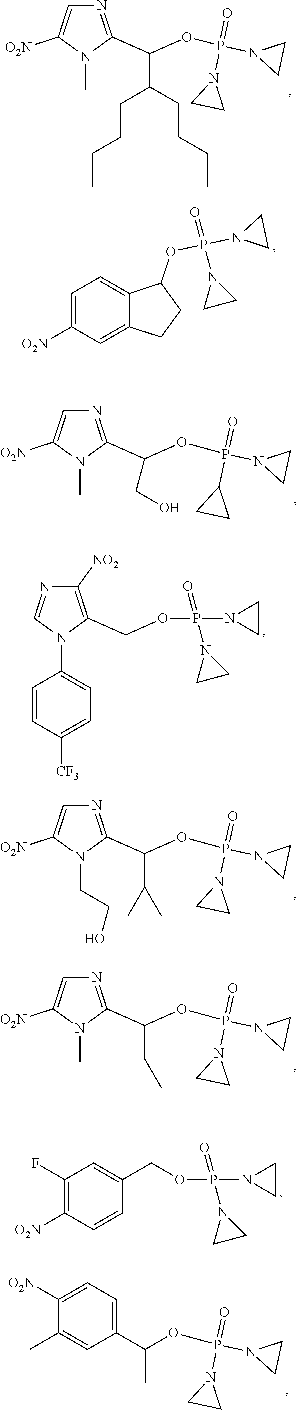

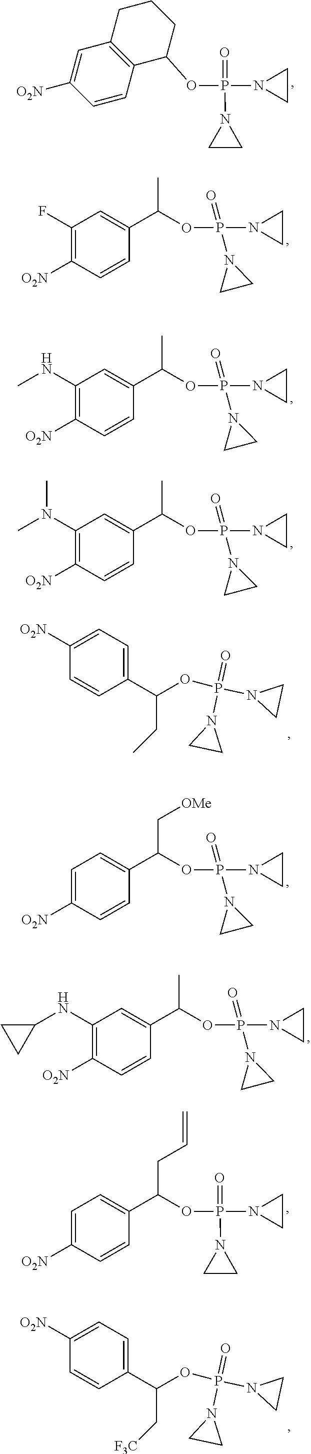

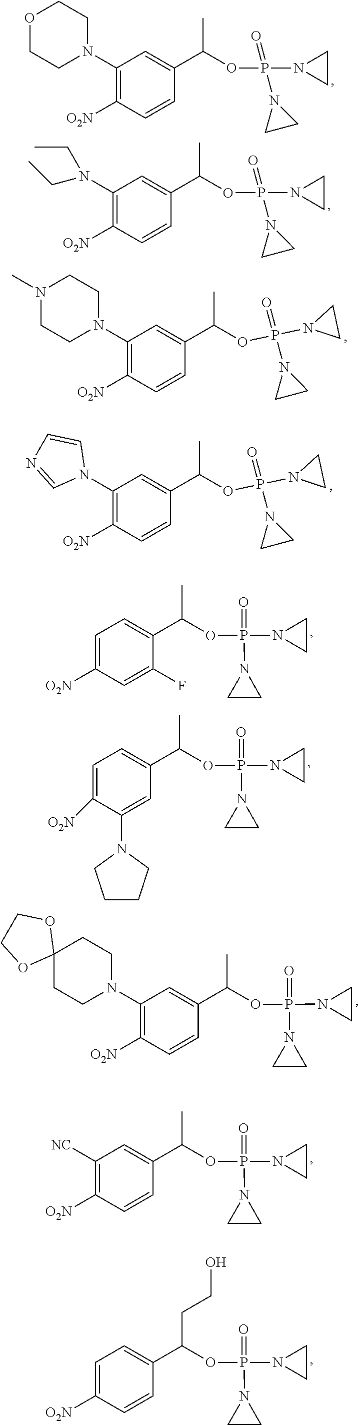

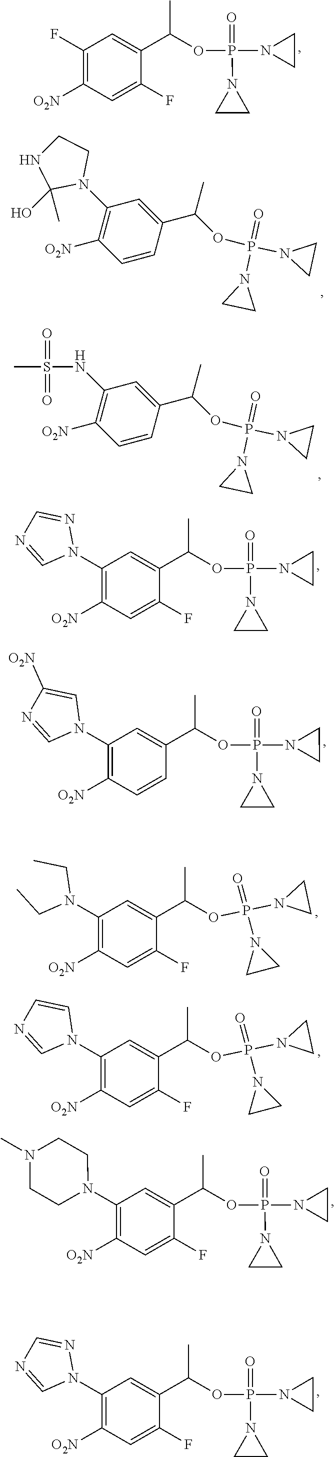

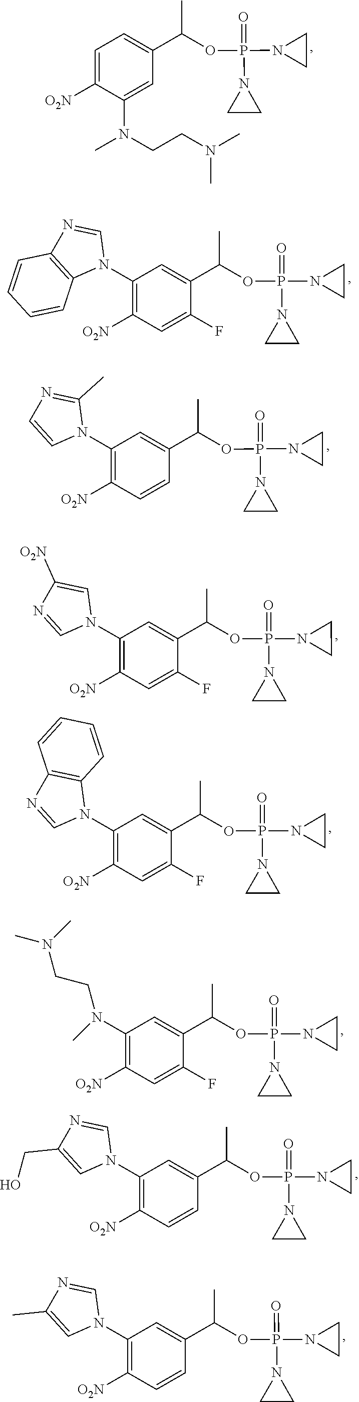

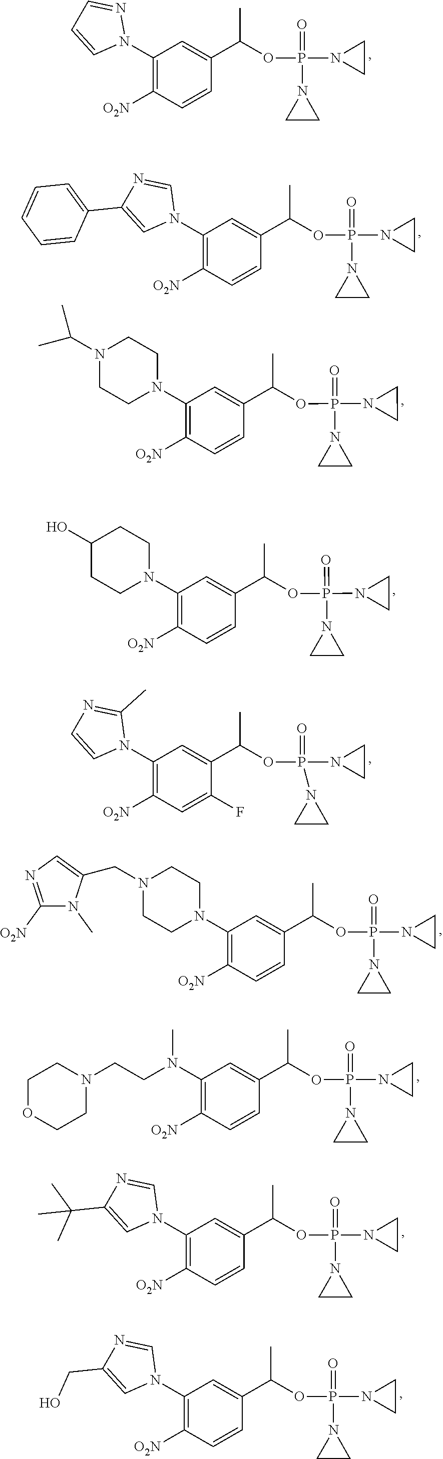

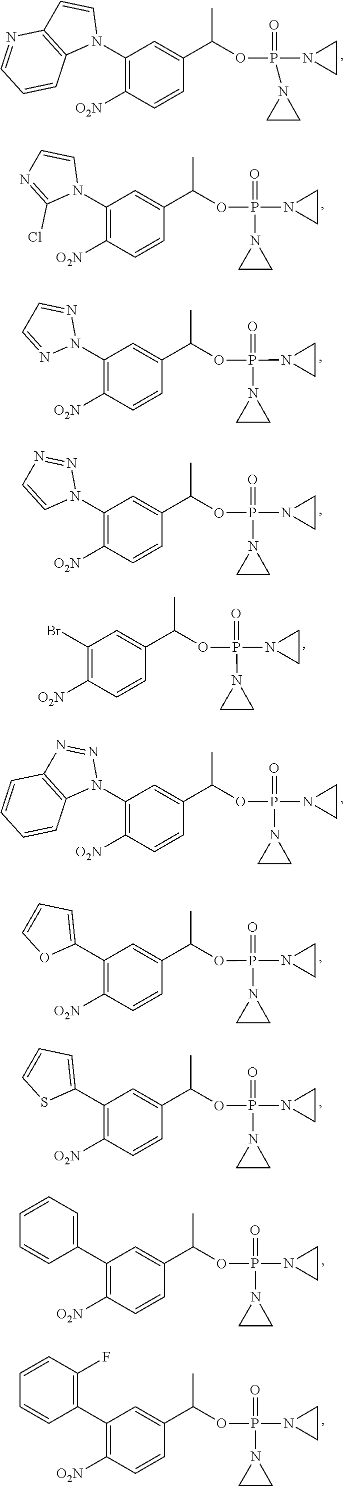

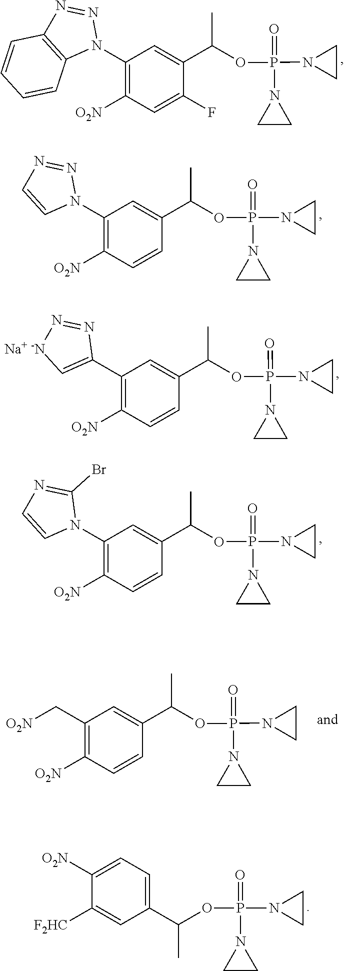

The specific methods for synthesizing the compounds of formula (G) and the corresponding spectral data are disclosed in WO2016210175A1 (corresponding to Chinese Publication CN108024974A), which is incorporated herein by reference in its entirety.

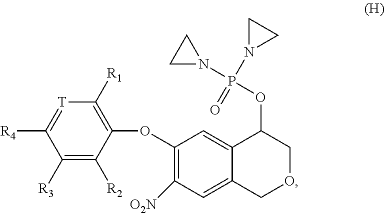

wherein the definitions of R₁, R₂, R₃, R₄ and T are as described in the claims of Patent Application PCT/CN2021/118597 (Publication No. WO2022057838A1), and the methods for synthesizing and preparing the specific compounds are also described in the aforementioned application, which is incorporated in its entirety into the present application. The specific definitions are as follows.
T is N or CH;
R₁ and R₂ are each independently H, F, Cl, Br, I or C₁₋₃ alkyl, wherein the C₁₋₃ alkyl is optionally substituted with one, two or three Rₐ;
each Rₐ is independently F, Cl, Br, I, —CN, —OH or —NH₂;
R₃ and R₄ are each independently H, F, Cl, Br, I, CN, C₁₋₃ alkyl, C₁₋₃ alkoxy,

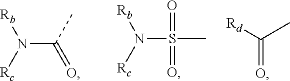

wherein the C₁₋₃ alkyl is optionally substituted with one, two or three R_{c};
R_{b} and R_{c} are each independently H, —CH₃, —CH₂CH₃, —(CH₂)₂CH₃ or —CH(CH₃)₂;
R_{d} is —CH₃, —CH₂CH₃, —(CH₂)₂CH₃ or —CH(CH₃)₂;
each R_{c} is independently F, Cl, Br, I, —CN, —OH or —NH₂.

Specifically, Compound H is selected from the following specific compounds:

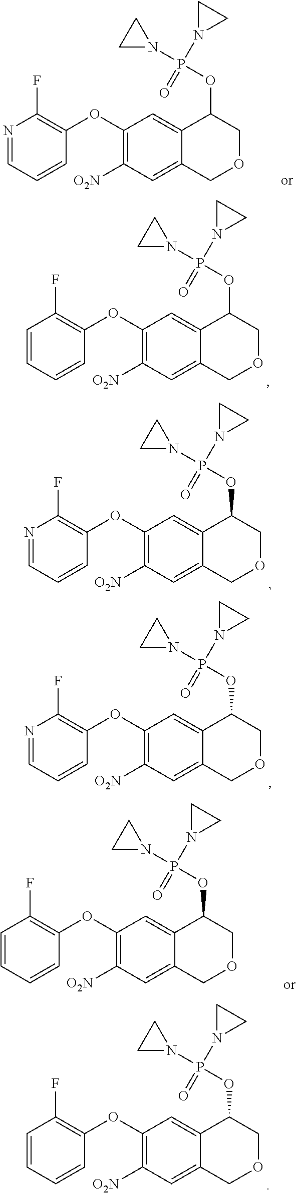

The specific methods for synthesizing the compounds of formula (H) and the corresponding spectral data are disclosed in WO2022057838A1, which is incorporated herein by reference in its entirety.

There is provided use of Br-IPM and Cl-IPM having the aforementioned crystal forms or obtained by the aforementioned production processes, as reactants, for synthesizing and preparing Compound A, Compound B, Compound C, Compound D, Compound E, Compound F, Compound G, and Compound H. The specific synthetic routes are provided here.

Compound A1 is reacted with Compound III to obtain Compound A:

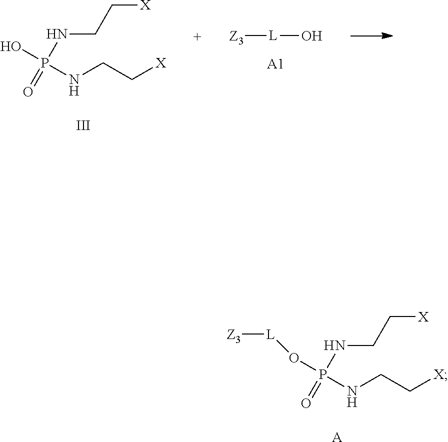

Compound B1 is reacted with Compound III to obtain Intermediate B2, which is subjected to a ring-closure reaction to obtain Compound B:

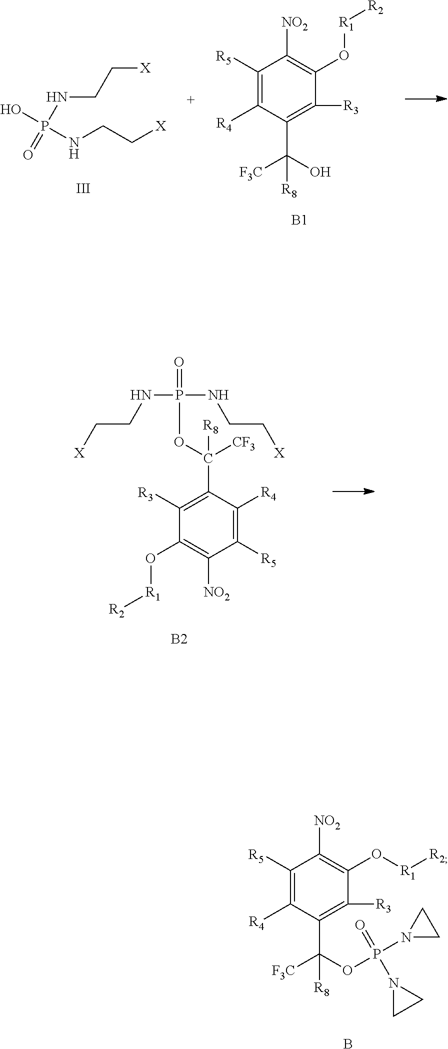

Compound C1 is reacted with Compound III to obtain Intermediate C2, which is subjected to a ring-closure reaction to obtain Compound C:

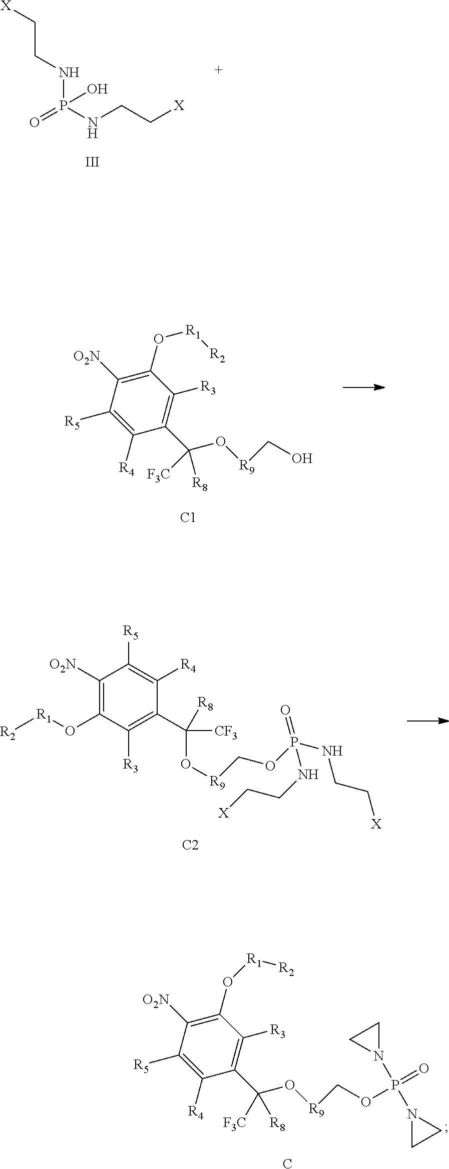

Compound D1 is reacted with Compound III to obtain Intermediate D2, which is subjected to a ring-closure reaction to obtain Compound D:

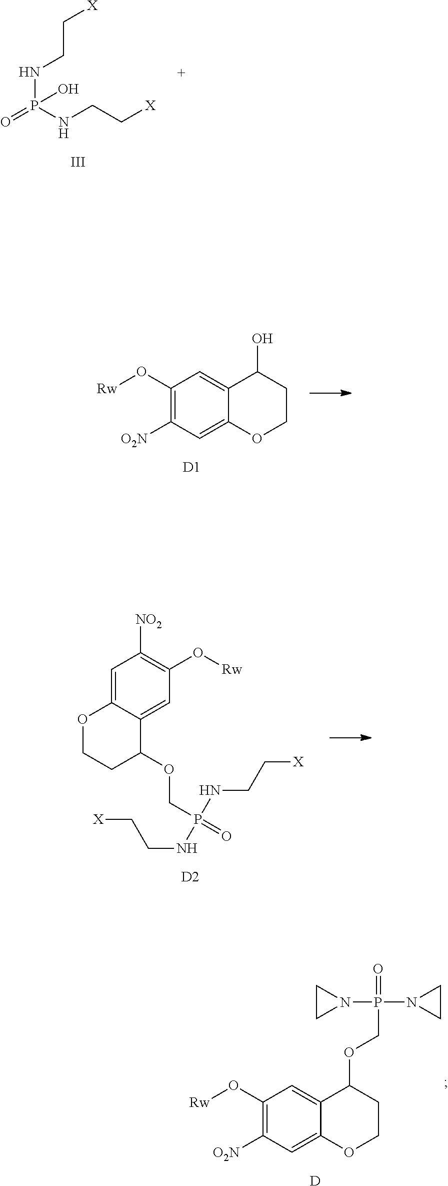

Compound E1 is reacted with Compound III to obtain Intermediate E2, which is subjected to a ring-closure reaction to obtain Compound E:

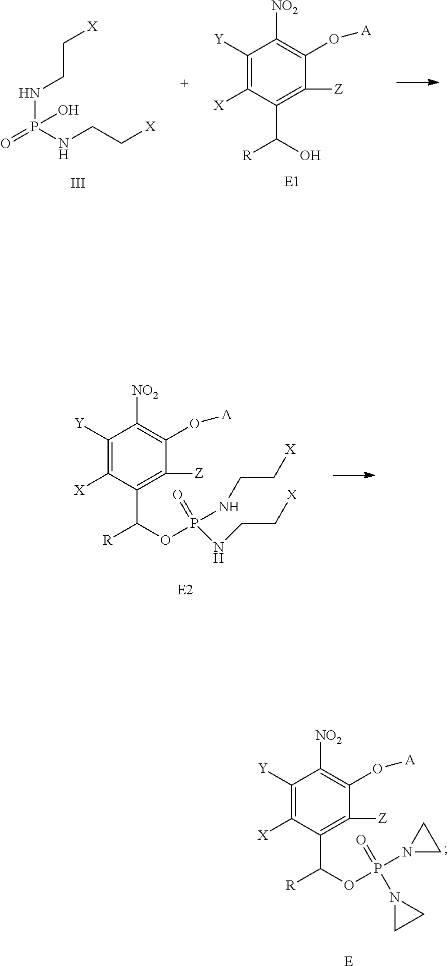

Compound F1 is reacted with Compound III to obtain Intermediate F2, which is subjected to a ring-closure reaction to obtain Compound F:

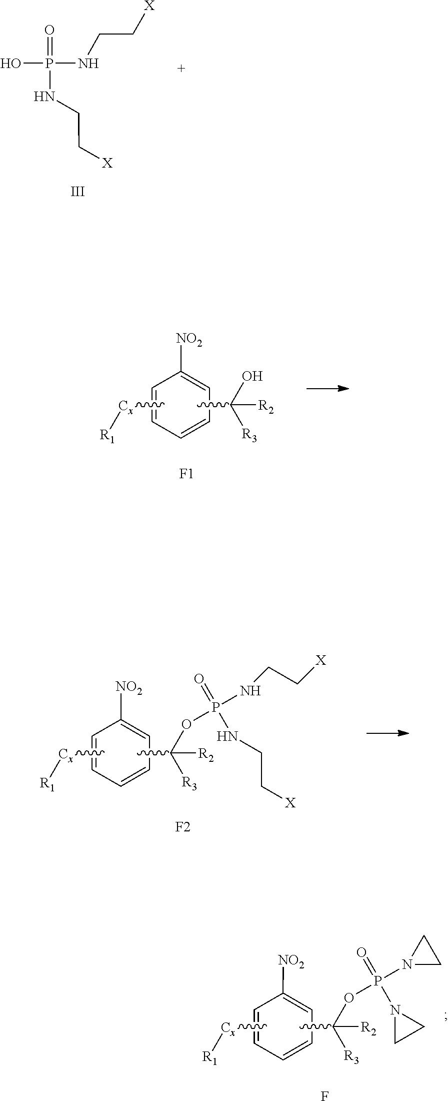

Compound G1-3-(I) is reacted with Compound III to obtain Intermediate G2-3-(I), which is subjected to a ring-closure reaction to obtain Compound G-3-(I):

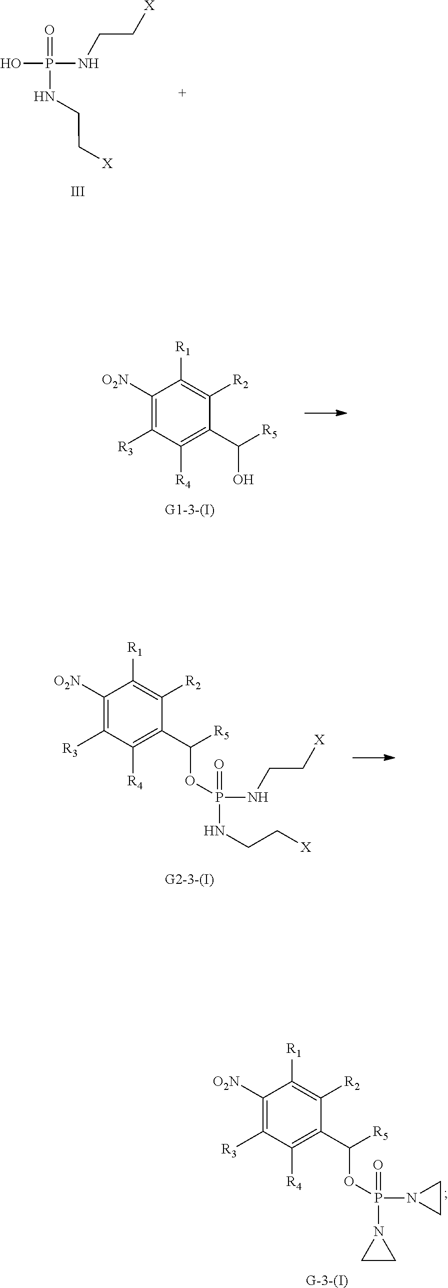

Compound H1 is reacted with Compound III to obtain Intermediate H2, which is subjected to a ring-closure reaction to obtain Compound H:

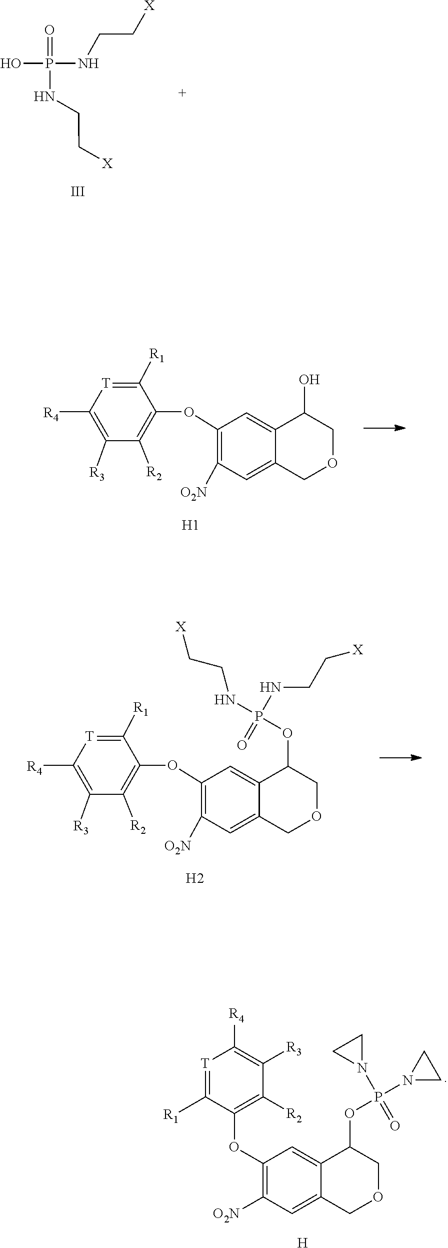

The present invention further provides a method for detection of HPLC purity of Br-IPM, using any one or more of the following detection parameters:
a reversed-phase C18 column is used as a chromatographic column for separation;
an ultraviolet detector is used for detection, with a detection wavelength of 210 nm;
a two-phase eluent is used for elution, with mobile phase A being a 0.1% phosphoric acid solution, and mobile phase B being acetonitrile;
a gradient elution procedure comprises varying the volume percentage of mobile phase A from 90% to 20%, and when the volume percentage of mobile phase A is 20%, isocratic elution is performed for a period of time;
preferably, signal peaks of Br-IPM are detected by the ultraviolet detector when the volume percentage of mobile phase A is in the range of 20% to 40%.

The percent purity of Br-IPM is calculated based on the peak area of Br-IPM using the area normalization method.

Preferably, the chromatographic column used is a Thermo Acclaim™ 120A C18 column (250*4.6 mm), the flow rate of the mobile phases is 0.7 ml/min, and the elution procedure is as follows:

| | Volume | Volume |
|---|---|---|
| | percentage | percentage |
| | of mobile | of mobile |
| Time/min | phase A | phase B |
| 0 | 90 | 10 |
| 5 | 90 | 10 |
| 35 | 20 | 80 |
| 40 | 20 | 80 |
| 40.1 | 90 | 10 |
| 45 | 90 | 10 |

Signal peaks of corresponding Br-IPM are detected by the ultraviolet detector within 12-15 minutes.

### BRIEF DESCRIPTION OF THE DRAWINGS

FIG. 1 is the ¹H-NMR spectrum of the Cl-IPM prepared in Example 1.

FIG. 2 is the ³¹P-NMR spectrum of the Cl-IPM prepared in Example 1.

FIG. 3 is the X-ray powder diffraction pattern of the Cl-IPM prepared in Example 1 (the test was performed using Cu-Kα at a temperature of 25° C. and a humidity of 35%, the sample was uniformly ground to pass 100 mesh, and the angle of refraction was represented by 20).

FIG. 4 is the differential scanning calorimetry (DSC) pattern of the Cl-IPM prepared in Example 1 (the test was performed using an Al₂O₃ crucible at a temperature range of 25° C.-410° C. and a heating rate of 10° C./min; the flow rate of the purging nitrogen was 50 ml/min, and the flow rate of the protective nitrogen was 20 ml/min).

FIG. 5 is the X-ray powder diffraction pattern of the Cl-IPM prepared in Comparative Example 1 (the test was performed using Cu-Kα at a temperature of 25° C. and a humidity of 35%, the sample was uniformly ground to pass 100 mesh, and the angle of refraction was represented by 20).

FIG. 6 is the differential scanning calorimetry (DSC) pattern of the Cl-IPM prepared in Comparative Example 1 (the test was performed using an Al₂O₃ crucible at a temperature range of 25° C.-410° C. and a heating rate of 10° C./min; the flow rate of the purging nitrogen was 50 ml/min, and the flow rate of the protective nitrogen was 20 ml/min).

FIG. 7 is the superimposed X-ray powder diffraction patterns of the Cl-IPM prepared in Example 1 and the Cl-IPM prepared in Comparative Example 1 (the test was performed using Cu-Kα at a temperature of 25° C. and a humidity of 35%, the sample was uniformly ground to pass 100 mesh, and the angle of refraction was represented by 2θ), wherein the abscissa indicates 2θ, the ordinate indicates the peak heights (cts), X represents the pattern of the Cl-IPM prepared in Example 1, and Y represents the pattern of the Cl-IPM prepared in Comparative Example 1.

FIG. 8 is the HPLC spectrum of the Br-IPM prepared in Experiment Si of Example 2.

FIG. 9 is the X-ray powder diffraction pattern of the Br-IPM prepared in Experiment Si of Example 2 (the test was performed using Cu-Kα at a temperature of 25° C. and a humidity of 35%, the sample was uniformly ground to pass 100 mesh, and the angle of refraction was represented by 20).

FIG. 10 is the differential scanning calorimetry (DSC) pattern of the Br-IPM prepared in Experiment Si of Example 2 (the test was performed using an Al₂O₃ crucible at a temperature range of 25° C.-410° C. and a heating rate of 10° C./min; the flow rate of the purging nitrogen was 50 ml/min, and the flow rate of the protective nitrogen was 20 ml/min).

FIG. 11 is the X-ray powder diffraction pattern of the Br-IPM prepared in Comparative Example 2 (the test was performed using Cu-Kα at a temperature of 25° C. and a humidity of 35%, the sample was uniformly ground to pass 100 mesh, and the angle of refraction was represented by 20).

FIG. 12 is the differential scanning calorimetry (DSC) pattern of the Br-IPM prepared in Comparative Example 2 (the test was performed using an Al₂O₃ crucible at a temperature range of 25° C.-410° C. and a heating rate of 10° C./min; the flow rate of the purging nitrogen was 50 ml/min, and the flow rate of the protective nitrogen was 20 ml/min).

FIG. 13 shows the superimposed X-ray powder diffraction patterns of the Br-IPM prepared in Experiment Si of Example 2 and the Br-IPM prepared in Comparative Example 2 (the test was performed using Cu-Kα at a temperature of 25° C. and a humidity of 35%, the sample was uniformly ground to pass 100 mesh, and the angle of refraction was represented by 20), wherein the abscissa indicates 2θ, the ordinate indicates the peak heights (cts), M represents the pattern of the Br-IPM prepared in Experiment Si of Example 2, and N represents the pattern of the Br-IPM prepared in Comparative Example.

FIG. 14 is a curve graph showing the change of the content of Br-IPM over time when the Br-IPM prepared in Experiment Si of Example 2 was stored at −5° C., 2-8° C., and 25° C.

### EXAMPLES

The specific implementation of the present invention will be described below through specific examples.

All the experimental instruments and test conditions involved in the examples of the present application are as follows:

The instrument for ¹H-NMR and ³¹P-NMR spectroscopy was the German Bruker 400 MHz nuclear magnetic resonance (NMR) spectrometer AVANCE NEO 400 M; the test conditions were that 20 mg of a sample was dissolved in the deuterated reagent DMSO or other suitable solvents, and samples were taken and detected by AVANCE NEO 400 M at 400 HZ.

The X-ray powder diffraction (XRPD) instrument was Holland PANalytical-X′Pert 3 Powder; the test was performed using Cu-Kα at a temperature of 25° C. and a humidity of 35%, the sample was uniformly ground to pass 100 mesh, and the angle of refraction was represented by 20, to obtain X-ray powder diffraction patterns, with an error of <0.01°.

The instruments for differential scanning calorimetry (DSC) were a synchronous thermal analyzer, NETZSCH, Sta-449F3; and the test conditions were that the test was performed using an Al₂O₃ crucible at a temperature range of 25° C.-410° C. and a heating rate of 10° C./min; the flow rate of the purging nitrogen was 50 ml/min, the flow rate of the protective nitrogen was 20 ml/min; and the error range was +1° C. for the temperature and was ±5 μg for the mass.

### Description of the Abbreviations for the Reagents:

DCM is dichloromethane, TEA is triethylamine, THF is tetrahydrofuran, PPh₃ is triphenylphosphine, DIAD is diisopropyl azodicarboxylate, EtOAc is ethyl acetate, SiO₂ is silicon dioxide, PE is petroleum ether and DIPEA is N,N-diisopropylethylamine.

### Description of the Determination of the Yield and HPLC Purity:

In all the examples and the comparative examples provided by the present application, the amount of 2-haloethylamine hydrohalide was excessive relative to the amount of phosphorus oxyhalide. Therefore, all the yields were calculated based on the phosphorus oxyhalide, and specifically, the yields were obtained by dividing the amount obtained after the post-treatment by the theoretical amount.

### Example 1: Preparation of Cl-IPM

A typical operation of using the new method developed by the present invention for preparing Cl-IPM is as follows.

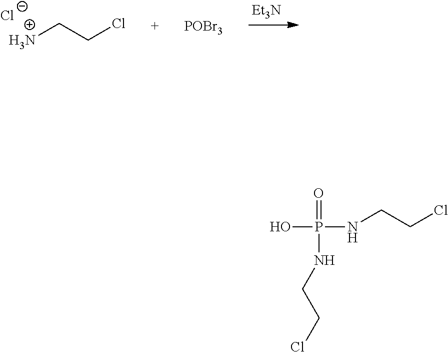

To a 250 ml dry three-necked flask was added 150 ml of dry dichloromethane and 7.2 g (0.0621 mol, 2.1 eq.) 2-chloroethylamine hydrochloride in sequence, the reaction mixture was coolled to −30° C., and 8.6 g (0.0300 mol, 1.0 eq.) phosphorus oxybromide was added. After the addition, the temperature continued to decrease to −70° C., then 8.4 ml (0.0600 mol, 2.0 eq.) of a solution of dry triethylamine dissolved in 20 ml of dry dichloromethane was slowly added dropwise to the reaction mixture, and the rate of the dropwise addition was controlled so that the temperature of the reaction solution did not exceed −70° C.

After completion of the dropwise addition, the temperature was naturally raised to −60° C. At this temperature, 4.2 ml (0.0300 mol, 1.0 eq.) of a solution of dry triethylamine dissolved in 20 ml of dry dichloromethane was slowly added dropwise to the reaction mixture, and the rate of the dropwise addition was controlled so that the temperature of the reaction solution did not exceed −60° C.

After completion of the dropwise addition, the temperature was naturally raised to −50° C. At this temperature, 4.2 ml (0.0300 mol, 1.0 eq.) of a solution of dry triethylamine dissolved in 20 ml of dry dichloromethane was slowly added dropwise to the reaction mixture, and the rate of the dropwise addition was controlled so that the temperature of the reaction solution did not exceed −50° C.

After completion of the dropwise addition, the temperature was naturally raised to −20° C. Filtration was performed. The filter residue was washed with a small amount of dichloromethane, the filtrate and the washing liquid were combined, 10 ml of ice water was added at an external temperature of 0 to 5° C., and rapid stirring was performed for 4 h.

Suction filtration was performed, and washing with stirring was performed with a small amount of ice water and then with acetone respectively. The filter cake was collected, and vacuum-dried at room temperature to obtain 3.01 g of Cl-IPM as a white solid with a yield of 45.4%.

The Test Results were as Follows:

Melting point measurement: the melting point was 108 to 110° C.

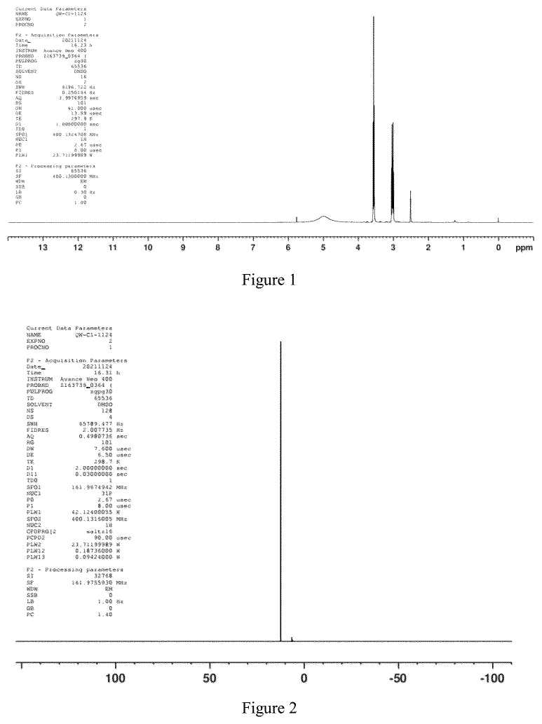

¹H-NMR (DMSO-d6, δ/ppm) data: 2.85-3.08 (4H, m, —CH₂), 3.52-3.61 (4H, m, —CH₂), as shown in FIG. 1.

³¹P-NMR (DMSO-d6, δ/ppm) data: 12.305 (—P═O), as shown in FIG. 2.

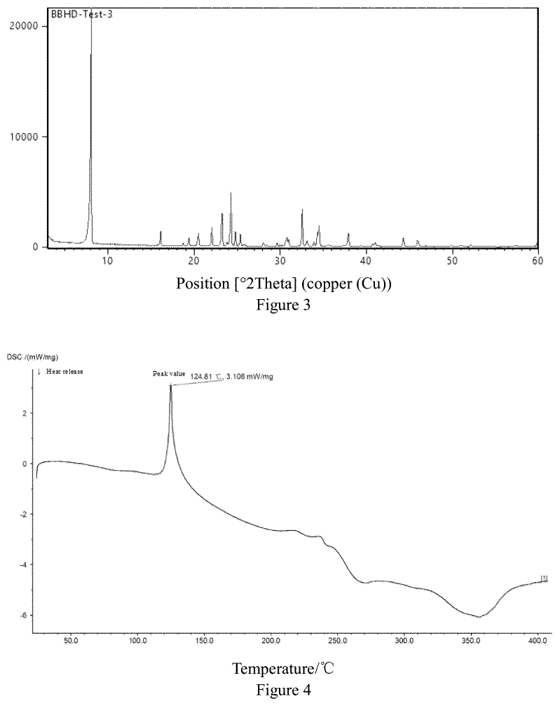

An X-ray powder diffraction test with Cu-Kα radiation was performed. The primary spectrum represented by 2θ is shown in FIG. 3. According to the test conditions of the instrument, peaks with a peak height greater than 8 cts were selected, and the data are listed in Table 3 below:

TABLE 3
Crystal data of the Cl-IPM prepared in Example 1

| | Peak | Relative |
|---|---|---|
| Position | height | intensity |
| (2θ) | (cts) | (%) |
| 8.0209 | 22560.43 | 100 |
| 16.1087 | 1373.14 | 6.09 |
| 18.7114 | 296.14 | 1.31 |
| 19.3901 | 745.01 | 3.3 |
| 20.5104 | 1185.97 | 5.26 |
| 21.4299 | 51.5 | 0.23 |
| 22.0369 | 1751.51 | 7.76 |
| 23.2285 | 3008.18 | 13.33 |
| 23.8235 | 337.38 | 1.5 |
| 24.2629 | 4742.66 | 21.02 |
| 24.7915 | 1310.07 | 5.81 |
| 25.3655 | 1077.28 | 4.78 |
| 25.8086 | 208.68 | 0.92 |
| 28.0429 | 363.84 | 1.61 |
| 28.4479 | 119.1 | 0.53 |
| 29.6298 | 291.83 | 1.29 |
| 29.949 | 86.4 | 0.38 |
| 30.2621 | 85.42 | 0.38 |
| 30.7579 | 792.6 | 3.51 |
| 30.9802 | 623.98 | 2.77 |
| 32.5394 | 3283.25 | 14.55 |
| 33.107 | 478.67 | 2.12 |
| 33.928 | 455.11 | 2.02 |
| 34.3143 | 1207.96 | 5.35 |
| 34.503 | 1875.94 | 8.32 |
| 35.6098 | 186.33 | 0.83 |
| 37.2134 | 50.97 | 0.23 |
| 37.914 | 1274.95 | 5.65 |
| 39.3701 | 73.9 | 0.33 |
| 40.2372 | 31.96 | 0.14 |
| 40.713 | 240.12 | 1.06 |
| 41.0129 | 352.57 | 1.56 |
| 42.1423 | 14.33 | 0.06 |
| 42.9436 | 28.85 | 0.13 |
| 43.6994 | 38.41 | 0.17 |
| 44.2974 | 711.95 | 3.16 |
| 45.9149 | 511.81 | 2.27 |
| 46.9205 | 64.95 | 0.29 |
| 48.347 | 8.68 | 0.04 |
| 48.786 | 17.05 | 0.08 |
| 49.8437 | 165.77 | 0.73 |
| 50.8707 | 123.92 | 0.55 |
| 51.1323 | 103.51 | 0.46 |
| 52.1419 | 140.36 | 0.62 |
| 53.4125 | 13.99 | 0.06 |
| 53.9493 | 35.19 | 0.16 |
| 56.2199 | 20.18 | 0.09 |
| 57.3457 | 83.6 | 0.37 |
| 58.0845 | 26.77 | 0.12 |

A differential scanning calorimetry (DSC) test was performed. The heating program was set as follows: the temperature was initially 25° C. and increased to 410° C. with a gradient of 10° C./min. The endothermic peak of DSC was at 124.81° C., and the endothermic value was 3.108 mW/mg, as shown in FIG. 4.

In the following comparative example, Cl-IPM was prepared by the method in the patent application CN102746336A, and the yield and the spectral characteristics of the product prepared by the prior art method were measured.

### Comparative Example 1: Existing Crystal Forms (or Possibly Amorphous Forms) of the Cl-IPM Prepared by the Prior Art Process

To a solution of 2-chloroethyl hydrochloride (11.0 g) in DCM (90 mL) at 10° C. was added a solution of POCl₃ (2.3 mL) in DCM (4 mL) followed by addition of a solution of TEA (14.1 mL) in DCM (25 mL). The reaction mixture was filtered, and the filtrate was concentrated to ca. 30% of the original volume and filtered. The residue was washed with DCM (3×25 mL) and the combined DCM portions were concentrated to yield a solid to which a mixture of THF (6 mL) and water (8 mL) was added. THF was removed in a rotary evaporator, and the resulting solution chilled overnight in a fridge. The precipitate obtained was filtered, washed with water (10 mL) and ether (30 mL), and dried in vacuo to yield 1.70 g of Cl-IPM (it is calculated that the yield is 31.1%).

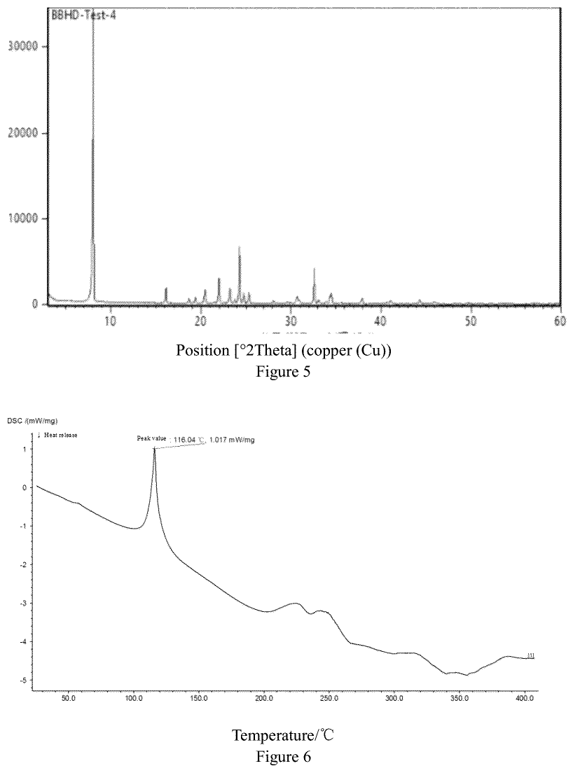

Melting point measurement was carried out using the same method as the one for the Cl-IPM obtained in the above Example 1, and the melting point was 104 to 105° C.; an X-ray powder diffraction test was carried out, and the pattern is shown in FIG. 5. According to the test conditions of the instrument, peaks with a peak height greater than 8 cts were selected, and the data are listed in Table 4 below:

TABLE 4
Crystal data of the Cl-IPM prepared in
Comparative Example 1

| | Peak | Relative |
|---|---|---|
| Position | height | intensity |
| (2θ) | (cts) | (%) |
| 8.0344 | 34868.45 | 100 |
| 16.125 | 1845.15 | 5.29 |
| 18.6743 | 522.78 | 1.5 |
| 19.3757 | 685.77 | 1.97 |
| 20.4864 | 1605.75 | 4.61 |
| 21.4225 | 103.45 | 0.3 |
| 21.9972 | 2934.48 | 8.42 |
| 23.2294 | 1645.92 | 4.72 |
| 23.7962 | 390.7 | 1.12 |
| 24.2994 | 5792.96 | 16.61 |
| 24.7644 | 1124.79 | 3.23 |
| 25.3397 | 1256.03 | 3.6 |
| 25.8062 | 111.11 | 0.32 |
| 28.0351 | 316.75 | 0.91 |
| 28.4316 | 89.68 | 0.26 |
| 29.6204 | 252.05 | 0.72 |
| 29.9222 | 123.91 | 0.36 |
| 30.7259 | 780.78 | 2.24 |
| 30.9534 | 388.77 | 1.11 |
| 32.0465 | 8.6 | 0.02 |
| 32.5746 | 4028.5 | 11.55 |
| 33.0991 | 365.86 | 1.05 |
| 33.9317 | 295.24 | 0.85 |
| 34.3025 | 817.38 | 2.34 |
| 34.4812 | 1196.54 | 3.43 |
| 35.5951 | 160.13 | 0.46 |
| 37.1792 | 8.95 | 0.03 |
| 37.9218 | 715.12 | 2.05 |
| 39.3761 | 49.21 | 0.14 |
| 40.1845 | 27.38 | 0.08 |
| 40.6795 | 191.27 | 0.55 |
| 41.0464 | 395.49 | 1.13 |
| 42.8488 | 21.19 | 0.06 |
| 43.74 | 61.46 | 0.18 |
| 44.2868 | 489.97 | 1.41 |
| 45.8951 | 235.7 | 0.68 |
| 46.0401 | 212.46 | 0.61 |
| 46.9171 | 31.58 | 0.09 |
| 48.2566 | 29.65 | 0.09 |
| 48.7805 | 19.73 | 0.06 |
| 49.7712 | 132.17 | 0.38 |
| 50.826 | 67.45 | 0.19 |
| 51.1168 | 91.35 | 0.26 |
| 52.1137 | 108.9 | 0.31 |
| 53.2472 | 35.25 | 0.1 |
| 54.3662 | 9.87 | 0.03 |
| 56.1649 | 13.16 | 0.04 |
| 57.519 | 34.51 | 0.1 |
| 58.8462 | 17.67 | 0.05 |
| 59.8687 | 83.83 | 0.24 |

A differential scanning calorimetry (DSC) test was performed (the heating program: the temperature was initially 25° C. and increased to 410° C. with a gradient of 10° C./min). The endothermic peak of DSC was at 116.04° C., and the endothermic value was 1.017 mW/mg, as shown in FIG. 6.

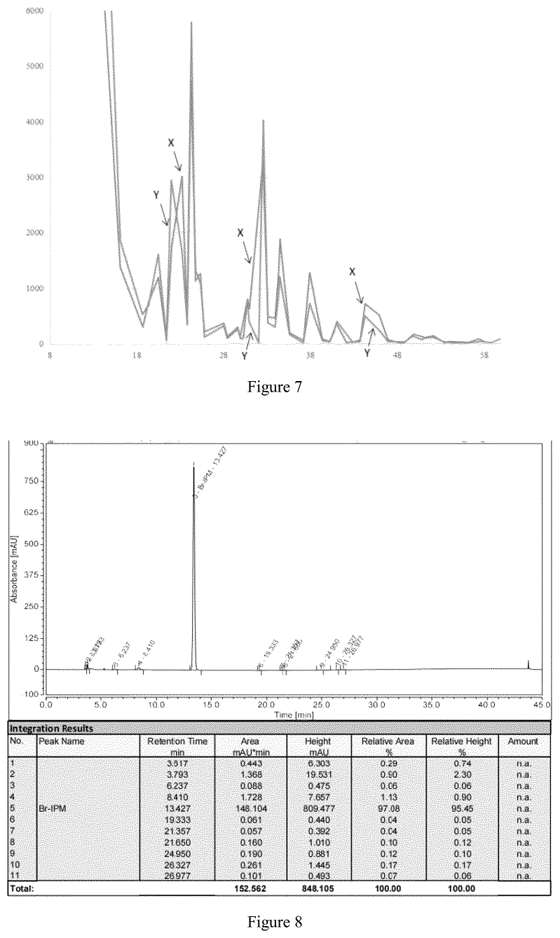

After plotting the data in Table 3 and Table 4 of the Cl-IPMs prepared in Example 1 and Comparative Example 1, they were superimposed and compared to show different characteristic peaks so as to obtain the superimposed patterns (by spreadsheet processing) as shown in FIG. 7, wherein the abscissa indicates 2θ, the ordinate indicates peak heights (cts), the maximum peak height selected on the ordinate is 6,000 cts, X represents the pattern of the Cl-IPM prepared in Example 1, and Y represents the pattern of the Cl-IPM prepared in Comparative Example 1.

From the superimposed XRPD patterns of the Cl-IPM, it can be seen that the pattern of the crystal form of Cl-IPM prepared by the new process of the present application can basically overlap with that of the existing crystal form (or possibly amorphous form) as prepared by the prior art process, but the characteristic peaks of the new crystal form at corresponding positions are obviously different, as shown in Table 5 below:

TABLE 5
Comparison of the characteristic peaks of the Cl-IPM

| | Exsiting crystal form or |
|---|---|
| New crystal form | amorphous form |
| of Cl-IPM | of Cl-IPM |
| (characteristic peaks, | (characteristic peaks, |
| represented by 2θ) | represented by 2θ) |
| 23.22° | 24.30° |
| 30.75° | 32.57° |
| 44.29° | 44.29° |

Further, the relatively obvious characteristic peaks were observed also at 8.02°, 16.01°, 19.39°, 20.51°, 22.03°, 24.26°, 24.79°, 25.36°, 32.53°, 34.31°, 34.50° and 37.91°, with an error range not greater than 0.01° for each characteristic peak.

The DSC data were further compared. FIG. 4 is the DSC pattern of the crystal form of Cl-IPM prepared by the new process of the present application, and FIG. 6 is the DSC pattern of the existing crystal form (or possibly amorphous form) prepared by the prior art process. Evidently, they were siginificantly different in term of both the endothermic peaks and endothermic values.

The melting points were measured. The melting point of the crystal form of Cl-IPM prepared by the new process of the present application was 108-110° C., and the melting point of the existing crystal form (or possibly amorphous form) prepared by the prior art process was 104-105° C.

By comparing the XRPD patterns, DSC data, and melting points, it can be seen that the crystal form of Br-IPM prepared by the new process of the present application is completely different from the existing crystal form (or possibly amorphous form) prepared by the prior art process, and is anew crystal form.

### Example 2: Preparation of Br-IPM

A typical operation of using the new method developed by the present invention for preparing Br-IPM is as follows.

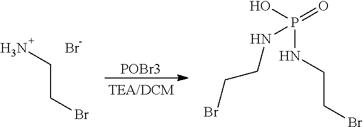

Experiment No. S1:

35 ml of dichloromethane and 5.43 g of 2-bromoethylamine hydrobromide was added into a 100 ml three-necked flask (under nitrogen atmosphere) at room temperature. Stirring was started and the temperature was set to drop to −60° C. When the temperature dropped to about −20° C., 3.80 g of phosphorus oxybromide was added, and the temperature continued to drop to −60° C.

A solution of triethylamine in dichloromethane was added in three batches successively.

For the first addition, a mixed solution consisting of 2.86 g triethylamine and 3.9 ml dichloromethane was added dropwise at a temperature ranging from −60° C. to −55° C., and the rate of the dropwise addition was mainly controlled by the temperature to be relatively moderate;
for the second addition, a mixed solution consisting of 1.43 g triethylamine and 3.9 ml dichloromethane was added dropwise at a temperature ranging from −55° C. to −50° C., and the rate of addition was controlled to be relatively slow; and
for the third addition, a mixed solution consisting of 1.14 g triethylamine and 3.9 ml dichloromethane was added dropwise at a temperature ranging from −45° C. to −40° C., and the rate of addition was controlled to be slow.

After the addition of the solution of triethylamine in dichloromethane, the temperature was slowly raised to −20° C. naturally, 12 ml of water was slowly added dropwise, the temperature was slowly raised to −5° C., and while this temperature was maintained, stirring was continued for 8 h.

A solid filter cake was obtained by suction filtration. The solid was washed by beating twice with a total of 40 ml of water, once with 32 ml of dichloromethane, and once with 32 ml of acetone, and was vacuum-dried at room temperature for 12 h to obtain 1.9 g of Br-IPM as a solid with a yield of 46.6%, and HPLC purity of 97.08%. The HPLC pattern is shown in FIG. 8.

The conditions for determination of HPLC purity of the Br-IPM are as follows:

Preferred chromatographic conditions for determination of purity of the Br-IPM

Chromatographic column: Thermo Acclaim ™ 120A C18 250*4.6 mm, 5 μm
Flow rate: 0.7 ml/min
Detection wavelength: 210 nm
Column temperature: 5° C.
Mobile phase A: 0.1% phosphoric acid solution Mobile phase B: acetonitrile
Elution procedure:

| Time | A % | B % |
|---|---|---|
| 0 | 90 | 10 |
| 5 | 90 | 10 |
| 35 | 20 | 80 |
| 40 | 20 | 80 |
| 40.1 | 90 | 10 |
| 45 | 90 | 10 |

The results in FIG. 8 show that the Br-IPM showed a peak at 13.427 min. After many times of actual testing, it was found that due to the influence of conditions such as the temperature and instrument, it is normal when the time at which the Br-IPM showed a peak was within a range of 12 to 15 min.

The results of melting point measurements, X-ray powder diffraction and differential scanning calorimetry are as follows:
Melting point: 106-107° C.

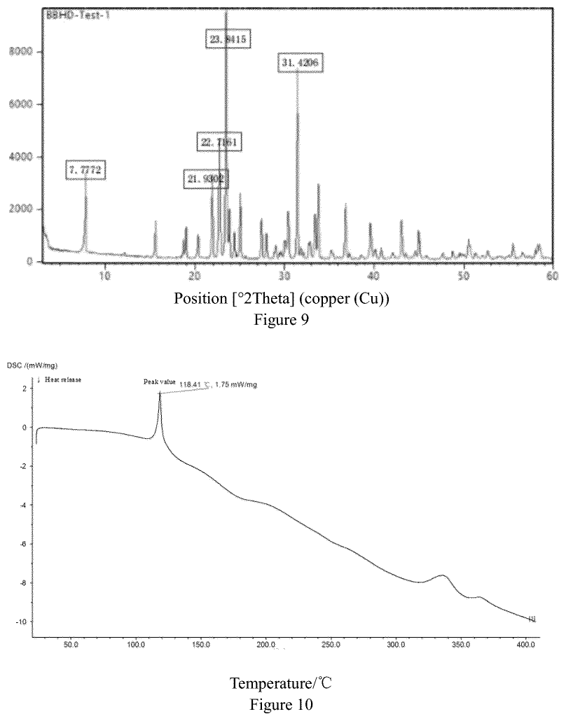

XRPD: Cu-Kα radiation. The primary spectrum represented by 2θ is shown in FIG. 9. According to the test conditions of the instrument, the peak heights greater than 25 cts were selected, and the data are listed in Table 6 below:

TABLE 6
Crystal data of the Br-IPM prepared
in Experiment S1 of Example 2

| | Peak | Relative |
|---|---|---|
| Position | height | intensity |
| (2θ) | (cts) | (%) |
| 3.5967 | 77.32 | 0.82 |
| 7.7772 | 3061.84 | 32.6 |
| 12.1484 | 130.42 | 1.39 |
| 14.7103 | 53.61 | 0.57 |
| 15.5768 | 1410.41 | 15.02 |
| 17.0987 | 52.82 | 0.56 |
| 18.705 | 655.28 | 6.98 |
| 19.0179 | 1170.98 | 12.47 |
| 20.3334 | 877.53 | 9.34 |
| 21.9302 | 3045.02 | 32.42 |
| 22.7161 | 4435.18 | 47.22 |
| 23.4525 | 9392.62 | 100 |
| 23.8415 | 1801.87 | 19.18 |
| 24.4215 | 958.9 | 10.21 |
| 25.0523 | 2499.45 | 26.61 |
| 25.6369 | 97.73 | 1.04 |
| 27.4451 | 1512.8 | 16.11 |
| 27.9992 | 947.74 | 10.09 |
| 28.8466 | 217.95 | 2.32 |
| 29.0452 | 498.29 | 5.31 |
| 29.4314 | 198.78 | 2.12 |
| 29.657 | 229.98 | 2.45 |
| 30.005 | 610.06 | 6.5 |
| 30.1327 | 602.14 | 6.41 |
| 30.4321 | 1706.9 | 18.17 |
| 31.4206 | 7033.43 | 74.88 |
| 31.8228 | 378.65 | 4.03 |
| 32.1247 | 218.82 | 2.33 |
| 32.683 | 521.39 | 5.55 |
| 32.8471 | 616.34 | 6.56 |
| 33.4052 | 1678.02 | 17.87 |
| 33.752 | 2890.69 | 30.78 |
| 35.2065 | 315.34 | 3.36 |
| 35.8699 | 53.59 | 0.57 |
| 36.7837 | 2070.73 | 22.05 |
| 37.2294 | 211.96 | 2.26 |
| 37.912 | 51.88 | 0.55 |
| 38.5127 | 137.41 | 1.46 |
| 39.5584 | 1341.7 | 14.28 |
| 39.6926 | 769.86 | 8.2 |
| 40.1734 | 348.92 | 3.71 |
| 40.7581 | 420.48 | 4.48 |
| 41.6069 | 61.41 | 0.65 |
| 42.109 | 210.96 | 2.25 |
| 42.4733 | 33.62 | 0.36 |
| 43.0389 | 1407.52 | 14.99 |
| 43.1753 | 688.13 | 7.33 |
| 43.5485 | 181.83 | 1.94 |
| 44.0799 | 29.56 | 0.31 |
| 44.5334 | 262.51 | 2.79 |
| 44.9706 | 1049.42 | 11.17 |
| 45.8386 | 119.32 | 1.27 |
| 47.6617 | 214.19 | 2.28 |
| 48.7488 | 290.19 | 3.09 |
| 49.5326 | 194.19 | 2.07 |
| 50.0486 | 87.47 | 0.93 |
| 50.5206 | 685.8 | 7.3 |
| 50.6787 | 432.29 | 4.6 |
| 51.3793 | 194.67 | 2.07 |
| 52.0373 | 117.11 | 1.25 |
| 52.6772 | 289.24 | 3.08 |
| 53.9127 | 79.13 | 0.84 |
| 55.0512 | 97.28 | 1.04 |
| 55.4652 | 549.42 | 5.85 |
| 56.5306 | 167.51 | 1.78 |
| 57.2745 | 64.11 | 0.68 |
| 57.9727 | 297.85 | 3.17 |
| 58.2487 | 502.22 | 5.35 |
| 58.4357 | 493.72 | 5.26 |
| 59.3446 | 25.92 | 0.28 |

A DSC test was performed (the heating program: the temperature was initially 25° C. and increased to 410° C. with a gradient of 10° C./min): the endothermic peak of DSC was 118.41° C., and the endothermic value was 1.75 mW/mg, as shown in FIG. 10.

The process of preparing Br-IPM using the new method developed by the present invention was repeated and scaled up based on the aforementioned typical operating conditions. The experiments were as follows:

Experiment Nos. S2-S6

A series of experiments were conducted to prepare Br-IPM with different amounts of the raw materials under the same experimental conditions as in Experiment No. S1 in Example 2, except that the amounts of the raw materials phosphorus oxybromide, 2-bromoethylamine hydrobromide and triethylamine, and the ratio of dichloromethane as a solvent and the solute dissolved therein were varied. The experimental conditions and the experimental results are shown in Table 7.

TABLE 7
Experimental results of preparing Br-IPM with different amounts of the raw materials

| | | | | | The ratio of the | The mass | The | |
|---|---|---|---|---|---|---|---|---|
| | | Phosphorus | | | amounts of the | of the | yield | |
| Experiment | 2-Bromoethylamine | oxybromide | Triethylamine | | three additions | obtained | of | HPLC |
| No. | hydrobromide (g) | (g) | (ml or g) | | of triethylamine | Br-IPM (g) | Br-IPM | purity |
| S1 | 5.43 | 3.80 | 5.43 | g | 1:0.5:0.4 | 1.9 | 46.6% | 97.08% |
| S2 | 12.81 | 8.96 | 12.82 | g | 1:0.5:0.5 | 5.0 | 51.6% | 95.97% |
| S3 | 17.47 | 13.98 | 28 | ml | 1:0.5:0.4 | 7.86 | 52.0% | 95.83% |
| S4 | 1500 | 1000 | 1900 | ml | 1:0.5:0.4 | 670.9 | 62.1% | 93.23% |
| S5 | 1530 | 970 | 1890 | ml | 1:0.5:0.4 | 642 | 61.2% | 93.96% |
| S6 | 3711 | 2360 | 4590 | ml | 1:0.5:0.4 | 1647 | 64.6% | 94.83% |

Experiment No. S4:

9.0 L of dichloromethane and 1.5 kg of 2-bromoethylamine hydrobromide were added into a 20 ml reaction kettle (under nitrogen atmosphere) at room temperature. Stirring was started and the temperature was set to drop to −60° C. When the temperature dropped to about −20° C., 1.0 kg of phosphorus oxybromide was added, and the temperature continued to drop to −60° C.

A solution of triethylamine in dichloromethane was added in three batches successively.

For the first addition, a mixed solution consisting of 1 L triethylamine and 1 L dichloromethane was added dropwise at a temperature ranging from −60° C. to −55° C., and the rate of the dropwise addition was mainly controlled by the temperature to be relatively moderate;
for the second addition, a mixed solution consisting of 0.5 L triethylamine and 1 L dichloromethane was added dropwise at a temperature ranging from −55° C. to −50° C., and the rate of addition was controlled to be relatively slow; and
for the third addition, a mixed solution consisting of 0.4 L triethylamine and 1 L dichloromethane was added dropwise at a temperature ranging from −45° C. to −40° C., and the rate of addition was controlled to be slow.

After the addition of the solution of triethylamine in dichloromethane, the temperature was slowly raised to −20° C. naturally, 3 L of water was slowly added dropwise, the temperature was slowly raised to −5° C., and while this temperature was maintained, stirring was continued for 8 h.

A solid filter cake was obtained by suction filtration. The solid was washed by beating twice with a total of 10 L of water, once with 8 L of dichloromethane, and once with 8 L of acetone, and was vacuum-dried at room temperature for 12 h to obtain 670.9 g of Br-IPM as a solid with a yield of 62.1% and HPLC purity of 93.23%.

In the aforementioned embodiments S1 to S6 (S1 is a typical operation of the new process provided by the present invention for synthesizing Br-IPM), Br-IPM was systhsized by changing the conditions such as the amounts of the raw materials such as phosphorus oxybromide, 2-bromoethylamine hydrobromide and triethylamine, with the final yield ranging from 46% to 65%, and HPLC purity ranging from 93% to 97%, which were basically stable. Therefore, it can be considered that the present synthesis process is relatively stable, achieves yields and purities which meet the requirements even if the conditions change within a certain range, and is suitable for large-scale industrial production.

In the following comparative example, Br-IPM was prepared by the method of patent application CN102746336A, and the yield and the spectral characteristics of the product prepared by the prior art method were measured.

### Comparative Example 2: Existing Crystal Forms (or Possibly Amorphous Forms) of the Br-IPM Prepared by the Prior Art Process

To a solution of 2-bromoethylammonium bromide (19.4 g) in DCM (90 mL) at 10° C. was added a solution of POCl₃ (2.3 mL) in DCM (4 mL) followed by addition of a solution of TEA (14.1 mL) in DCM (25 mL). The reaction mixture was filtered, and the filtrate was concentrated to ca. 30% of the original volume and filtered. The residue was washed with DCM (3×25 mL) and the combined DCM portions were concentrated to yield a solid to which a mixture of THF (6 mL) and water (8 mL) was added. THF was removed in a rotary evaporator, and the resulting solution chilled overnight in a fridge. The precipitate obtained was filtered, washed with water (10 mL) and ether (30 mL), and dried in vacuo to yield 2.1 g of Br-IPM (it is calculated that the yield is 27.46% and the HPLC purity is 93.1%).

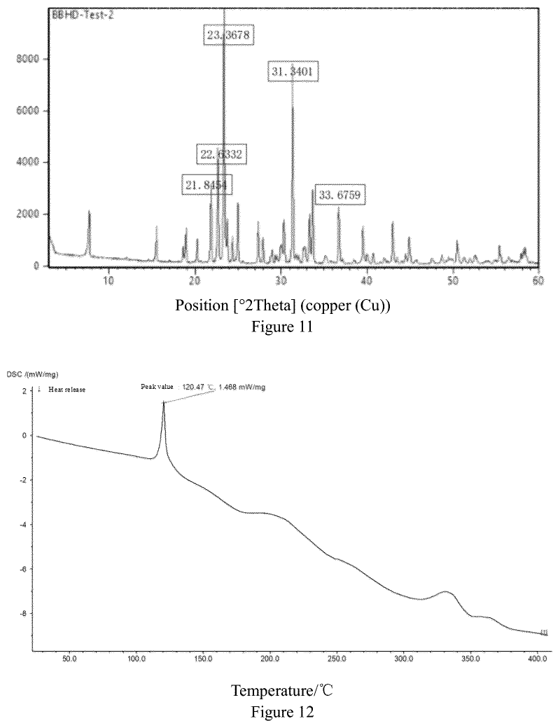

Melting point measurement was carried out using the same method as the one for the Br-IPM obtained in Experiment S1 in the above Example 2, and the melting point was 101 to 103° C.; an X-ray powder diffraction test was carried out, and the pattern is shown in FIG. 11. According to the test conditions of the instrument, peaks with a peak height greater than 40 cts were selected, and the data are listed in Table 8 below:

TABLE 8
Crystal data of the Br-IPM prepared
in Comparative Example 2

| | Peak | Relative |
|---|---|---|
| Position | height | intensity |
| (2θ) | (cts) | (%) |
| 7.6952 | 1767.42 | 17.97 |
| 12.0557 | 104.19 | 1.06 |
| 14.5928 | 50.64 | 0.51 |
| 15.4945 | 1367.59 | 13.91 |
| 17.0195 | 47.42 | 0.48 |
| 18.6168 | 619.07 | 6.3 |
| 18.93 | 1322.19 | 13.44 |
| 20.2419 | 893.29 | 9.08 |
| 20.5738 | 46.84 | 0.48 |
| 21.8454 | 2860.53 | 29.09 |
| 22.6332 | 4371.6 | 44.45 |
| 23.3678 | 9834.13 | 100 |
| 23.7601 | 1644.62 | 16.72 |
| 24.3399 | 954.02 | 9.7 |
| 24.9715 | 2293.55 | 23.32 |
| 25.5581 | 69.81 | 0.71 |
| 27.3681 | 1618.71 | 16.46 |
| 27.9174 | 988.25 | 10.05 |
| 28.7731 | 204.9 | 2.08 |
| 28.9632 | 501.9 | 5.1 |
| 29.3561 | 258.36 | 2.63 |
| 29.5761 | 240.11 | 2.44 |
| 29.9238 | 593.54 | 6.04 |
| 30.0587 | 649.51 | 6.6 |
| 30.3456 | 1643.73 | 16.71 |
| 31.3401 | 7388.14 | 75.13 |
| 31.7606 | 225.57 | 2.29 |
| 32.0329 | 201.5 | 2.05 |
| 32.6082 | 435.01 | 4.42 |
| 32.789 | 562.93 | 5.72 |
| 33.3231 | 1789.42 | 18.2 |
| 33.6759 | 2841.74 | 28.9 |
| 35.129 | 278.41 | 2.83 |
| 35.8262 | 56.21 | 0.57 |
| 36.7076 | 2152.84 | 21.89 |
| 37.1477 | 165.19 | 1.68 |
| 37.8252 | 55 | 0.56 |
| 38.4561 | 158.34 | 1.61 |
| 39.4801 | 1344.92 | 13.68 |
| 39.9548 | 328.75 | 3.34 |
| 40.0895 | 322.61 | 3.28 |
| 40.7004 | 402.63 | 4.09 |
| 41.5067 | 41.51 | 0.42 |
| 41.9471 | 165.35 | 1.68 |
| 42.3526 | 48.32 | 0.49 |
| 42.9622 | 1547.66 | 15.74 |
| 43.1034 | 741.49 | 7.54 |
| 43.4764 | 208.39 | 2.12 |
| 44.0403 | 54.58 | 0.56 |
| 44.4552 | 324.83 | 3.3 |
| 44.8974 | 997.71 | 10.15 |
| 45.7494 | 112.05 | 1.14 |
| 47.5011 | 198.08 | 2.01 |
| 48.6754 | 287.96 | 2.93 |
| 49.4705 | 174.15 | 1.77 |
| 49.9181 | 64.4 | 0.65 |
| 50.4434 | 730.37 | 7.43 |
| 50.6068 | 378.37 | 3.85 |
| 51.3033 | 206.62 | 2.1 |
| 51.9663 | 164.34 | 1.67 |
| 52.5073 | 250.68 | 2.55 |
| 52.6157 | 326.37 | 3.32 |
| 53.8646 | 83.46 | 0.85 |
| 54.8421 | 74.48 | 0.76 |
| 54.982 | 100.75 | 1.02 |
| 55.393 | 677.79 | 6.89 |
| 55.5669 | 282.62 | 2.87 |
| 56.4824 | 205.63 | 2.09 |
| 57.886 | 296.4 | 3.01 |
| 58.1684 | 483.39 | 4.92 |
| 58.3654 | 544.17 | 5.53 |

A differential scanning calorimetry (DSC) test was performed (the heating program: the temperature was initially 25° C. and increased to 410° C. with a gradient of 10° C./min). The endothermic peak of DSC was 120.47° C., and the endothermic value was 1.468 mW/mg, as shown in FIG. 12.

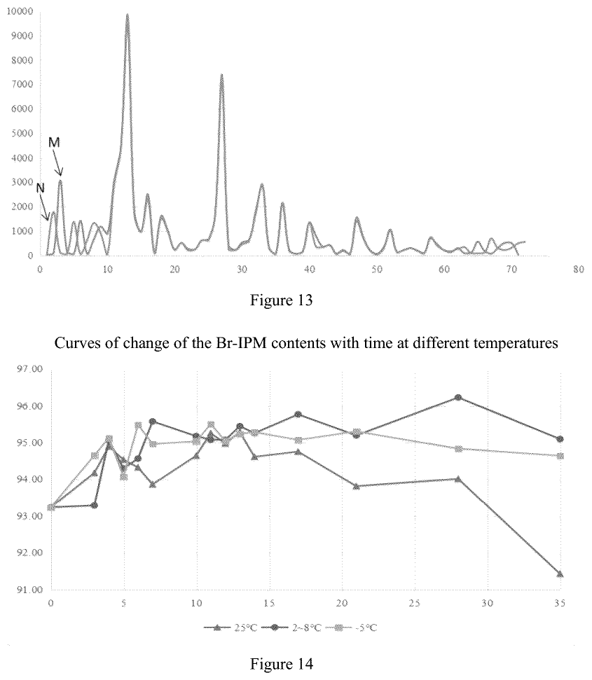

After plotting the data in Table 6 and Table 8 of the Br-IPM prepared in Experiment S1 in Example 2 and Comparative Example 1, they were superimposed and compared to show different characteristic peaks so as to obtain the superimposed patterns (by spreadsheet processing) as shown in FIG. 13, wherein the abscissa indicates 2θ, the ordinate indicates peak heights (cts), M represents the pattern of the Br-IPM prepared in Experiment S1 in Example 2, and N represents the pattern of the Br-IPM prepared in Comparative Example 2.

From the superimposed XRPD patterns of the Br-IPM, it can be seen that the pattern of the crystal form of Br-IPM prepared by the new process of the present application can basically overlap with that of the existing crystal form (or possibly amorphous form) prepared by the prior art process, but the characteristic peaks of the new crystal form at corresponding positions are obviously different, as shown in Table 9 below:

TABLE 9
Comparison of characteristic peaks of the Br-IPM

| New crystal form | Exsiting crystal form or |
|---|---|
| of Br-IPM | amorphous form of Br-IPM |
| (characteristic peaks, | (characteristic peaks, |
| represented by 2θ) | represented by 2θ) |
| 7.77° | 7.69° |
| 15.57° | 15.49° |
| 19.01° | 18.93° |

Further, the relatively obvious characteristic peaks were observed at 21.93°, 22.71°, 23.45°, 23.84°, 24.42°, 25.05°, 27.44°, 27.99°, 30.43°, 31.42°, 33.40°, 33.75°, 36.78°, 39.55°, 43.03° and 44.97°, with an error range not greater than 0.01° for each characteristic peak.

The DSC data were further compared. FIG. 10 is the DSC pattern of the crystal form of Br-IPM prepared by the new process of the present application, and FIG. 12 is the DSC pattern of the existing crystal form (or possibly amorphous form) prepared by the prior art process. Evidently, they are notably different in terms of both the endothermic peaks and endothermic values.

The melting points were measured. The melting point of the crystal form of Br-IPM prepared by the new process of the present application was 106-107° C., and the melting point of the existing crystal form (or possibly amorphous form) prepared by the prior art process was 101-103° C.

By comparing the XRPD patterns, DSC data, and melting points, it can be seen that the crystal form of Br-IPM prepared by the new process of the present application is completely different from the existing crystal form (or possibly amorphous form) prepared by the prior art process, and is anew crystal form.

### Comparison of the Examples and Comparative Examples

The above experiments can also show that compared with the batchwise addition, adding triethylamine in a single addition to the reaction system may lead to too many by-products, thereby leading to extremely low yields. The present application adopts the method of adding triethylamine in batches to prepare Br-IPM or Cl-IPM, both with yields significantly higher than those in the prior art CN102746336A.

A comparison of the post-treatments of the experimental operations can fully explain the specific reasons why the crystal form of Br-IPM prepared by the new process of the present application is completely different from the existing crystal form (or possibly amorphous form) prepared by the prior art process.

Both the crystal forms of Br-IPM and Cl-IPM in Comparative Examples 1 and 2 were obtained by concentrating dichloromethane to obtain a solid, dissolving the solid in a mixed solution of THF and water for the second time, removing the THF by rotary evaporation, then cooling the remaining solution overnight in a refrigerator and filtering the solution. In other words, the crystal forms were obtained by heating and concentrating dichloromethane, and precipitating the crystals from the THF-water solution system for the second time by rapid cooling.

The crystal form of Cl-IPM in Example 1 was formed by adding ice water to the dichloromethane system at 0-5° C., and slowly precipitating the crystals under continuous stirring. The crystal form of Br-IPM in Experiment S1 in Example 2 was 40 formed by adding water to the reaction system at −20° C., raising the temperature to −5° C., and slowly precipitating the crystals with continuous stirring. In other words, in the present application, the crystal forms were obtained by adding ice water to dichloromethane to change the solubility, and slowly precipitating the crystals under stirring.

In the following Comparative Examples 3 and 4, a similar method to that in Example 1 was employed for preparing Cl-IPM, except for the means of adding the solution of triethylamine in dichloromethane: in Example 1, it was added in three batches, whereas in Comparative Example 3, the solution of triethylamine in dichloromethane in the same amount was added in a single addition.

### Comparative Example 3: Preparation of Cl-IPM by Adding Triethylamine in a Single Addition

To a 250 ml dry three-necked flask was added 150 ml of dry dichloromethane and 7.2 g (0.0621 mol, 2.1 eq.) 2-chloroethylamine hydrochloride in sequence, the reaction mixture was coolled to −30° C., and 8.6 g (0.0300 mol, 1.0 eq.) phosphorus oxybromide was added. After the addition, the temperature continued to decrease to −70° C., then a solution of 16.8 ml (0.1200 mol, 4.0 eq.) of dry triethylamine dissolved in 60 ml of dry dichloromethane was added dropwise to the reaction mixture in a single addition (the solution of triethylamine in dichloromethane was added in a single addition in the same temperature control zone), and the rate of the dropwise addition was controlled so that the temperature of the reaction solution was between −70° C. and −50° C.

After completion of the dropwise addition, the temperature was naturally raised to −20° C. Filtration was performed. The filter residue was washed with a small amount of dichloromethane, the filtrate and the washing liquid were combined, 10 ml of ice water was added at an external temperature of 0 to 5° C., and rapid stirring was performed for 4 h.

Suction filtration was performed, and washing with stirring was performed with a small amount of ice water and then acetone respectively. The filter cake was collected, and vacuum-dried at room temperature to obtain 2.30 g of Cl-IPM as a white solid with a yield of 34.7%.

With other experimental conditions being equal, adding the solution of triethylamine in dichloromethane in a single addition leads to a significantly lower yield than adding the solution in three batches.

In the following Comparative Example 4, a similar method to that in Experiment S1 in Example 2 was employed for preparing Br-IPM, except for the means of adding the solution of triethylamine in dichloromethane: in Experiment S1 in Example 2, it was added in three batches, whereas in Comparative Example 4, the solution of triethylamine in dichloromethane in the same amount was added in a single addition.

### Comparative Example 4: Preparation of Br-IPM by Adding Triethylamine in a Single Addition

9.0 L of dichloromethane and 1.5 kg of 2-bromoethylamine hydrobromide were added into a 20 L reaction kettle (under nitrogen atmosphere) at room temperature. Stirring was started and the temperature was set to drop to −60° C. When the temperature dropped to about −20° C., 1.0 kg of phosphorus oxybromide was added, and the temperature continued to drop to −60° C. Then, a mixed solution containing 1.9 L of triethylamine and 3 L of dichloromethane was added dropwise to the reaction mixture in a single addition (the solution of triethylamine in dichloromethane was added in a single addition in the same temperature control zone), and the rate of the dropwise addition was controlled so that the temperature of the reaction system was between −60° C. and −40° C.

After the addition of the solution of triethylamine in dichloromethane, the temperature was slowly raised to −20° C. naturally, 3 L of water was slowly added dropwise, the temperature was slowly raised to −5° C., and while this temperature was maintained, stirring was continued for 8 h.

A solid filter cake was obtained by suction filtration. The solid was washed by beating twice with a total of 10 L of water, once with 8 L of dichloromethane, and once with 8 L of acetone, and was vacuum-dried at room temperature for 12 h to obtain 350.1 g of Br-IPM as a solid with a yield of 32.4% and HPLC purity of 93.4%.

With other experimental conditions being equal, adding the solution of triethylamine in dichloromethane in a single addition leads to a significantly lower yield than adding the solution in three batches.

### Example 3

A study on the stability of the crystal form of Br-IPM obtained in Experiment S1 in the above Example 2 was carried out as follows.

Samples of the Br-IPM crystals obtained in Experiment S1 in Example 2 were taken, and stored in environments of −5° C., 2-8° C., 25° C. and 40° C. respectively. On different days, samples were taken at the same time for analysis and detection of related substances, and their contents were recorded. The experimental results are shown in Table 10.

TABLE 10
Detection results of the Br-IPM content in the
analysis of related substances

| Time | 25° C. | 2-8° C. | −5° C. | 40° C. |
|---|---|---|---|---|
| (day) | (%) | (%) | (%) | (%) |
| 0 | 93.23 | 93.23 | 93.23 | 93.23 |
| 3 | 94.17 | 93.28 | 94.65 | 86.36 |
| 4 | 94.89 | 95.06 | 95.12 | Detection was |
| | | | | stopped |
| 5 | 94.53 | 94.29 | 94.07 | N/A |
| 6 | 94.32 | 94.56 | 95.48 | N/A |
| 7 | 93.86 | 95.57 | 94.96 | N/A |
| 10 | 94.64 | 95.17 | 95.03 | N/A |
| 11 | 95.25 | 95.07 | 95.50 | N/A |
| 12 | 94.97 | 95.07 | 95.04 | N/A |
| 13 | 95.28 | 95.44 | 95.23 | N/A |
| 14 | 94.61 | 95.25 | 95.28 | N/A |
| 17 | 94.75 | 95.76 | 95.07 | N/A |
| 21 | 93.81 | 95.19 | 95.30 | N/A |
| 28 | 94.01 | 96.22 | 94.83 | N/A |
| 35 | 91.42 | 95.09 | 94.64 | N/A |

Note:
N/A means not detected.

In the table above, when the Br-IPM crystals were stored at 40° C., their Br-IPM content decreased significantly over time, and the detection was stopped on the third day, indicating that the Br-IPM crystals were unstable when placed at 40° C.

The detetion data on the Br-IPM contents of the samples stored at 25° C., −5° C. and 2-8° C. were plotted to obtain curves of change of the Br-IPM contents with time at different temperatures, as shown in FIG. 14. As can be seen from the figure, when Br-IPM crystals were stored at 25° C., they were relatively stable for the first 28 days, and subsequently, their Br-IPM content decreased significantly. When Br-IPM crystals were stored at low temperatures of 2-8° C. and −5° C., the Br-IPM content remained relatively stable until the 35th day, indicating that the Br-IPM crystals were suitable for storage at low temperatures and were relatively stable.

Therefore, the Br-IPM crystals prepared by the new process of the present application are relatively stable, can be stored at room temperature for 28 days, can be stored at 2 to 8° C. and −5° C. for at least 35 days, are suitable as intermediates, and can be stored in factories without the need of directly producing Cl-IPM or Br-IPM in a reaction vessel before its direct participation in the reaction for the preparation of the next intermediate/finished product, as required in the prior art CN102746336A, WO2020228685A9, WO2021068952A1 and the like.

Because the reagents such as phosphorus oxychloride and phosphorus oxybromide used in the reaction to generate Cl-IPM and Br-IPM are highly toxic and easily react with water, there are relatively high requirements for the sealing properties of the reaction vessel, water removal during operation, and control of moisture content. In large-scale factory production, differences in water content of different batches of phosphorus oxychloride and phosphorus oxybromide, and differences in water removal operations will make the product quality unstable and make it hard to control the quality of the final product. Using the new crystal forms prepared by the present invention, it is possible to prepare a sufficient amount at once to enable the production of compounds with multiple structures (drugs with structures A, B, C, D and E) as desired, which contributes to the quality control of the product.

### Example 4

The following illustrates the typical exemplary reactions for further synthesizing and preparing Compounds A, B, C, D, and E using the Cl-IPM or Br-IPM prepared by the present invention.

### Preparation of Compounds 1 and 2

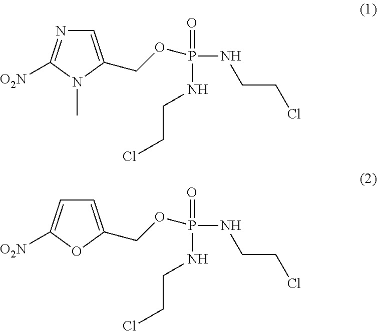 [SMILES: Cn1c(COP(=O)(NCCCl)NCCCl)cnc1[N+](=O)[O-] ; O=[N+]([O-])c1ccc(COP(=O)(NCCCl)NCCCl)o1]

When L is —CH₂—, Z₃ is

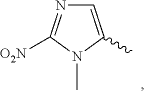

### and Z₃-L-OH is

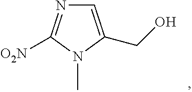

Compound A has the typical structure of Compound 1, which is synthesized by the following method:

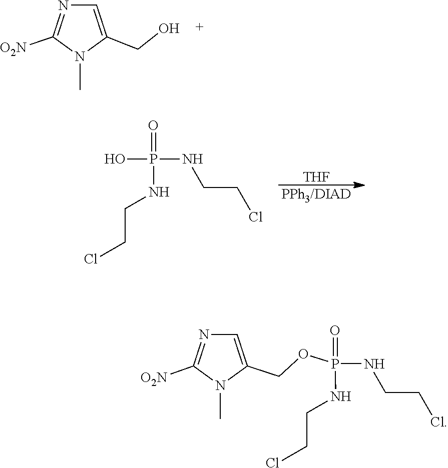

To a solution of N-methyl-2-nitroimidazole-5-methanol (180 mg, 1.14 mmol), triphenylphosphine (300 mg, 1.14 mmol), and Cl-IPM (127 mg, 0.57 mmol) in THF (10 ml), diisopropyl azodicarboxylate (DIAD, 0.22 ml, 1.14 mmol) was added dropwise at room temperature. After two hours reaction mixture was concentrated and the residue was separated by flash chromatography with 30-100% acetone in toluene to obtain Compound 1.

Using a similar synthesis method, when Z₃-L-OH is selected from

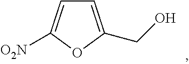

Compound 2 can be prepared.

### Preparation of Compound 3

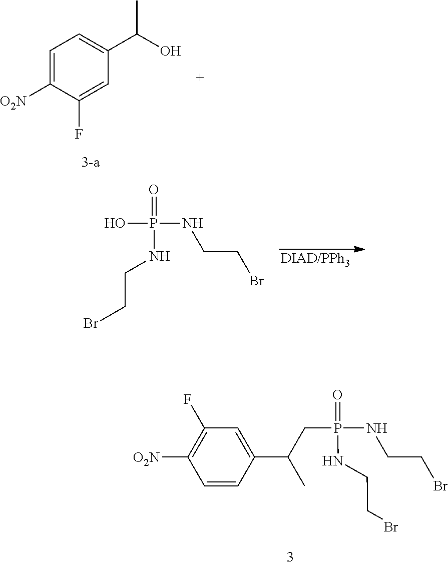

To a mixture of Compound 3-a (1.44 g, 7.78 mmol), Br-IPM (2.88 g, 9.34 mmol) and PPh₃ (3.06 g, 11.67 mmol) in THF (60 mL) at 0° C. was added DIAD (2.34 g, 11.67 mmol). The mixture was stirred at 0° C. for 1.5 h, concentrated under reduced pressure and purified via FCC (silica gel, EtOAc/Hexane) to afford Compound 3 as a light yellow oil (1.0 g, 27% yield).

### Preparation of Compound 4

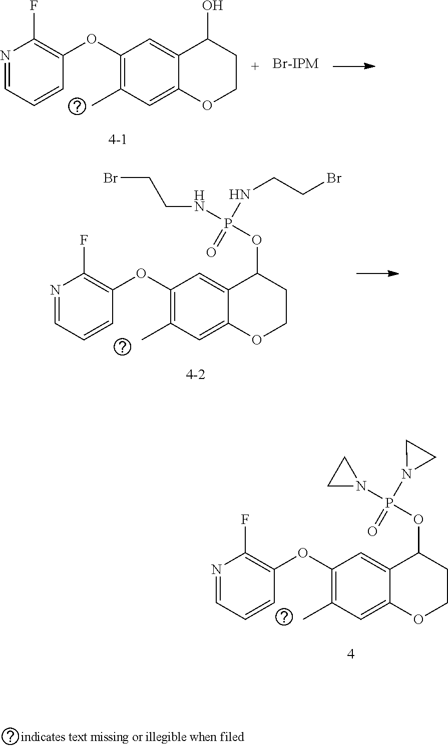 [SMILES: Cc1cc2c(cc1Oc1cccnc1F)C(O)CCO2 ; Cc1cc2c(cc1Oc1cccnc1F)C(OP(=O)(NCCBr)NCCBr)CCO2 ; Cc1cc2c(cc1Oc1cccnc1F)C(OP(=O)(N1CC1)N1CC1)CCO2]

To a mixture of Compound 4-1, Br-IPM and PPh₃ in THF at 0° C. was added DIAD. The mixture was reacted with stirring at 0° C. for 2 h. The reaction mixture was concentrated and purified by chromatography to obtain Compound 4-2.

Compound 4-2 was dissolved in THF, silver oxide was added, and the mixture was reacted with stirring at 70° C. for 12 h. The reaction solution was filtered, the filtrate was concentrated under reduced pressure, and the crude filter cake product was purified by column chromatography (SiO₂, PE: EtOAc=5:1-1:4) to obtain Compound 4.

### Preparation of Compound 5

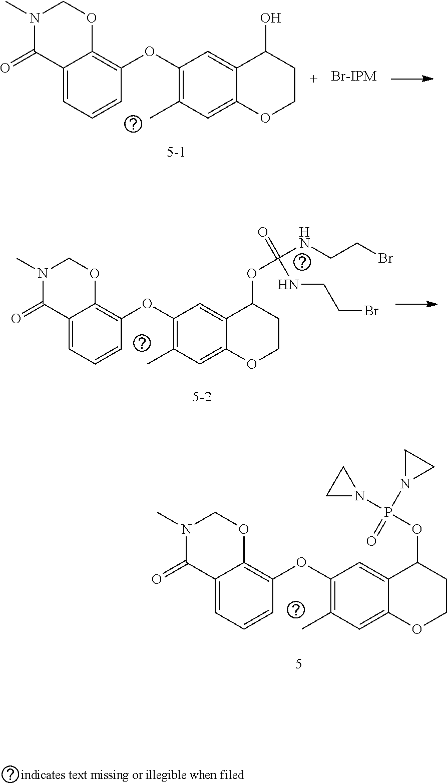

To a mixture of Compound 5-1, Br-IPM and PPh₃ in THF at −5° C. was added DIAD. The mixture was reacted with stirring at −5 to 0° C. for 2.5 h. The reaction mixture was concentrated and purified by chromatography to obtain Compound 5-2.

Compound 5-2 was dissolved in THF, silver oxide was added, and the mixture was reacted with stirring at 60° C. for 14 h. The reaction solution was filtered, the filtrate was concentrated under reduced pressure, and the crude filter cake product was purified by high-performance liquid chromatography to obtain Compound 5.

The purification conditions were as follows:
Separation column: Waters Xbridge (size: C18 150*50 mm, particle size: 10 μm);
Mobile phase: water (10 mM ammonium bicarbonate)-acetonitrile;
Elution gradient: 17%-47%, 10 minutes.

### Preparation of Compound 6

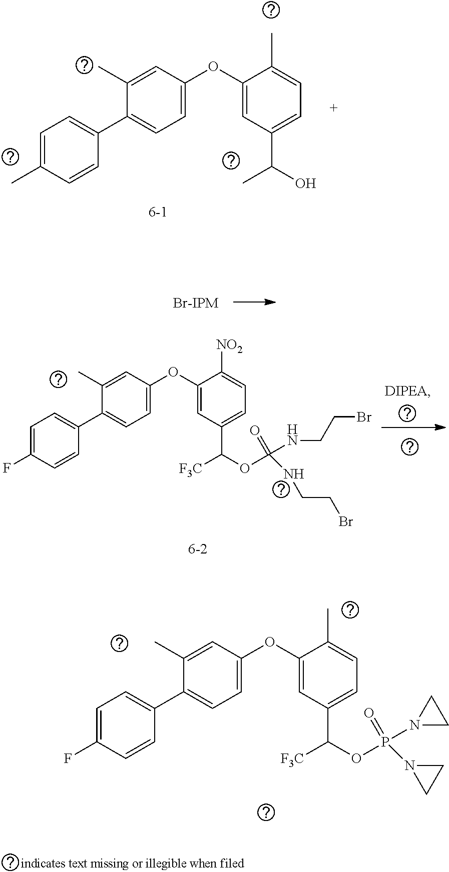

To a mixture of Compound 6-1, Br-IPM and PPh₃ in THF at −10° C. was added DIAD. The mixture was reacted with stirring at −10 to 0° C. for 2.5 h. After the reaction was complete, the temperature was naturally raised to 0° C., and a saturated aqueous solution of ammonium chloride was added dropwise. Extraction was performed with dichloromethane followed by drying, concentration, and column separation (200-300 mesh silica gel, n-heptane: EA=1:1-100) to obtain Compound 6-2.

Under the protection of nitrogen, Compound 6-2 was dissolved in THF. Then, silver oxide and DIPEA were added. The temperature was increased to 65° C. Reaction was performed for 3 h with stirring. After the reaction was complete, the temperature was reduced to room temperature. Suction filtration through celite was performed followed by washing with dichloromethane. The mother liquor was concentrated. Crystallization was performed by adding a small amount of anhydrous ether, and suction filtration was performed to obtain Compound 6.

The above examples are just exemplary embodiments of the reactions. In practice, DIAD+PPh₃ in the first step of dehydration condensation of X-IPM is a set of universal and mild reagents for dehydration condensation, and other combinations such as DEAD+PPh₃, DCC+PPh₃ and EDC+PPh₃ can also be used depending on the reactants.

In the second step of cyclization reaction, silver oxide was used as a catalyst for cyclization in the examples, but in practice, silver nitrate can also be used as the catalyst. DIPEA was used as an acid-binding agent. An acid-binding agent is generally an alkaline substance, and carbonates such as K₂CO₃, organic amines such as triethylamine and diethylamine can all serve as acid-binding agents, or a large amount of pyridine can be directly used (both as a reaction solvent and as an acid-binding agent).

The above examples describe the basic principles or main features or advantages of the present invention. Those skilled in the art should understand that the present invention is not limited to the above-mentioned examples, which merely describe the principles or main features or advantages of the present invention together with the specification. Various changes and modifications may be made to the present invention without departing from the spirit and scope of the present invention, and all such changes and modifications fall within the scope of the claims.

1. A process for producing X-IPM of formula III, comprising the following steps: 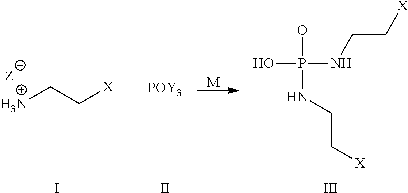
(1) mixing dichloromethane with 2-haloethylamine hydrohalide I, starting stirring and setting the temperature down to −70° C. to −60° C., and when the temperature is reduced to −30° C. to −20° C., adding phosphorus oxyhalide II;
(2) adding dropwise a solution of compound M in dichloromethane in batches at a temperature range of −70° C. to −40° C.:
\textcircled{1} for the first dropwise addition, the solution of compound M in dichloromethane comprises compound M in an amount 1.8 to 2.2 times the molar equivalent of phosphorus oxyhalide II, and the rate of the dropwise addition should ensures that the temperature change of the reaction system is within 10° C.;
\textcircled{2} for the second dropwise addition, the solution of compound M in dichloromethane comprises compound M in an amount 0.9 to 1.1 times the molar equivalent of phosphorus oxyhalide II, and the rate of the dropwise addition should ensures that the temperature change of the reaction system is within 10° C.; and
\textcircled{3} for the nth dropwise addition, the aforementioned dropwise addition step is repeated, the temperature of the system is increased by 5° C. to 15° C. with each addition, and the molar equivalent of compound M is decreased with each addition since the second dropwise addition;
(3) after the completion of the reaction, carrying out post-treatment to obtain a product;
wherein the n is an integer, and n≥2;
X in the 2-haloethylamine hydrohalide I and X-IPM are identical, and both are Br or Cl;
Z in the 2-haloethylamine hydrohalide I is Br or Cl;
Y in the phosphorus oxyhalide II is Br or Cl; and
the M is pyridine or R₃N, wherein the three R groups are each independently methyl, ethyl, propyl or isopropyl.

2. The process according to claim 1, wherein R is ethyl (i.e., M is triethylamine), comprising the following steps:
mixing dichloromethane with 2-haloethylamine hydrohalide I, starting stirring and setting the temperature down to −70° C. to −60° C., and when the temperature is reduced to −30° C. to −20° C., adding phosphorus oxyhalide II;
adding triethylamine for the first time: when the temperature is lowered to a range of −70° C. to −60° C., adding dropwise a solution of triethylamine in dichloromethane, which comprises triethylamine in an amount 1.8 to 2.2 times the molar equivalent of phosphorus oxyhalide II, and the rate of the dropwise addition should ensures that the temperature of the reaction system is below −60° C.;
adding triethylamine for the second time: when the temperature is raised to a range of −60° C. to −50° C., adding dropwise a solution of triethylamine in dichloromethane, which comprises triethylamine in an amount 0.9 to 1.1 times the molar equivalent of phosphorus oxyhalide II, and the rate of the dropwise addition should ensures that the temperature of the reaction system is below −50° C.;
adding triethylamine for the third time: when the temperature is raised to a range of −50° C. to −40° C., adding dropwise a solution of triethylamine in dichloromethane, which comprises triethylamine in an amount 0.9 to 1.1 times the molar equivalent of phosphorus oxyhalide II, and the rate of the dropwise addition should ensures that the temperature of the reaction system is below −40° C.;
after adding dropwise the solution of triethylamine in dichloromethane, raising the temperature to −20° C. to −10° C. for reaction until the reaction is completed, and carrying out post-treatment to obtain a product;
wherein X in the 2-haloethylamine hydrohalide I and X-IPM are identical, and both are Br or Cl;
Z in the 2-haloethylamine hydrohalide I is Br or Cl; and
Y in the phosphorus oxyhalide II is Br or Cl.

3. The process according to claim 2, wherein
when X in 2-haloethylamine hydrohalide I and X-IPM, Y in phosphorus oxyhalide II, and Z in 2-haloethylamine hydrohalide I are all Br, the post-treatment process for obtaining a product is as follows:
starting to add water dropwise at −20° C. to −10° C. at a rate which should ensure that the temperature of the reaction system is below −10° C., after the dropwise addition, raising the temperature to −5° C. to 5° C., maintaining this temperature and continuing to stir for 8-12 hours, filtering the reaction solution, beating the obtained filter cake with water, dichloromethane, and acetone in sequence, and collecting and drying the filter cake to obtain Br-IPM as a solid;
when X in 2-haloethylamine hydrohalide I and X-IPM, and Z in 2-haloethylamine hydrohalide I are all C₁, and Y in phosphorus oxyhalide II is Br, the post-treatment process for obtaining a product is as follows:
performing filtration, washing the filter residue with dichloromethane, combining the filtrate and washing liquid to obtain a combined reaction solution, heating the reaction solution to 0° C. to 5° C., then adding ice water at a rate which should ensure that the temperature of the reaction system is below 5° C., stirring for 2-6 h, filtering the reaction solution, beating the obtained filter cake with ice water and acetone in sequence, and collecting and drying the filter cake to obtain Cl-IPM as a solid.

4. The process according to claim 2, wherein
dichloromethane and 2-haloethylamine hydrohalide I are mixed in a ratio of 1 ml of dichloromethane to 0.04 to 0.18 g of 2-haloethylamine hydrohalide I;
the water contents of 2-haloethylamine hydrohalide I, dichloromethane and triethylamine used in the reaction process are controlled within 0.5% by mass.

5. The process according to claim 2, wherein
when triethylamine is added for the first time, the solution of triethylamine in dichloromethane added dropwise comprises triethylamine and dichloromethane in a volume ratio of 0.40-1.20 ml of triethylamine to 1 ml of dichloromethane;
when triethylamine is added for the second time, the solution of triethylamine in dichloromethane added dropwise comprises triethylamine and dichloromethane in a volume ratio of 0.20-0.60 ml of triethylamine to 1 ml of dichloromethane; and
when triethylamine is added for the third time, the solution of triethylamine in dichloromethane added dropwise comprises triethylamine and dichloromethane in a volume ratio of 0.20-0.60 ml of triethylamine to 1 ml of dichloromethane.

6. The process according to claim 3, wherein the temperature for drying the solid Br-IPM or Cl-IPM does not exceed 35° C.

7. A crystal form of Br-IPM, characterized in that the crystal form of Br-IPM meets one of the following conditions:
a melting point of 106 to 107° C. as determined by melting point measurements;
an endothermic peak at 117.5-119.5° C. and an endothermic value of 1.65 to 1.85 mW/mg as determined by differential scanning calorimetry; and
an X-ray powder diffraction pattern represented by the diffraction angle 2θ with characteristic peaks at 7.77°, 15.57° and 19.01°, with an error not greater than 0.01° as determined by X-ray powder diffraction using Cu-Kα radiation.

8. The crystal form of Br-IPM according to claim 7, characterized by
an endothermic peak at 118.41° C. (with an error of ±1° C.); and an endothermic value of 1.75 mW/mg as determined by differential scanning calorimetry; and
an X-ray powder diffraction pattern represented by the diffraction angle 2θ with characteristic peaks at 7.77°, 15.57°, 19.01°, 21.93°, 22.71°, 23.45°, 23.84°, 24.42°, 25.05°, 27.44°, 27.99°, 30.43°, 31.42°, 33.40°, 33.75°, 36.78°, 39.55°, 43.03° and 44.97°, with an error not greater than 0.01° as determined by X-ray powder diffraction using Cu-Kα radiation.

9. The crystal form of Br-IPM according to claim 7, characterized in that the crystal form of Br-IPM meets one of the following conditions:
it has the X-ray powder diffraction pattern as shown in FIG. 9; and
it has the differential scanning calorimetry pattern as shown in FIG. 10.

10. A crystal form of Cl-IPM, characterized in that the crystal form of Cl-IPM meets one of the following conditions:
a melting point of 108 to 110° C. as determined by melting point measurements;
an endothermic peak at 120 to 128° C., and an endothermic value of 2.5 to 3.5 mW/mg as determined by differential scanning calorimetry; and
an X-ray powder diffraction pattern represented by the diffraction angle 2θ with characteristic peaks at 23.22°, 30.75° and 44.29°, with an error not greater than 0.01° as determined by X-ray powder diffraction using Cu-Kα radiation.

11. The crystal form of Cl-IPM according to claim 10, characterized by
an endothermic peak at 124.81° C. (with an error of ±1° C.); and an endothermic value of 3.108 mW/mg as determined by differential scanning calorimetry; and
an X-ray powder diffraction pattern represented by the diffraction angle 2θ with characteristic peaks at 8.02°, 16.01°, 19.39°, 20.51°, 22.03°, 23.22°, 24.26°, 24.79°, 25.36°, 30.75°, 32.53°, 34.31°, 34.50°, 37.91° and 44.29°, with an error not greater than 0.01° as determined by X-ray powder diffraction using Cu-Kα radiation.

12. The crystal form of Cl-IPM according to claim 10, characterized in that the crystal form of Cl-IPM meets one of the following conditions:
it has the X-ray powder diffraction pattern as shown in FIG. 3; and
it has the differential scanning calorimetry pattern as shown in FIG. 4.

13. A method of synthesizing a compound selected from Compound A, Compound B, Compound C, Compound D, Compound E, Compound F, Compound G, and Compound H: 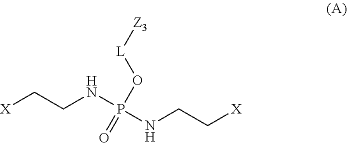
wherein L is selected from the group consisting of —CH₂—, —CD₂—, —CH(CH₃)—, —CD(CD₃)—, —CD(CH₃)—, —C(CH₃)₂—, —C(CD₃)₂—, 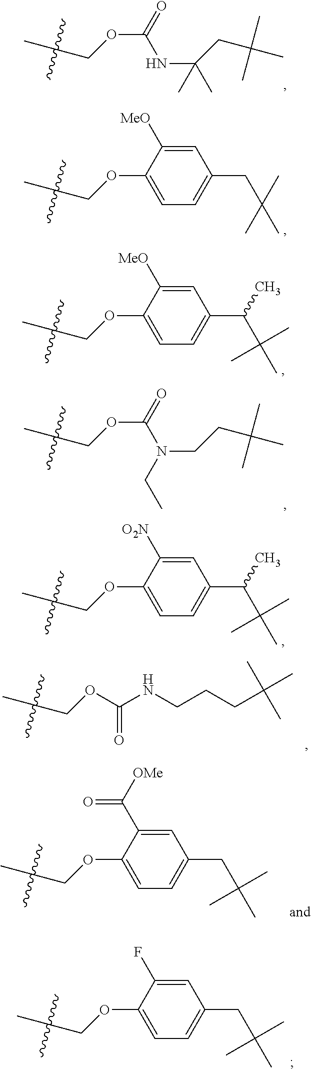
Z₃ is selected from the group consisting of 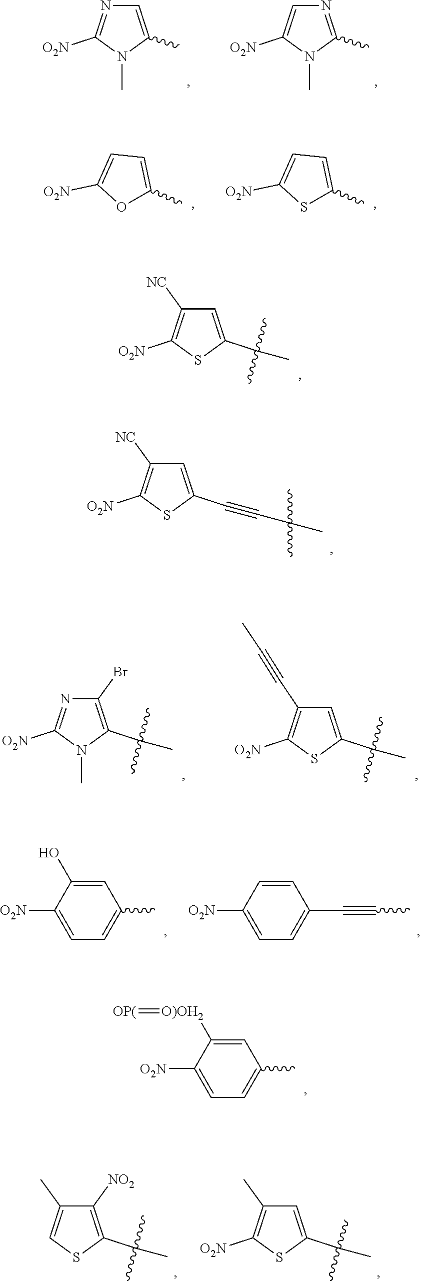 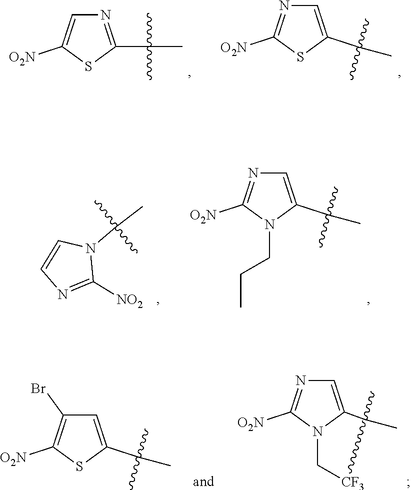
X in Compound A is Br or Cl;
D in the L is deuterium, an isotope of hydrogen; 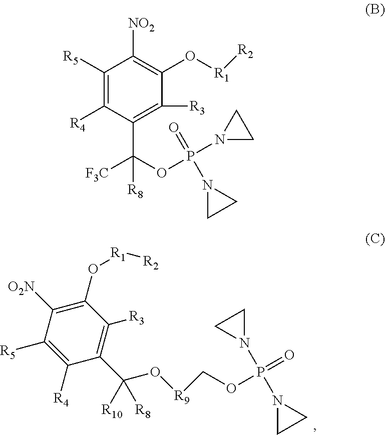
wherein the definitions of R₁, R₂, R₃, R₄, R₅, R₈, R₉ and R₁₀ are as described in the claims of Patent Application PCT/CN2020/089692 (Publication No. WO2020228685A9); 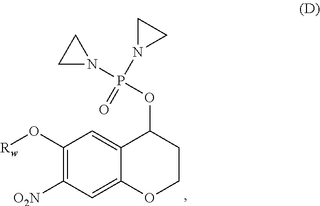
wherein the definitions of Rw are as described in the claims of Patent Application PCT/CN2020/120281 (Publication No. WO2021068952A1); 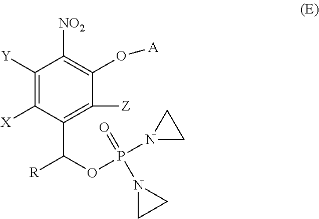
wherein
A is substituted or unsubstituted C₆-C₁₀ aryl, biaryl or substituted biaryl, or a 5-15 membered heteroaryl or —N═CR¹R², wherein the substituent is selected from the group consisting of halo, —CN, —NO₂, —O—(CH₂)—O—, —CO₂H and its salts, —OR¹⁰⁰, —CO₂R¹⁰⁰, —CONR¹⁰¹R¹⁰², —NR¹⁰¹R¹⁰², —NR¹⁰⁰SO₂R¹⁰⁰, —SO₂R¹⁰⁰, —SO₂NR¹⁰¹R¹⁰², C₁-C₆ alkyl, and C₃-C₁₀ heterocyclyl;
wherein R¹⁰⁰, R¹⁰¹ and R¹⁰² are each independently hydrogen, C₁-C₈ alkyl or C₆-C₁₂ aryl; or R¹⁰¹ and R¹⁰² together with the nitrogen atom to which they are attached form a 5-7 membered heterocyclic ring;
wherein alkyl and aryl are each substituted with 1-3 halo or 1-3 C₁-C₆;
wherein R¹ and R² are each independently phenyl or methyl;
X, Y and Z are each independently hydrogen or halo; and
R is hydrogen or C₁-C₆ alkyl or halogen-substituted alkyl;
wherein X in the X-IPM is Cl or Br; 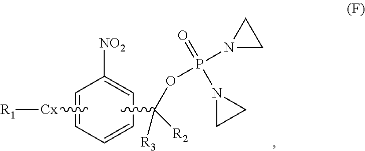
wherein the definitions of R₁, R₂, R₃, and Cx are as described in the claims of Patent Application PCT/CN2020/114519 (Publication No. WO2021120717A1), which corresponds to Chinese Application No. 2020800673113 (Publication No. CN114466853A); 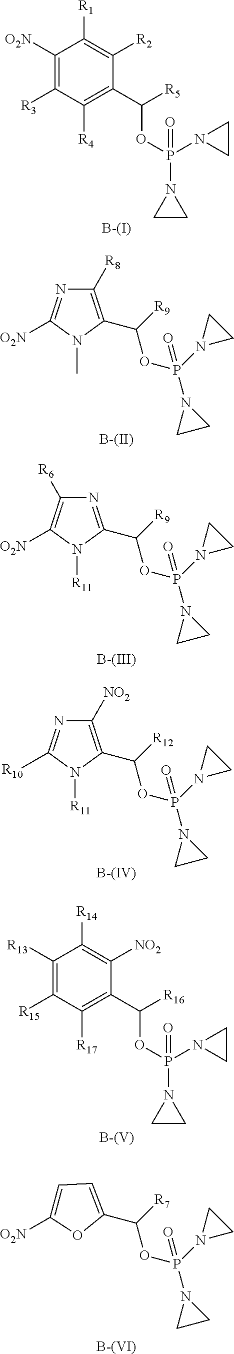
wherein the definitions of R₁, R₂, R₃, R₄, R₅, R₆, R₇, R₈, R₉, R₁₀, R₁₁, R₁₂, R₁₃, R₁₄, R₁₅, R₁₆ and R₁₇ are as described in the claims of Patent Application PCT/US2016/039092 (Publication No. WO2016210175A1), which corresponds to Chinese Application No. 2016800368985 (Publication No. CN108024974A) 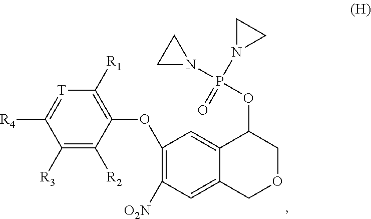
wherein the definitions of R₁, R₂, R₃, R₄ and T are as described in the claims of Patent Application PCT/CN2021/118597 (Publication No. WO2022057838A1),
wherein the method uses the X-IPM obtained by the process according to claim 1 as a reactant.

14. The method according to claim 13, wherein
Compound A1 is reacted with Compound III to obtain Compound A: 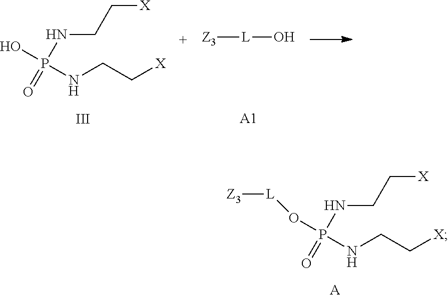
Compound B1 is reacted with Compound III to obtain Intermediate B2, which is subjected to a ring-closure reaction to obtain Compound B: 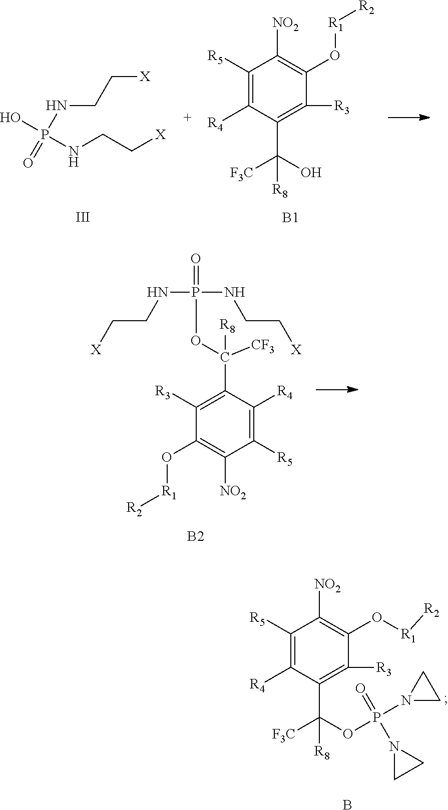
Compound C1 is reacted with Compound III to obtain Compound III, which is subjected to a ring-closure reaction to obtain Compound C: 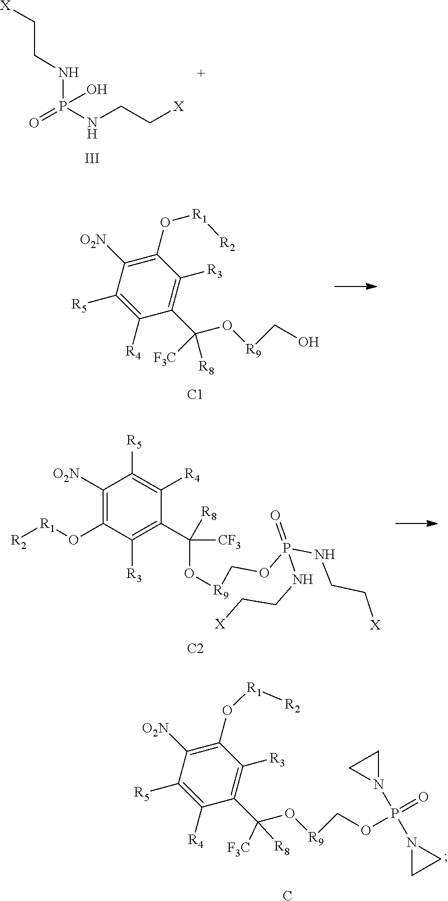
Compound D1 is reacted with Compound III to obtain Intermediate D2, which is subjected to a ring-closure reaction to obtain Compound D: 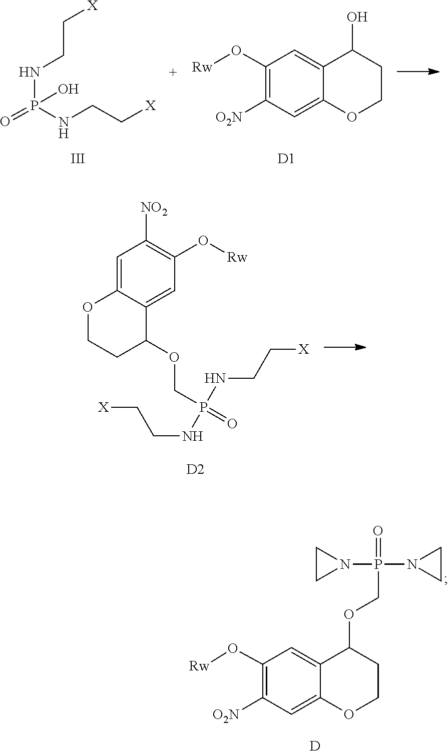
Compound E1 is reacted with Compound III to obtain Intermediate E2, which is subjected to a ring-closure reaction to obtain Compound E: 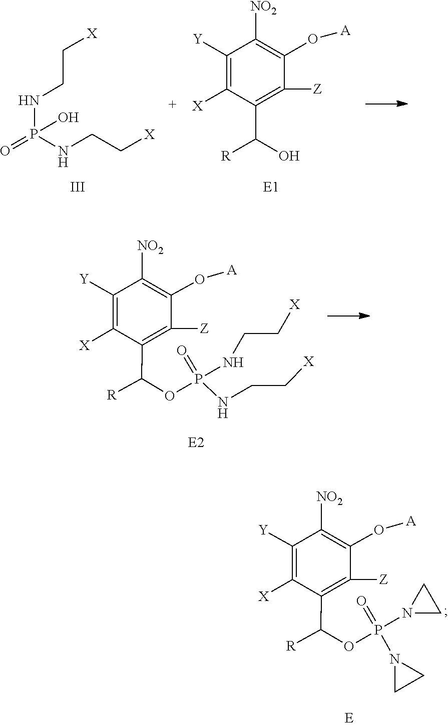
Compound F1 is reacted with Compound III to obtain Intermediate F2, which is subjected to a ring-closure reaction to obtain Compound F: 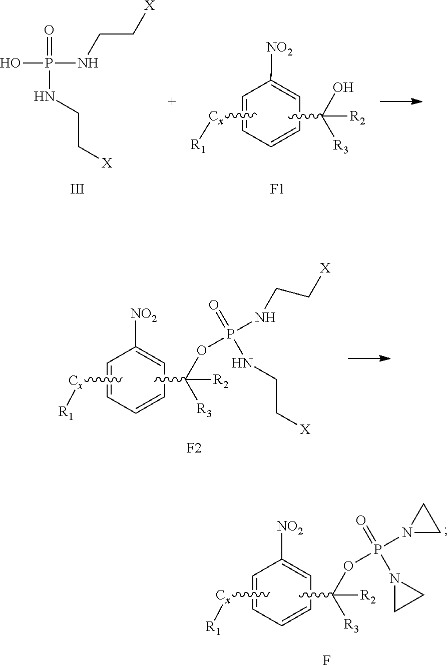
Compound G1-3-(I) is reacted with Compound III to obtain Intermediate G2-3-(I), which is subjected to a ring-closure reaction to obtain Compound G-3-(I): 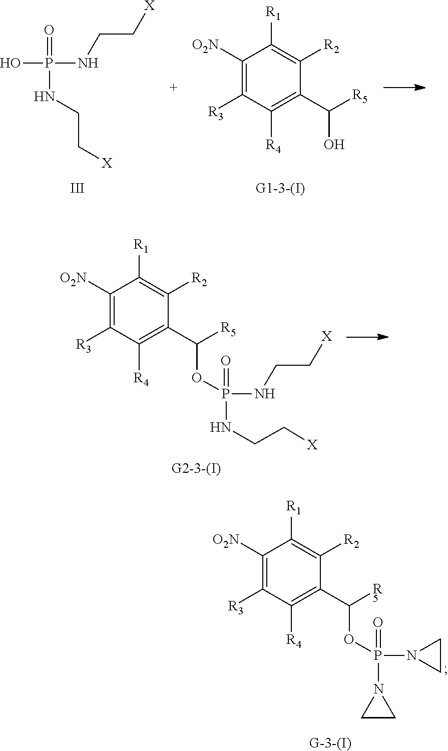
Compound H1 is reacted with Compound III to obtain Intermediate H2, which is subjected to a ring-closure reaction to obtain Compound H:

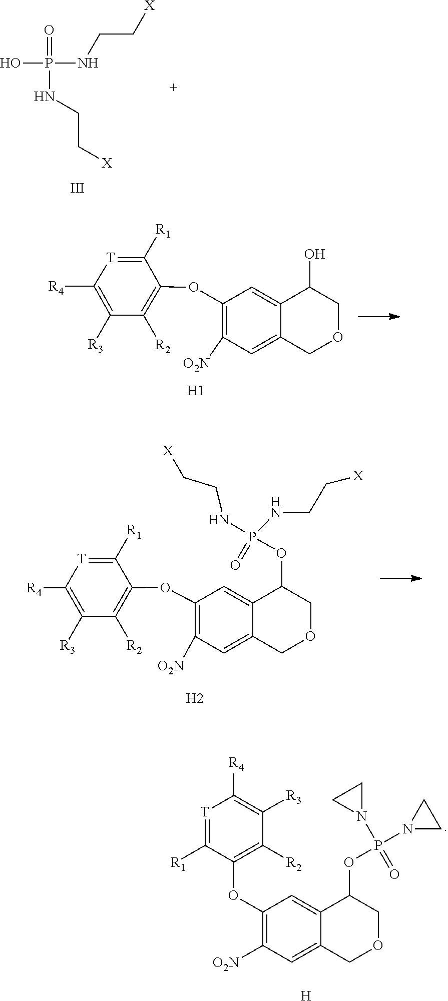

15. The method according to claim 13, wherein
Compound A is selected from compounds having the following structures: 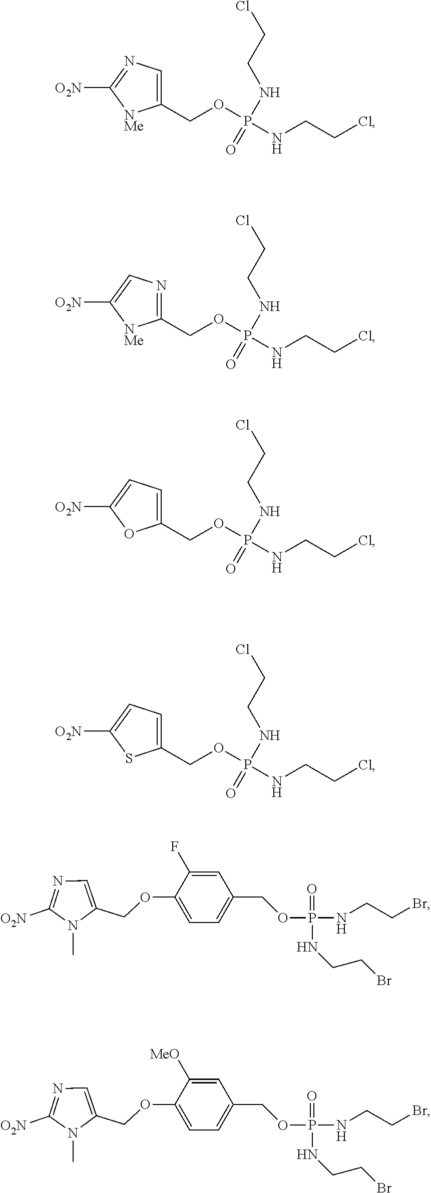 [SMILES: Cn1c(COP(=O)(NCCCl)NCCCl)cnc1[N+](=O)[O-] ; Cn1c([N+](=O)[O-])cnc1COP(=O)(NCCCl)NCCCl ; O=[N+]([O-])c1ccc(COP(=O)(NCCCl)NCCCl)o1 ; O=[N+]([O-])c1ccc(COP(=O)(NCCCl)NCCCl)s1 ; Cn1c(COc2ccc(COP(=O)(NCCBr)NCCBr)cc2F)cnc1[N+](=O)[O-] ; COc1cc(COP(=O)(NCCBr)NCCBr)ccc1OCc1cnc([N+](=O)[O-])n1C] 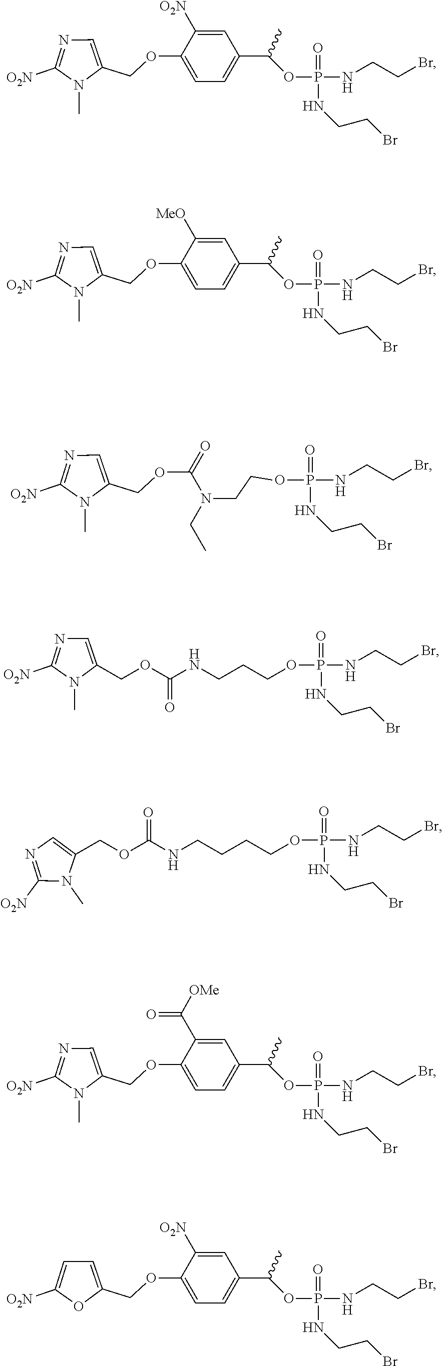 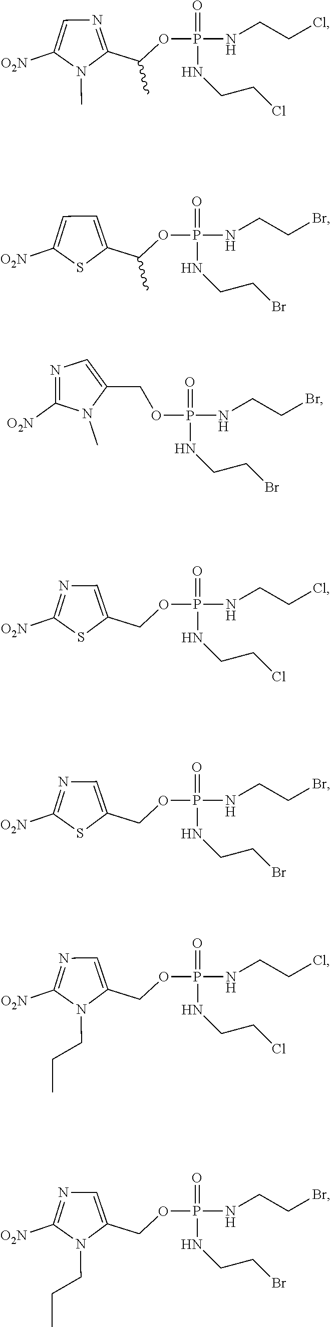 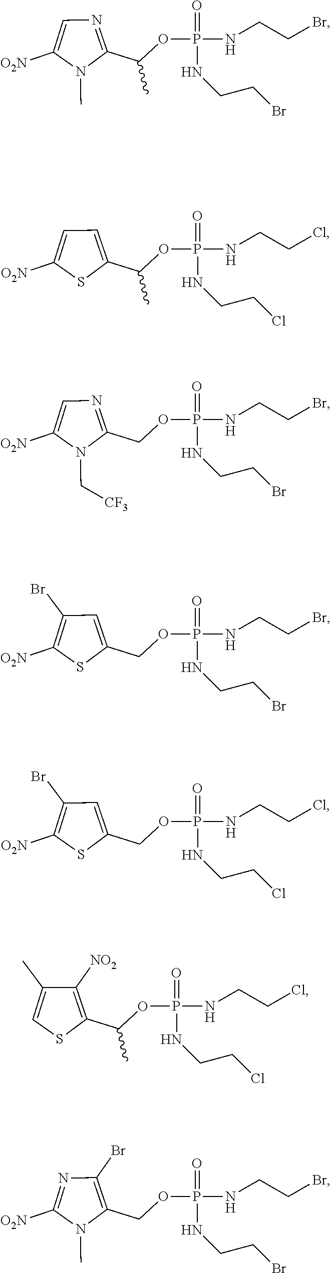 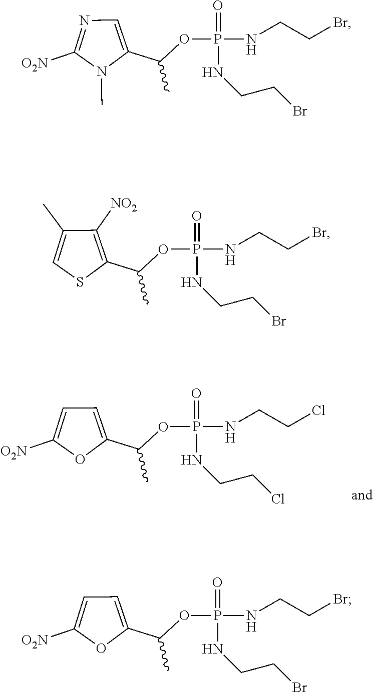
Compound B is selected from compounds having the following structures: 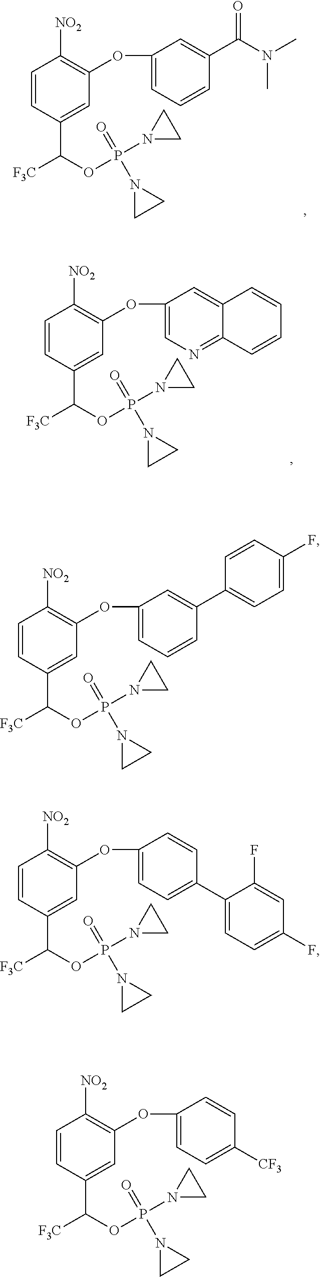 [SMILES: CN(C)C(=O)c1cccc(Oc2cc(C(OP(=O)(N3CC3)N3CC3)C(F)(F)F)ccc2[N+](=O)[O-])c1 ; O=[N+]([O-])c1ccc(C(OP(=O)(N2CC2)N2CC2)C(F)(F)F)cc1Oc1cnc2ccccc2c1 ; O=[N+]([O-])c1ccc(C(OP(=O)(N2CC2)N2CC2)C(F)(F)F)cc1Oc1cccc(-c2ccc(F)cc2)c1 ; O=[N+]([O-])c1ccc(C(OP(=O)(N2CC2)N2CC2)C(F)(F)F)cc1Oc1ccc(-c2ccc(F)cc2F)cc1 ; O=[N+]([O-])c1ccc(C(OP(=O)(N2CC2)N2CC2)C(F)(F)F)cc1Oc1ccc(C(F)(F)F)cc1] 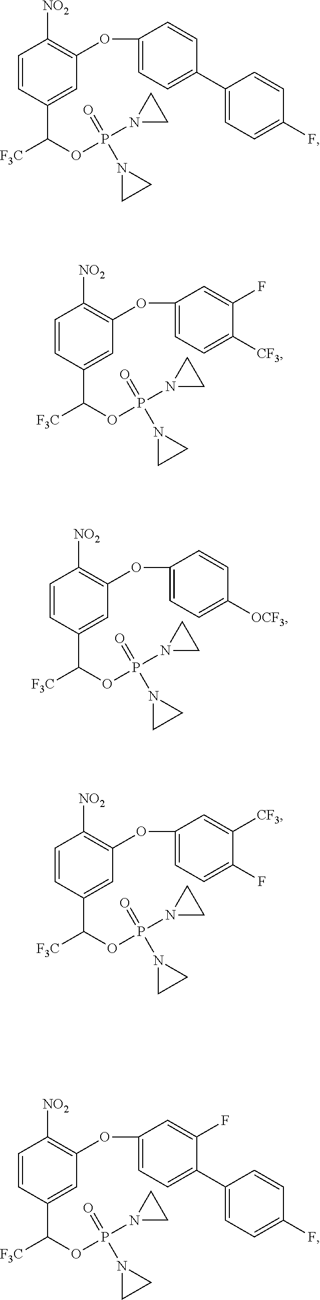 [SMILES: O=[N+]([O-])c1ccc(C(OP(=O)(N2CC2)N2CC2)C(F)(F)F)cc1Oc1ccc(-c2ccc(F)cc2)cc1 ; O=[N+]([O-])c1ccc(C(OP(=O)(N2CC2)N2CC2)C(F)(F)F)cc1Oc1ccc(C(F)(F)F)c(F)c1 ; O=[N+]([O-])c1ccc(C(OP(=O)(N2CC2)N2CC2)C(F)(F)F)cc1Oc1ccc(OC(F)(F)F)cc1 ; O=[N+]([O-])c1ccc(C(OP(=O)(N2CC2)N2CC2)C(F)(F)F)cc1Oc1ccc(F)c(C(F)(F)F)c1 ; O=[N+]([O-])c1ccc(C(OP(=O)(N2CC2)N2CC2)C(F)(F)F)cc1Oc1ccc(-c2ccc(F)cc2)c(F)c1] 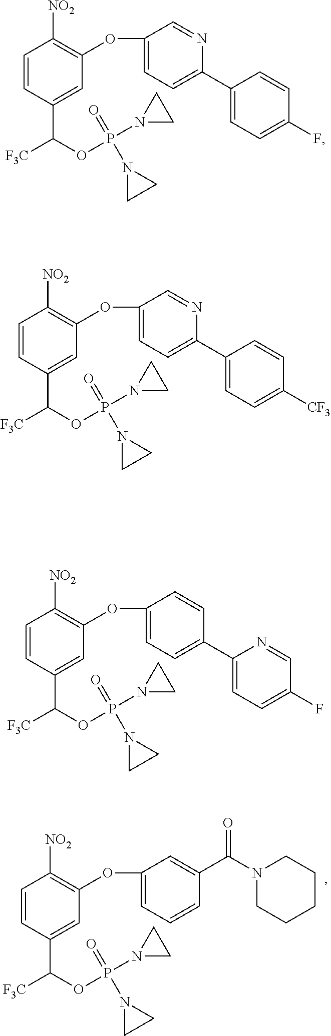 [SMILES: O=[N+]([O-])c1ccc(C(OP(=O)(N2CC2)N2CC2)C(F)(F)F)cc1Oc1ccc(-c2ccc(F)cc2)nc1 ; O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(F)cn2)cc1 ; O=C(c1cccc(Oc2cc(C(OP(=O)(N3CC3)N3CC3)C(F)(F)F)ccc2[N+](=O)[O-])c1)N1CCCCC1] 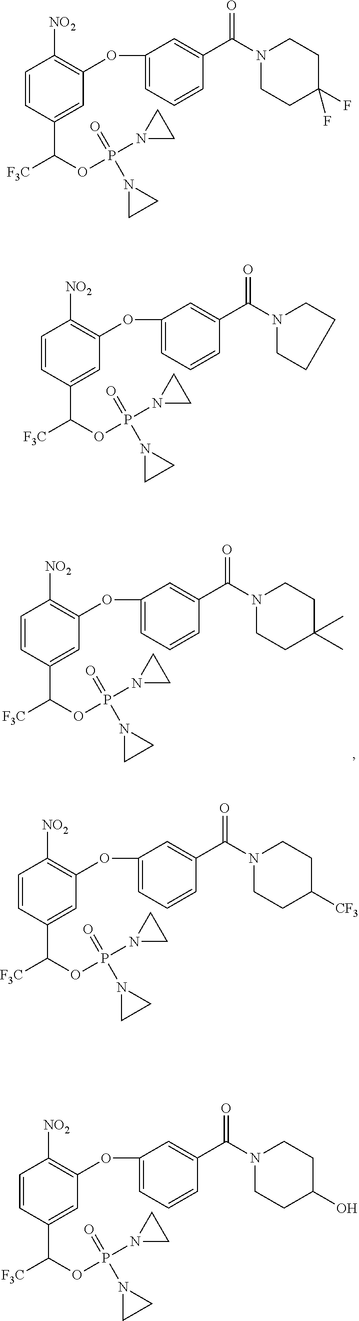 [SMILES: O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1 ; O=C(c1cccc(Oc2cc(C(OP(=O)(N3CC3)N3CC3)C(F)(F)F)ccc2[N+](=O)[O-])c1)N1CCC(C(F)(F)F)CC1 ; O=C(c1cccc(Oc2cc(C(OP(=O)(N3CC3)N3CC3)C(F)(F)F)ccc2[N+](=O)[O-])c1)N1CCC(O)CC1] 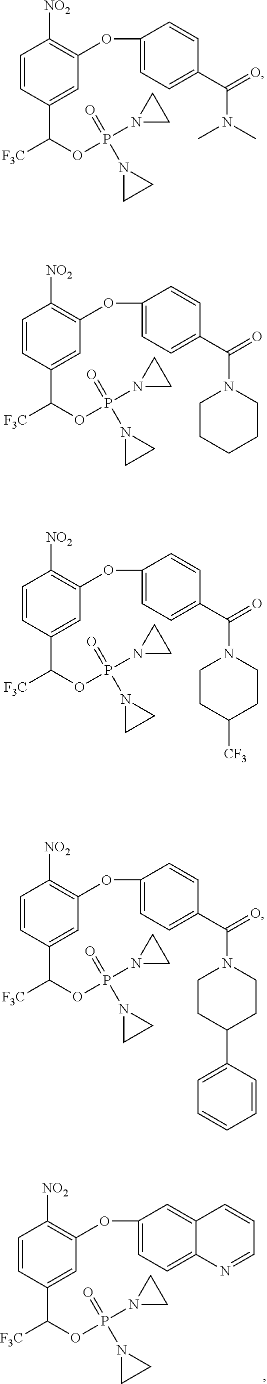 [SMILES: CN(C)C(=O)c1ccc(Oc2cc(C(OP(=O)(N3CC3)N3CC3)C(F)(F)F)ccc2[N+](=O)[O-])cc1 ; O=C(c1ccc(Oc2cc(C(OP(=O)(N3CC3)N3CC3)C(F)(F)F)ccc2[N+](=O)[O-])cc1)N1CCCCC1 ; O=C(c1ccc(Oc2cc(C(OP(=O)(N3CC3)N3CC3)C(F)(F)F)ccc2[N+](=O)[O-])cc1)N1CCC(C(F)(F)F)CC1 ; O=C(c1ccc(Oc2cc(C(OP(=O)(N3CC3)N3CC3)C(F)(F)F)ccc2[N+](=O)[O-])cc1)N1CCC(c2ccccc2)CC1 ; O=[N+]([O-])c1ccc(C(OP(=O)(N2CC2)N2CC2)C(F)(F)F)cc1Oc1ccc2ncccc2c1] 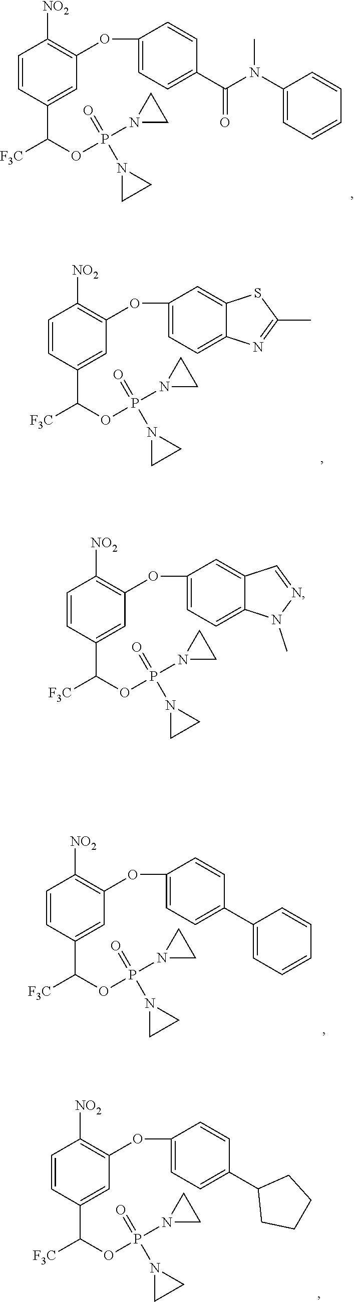 [SMILES: CN(C(=O)c1ccc(Oc2cc(C(OP(=O)(N3CC3)N3CC3)C(F)(F)F)ccc2[N+](=O)[O-])cc1)c1ccccc1 ; Cc1nc2ccc(Oc3cc(C(OP(=O)(N4CC4)N4CC4)C(F)(F)F)ccc3[N+](=O)[O-])cc2s1 ; Cn1ncc2cc(Oc3cc(C(OP(=O)(N4CC4)N4CC4)C(F)(F)F)ccc3[N+](=O)[O-])ccc21 ; O=[N+]([O-])c1ccc(C(OP(=O)(N2CC2)N2CC2)C(F)(F)F)cc1Oc1ccc(-c2ccccc2)cc1 ; O=[N+]([O-])c1ccc(C(OP(=O)(N2CC2)N2CC2)C(F)(F)F)cc1Oc1ccc(C2CCCC2)cc1] 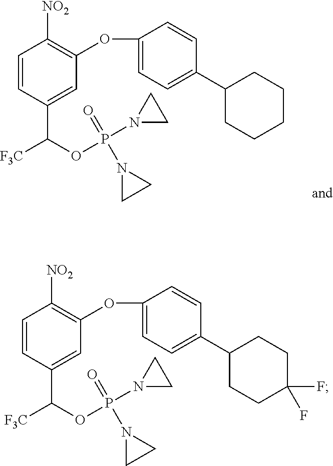 [SMILES: O=[N+]([O-])c1ccc(C(OP(=O)(N2CC2)N2CC2)C(F)(F)F)cc1Oc1ccc(C2CCCCC2)cc1 ; O=[N+]([O-])c1ccc(C(OP(=O)(N2CC2)N2CC2)C(F)(F)F)cc1Oc1ccc(C2CCC(F)(F)CC2)cc1]
Compound C is selected from compounds having the following structures: 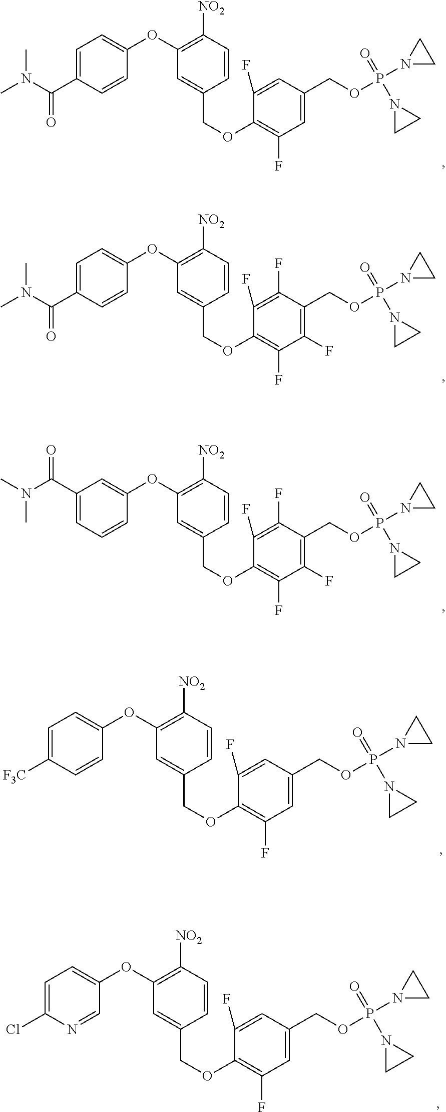 [SMILES: CN(C)C(=O)c1ccc(Oc2cc(COc3c(F)cc(COP(=O)(N4CC4)N4CC4)cc3F)ccc2[N+](=O)[O-])cc1 ; CN(C)C(=O)c1ccc(Oc2cc(COc3c(F)c(F)c(COP(=O)(N4CC4)N4CC4)c(F)c3F)ccc2[N+](=O)[O-])cc1 ; CN(C)C(=O)c1cccc(Oc2cc(COc3c(F)c(F)c(COP(=O)(N4CC4)N4CC4)c(F)c3F)ccc2[N+](=O)[O-])c1 ; O=[N+]([O-])c1ccc(COc2c(F)cc(COP(=O)(N3CC3)N3CC3)cc2F)cc1Oc1ccc(C(F)(F)F)cc1 ; O=[N+]([O-])c1ccc(COc2c(F)cc(COP(=O)(N3CC3)N3CC3)cc2F)cc1Oc1ccc(Cl)nc1] 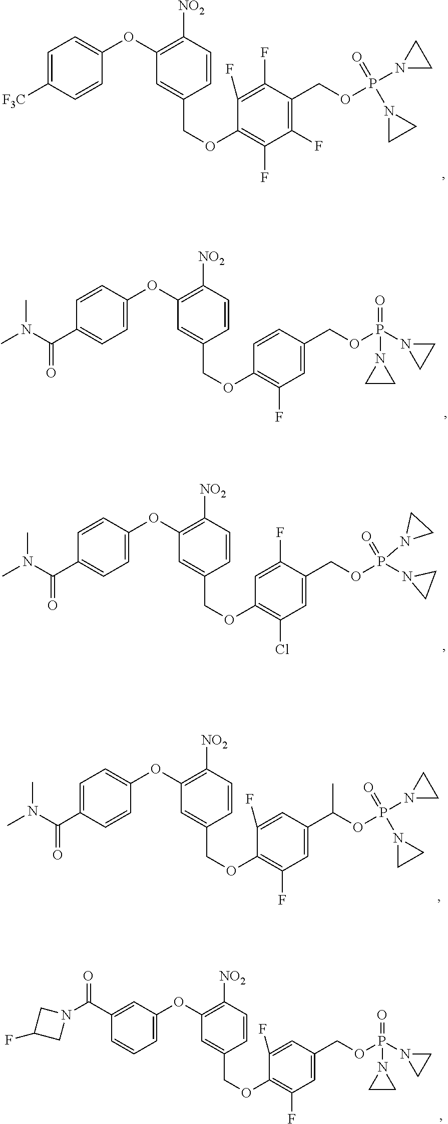 [SMILES: O=[N+]([O-])c1ccc(COc2c(F)c(F)c(COP(=O)(N3CC3)N3CC3)c(F)c2F)cc1Oc1ccc(C(F)(F)F)cc1 ; CN(C)C(=O)c1ccc(Oc2cc(COc3ccc(COP(=O)(N4CC4)N4CC4)cc3F)ccc2[N+](=O)[O-])cc1 ; CN(C)C(=O)c1ccc(Oc2cc(COc3cc(F)c(COP(=O)(N4CC4)N4CC4)cc3Cl)ccc2[N+](=O)[O-])cc1 ; CC(OP(=O)(N1CC1)N1CC1)c1cc(F)c(OCc2ccc([N+](=O)[O-])c(Oc3ccc(C(=O)N(C)C)cc3)c2)c(F)c1 ; O=C(c1cccc(Oc2cc(COc3c(F)cc(COP(=O)(N4CC4)N4CC4)cc3F)ccc2[N+](=O)[O-])c1)N1CC(F)C1] 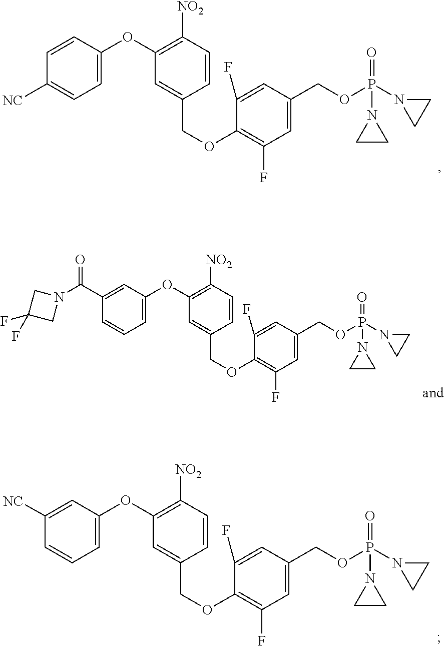 [SMILES: N#Cc1ccc(Oc2cc(COc3c(F)cc(COP(=O)(N4CC4)N4CC4)cc3F)ccc2[N+](=O)[O-])cc1 ; O=C(c1cccc(Oc2cc(COc3c(F)cc(COP(=O)(N4CC4)N4CC4)cc3F)ccc2[N+](=O)[O-])c1)N1CC(F)(F)C1 ; N#Cc1cccc(Oc2cc(COc3c(F)cc(COP(=O)(N4CC4)N4CC4)cc3F)ccc2[N+](=O)[O-])c1]
Compound D is selected from compounds having the following structures: 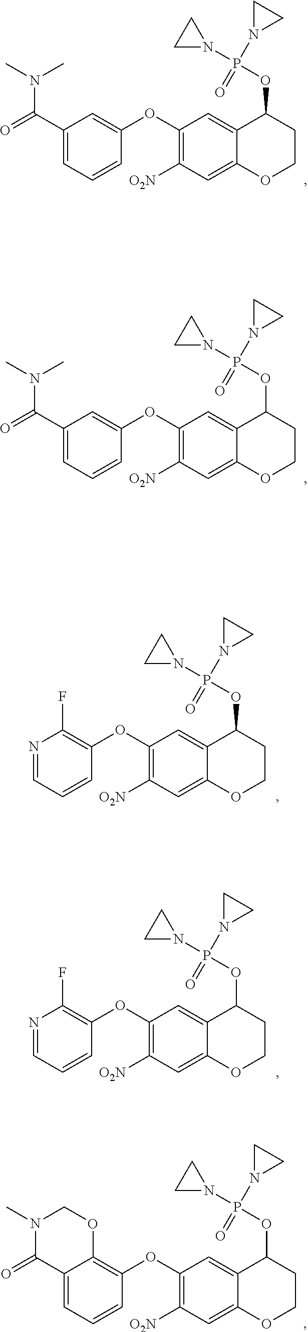 [SMILES: CN(C)C(=O)c1cccc(Oc2cc3c(cc2[N+](=O)[O-])OCC[C@@H]3OP(=O)(N2CC2)N2CC2)c1 ; CN(C)C(=O)c1cccc(Oc2cc3c(cc2[N+](=O)[O-])OCCC3OP(=O)(N2CC2)N2CC2)c1 ; O=[N+]([O-])c1cc2c(cc1Oc1cccnc1F)[C@@H](OP(=O)(N1CC1)N1CC1)CCO2 ; O=[N+]([O-])c1cc2c(cc1Oc1cccnc1F)C(OP(=O)(N1CC1)N1CC1)CCO2 ; CN1COc2c(Oc3cc4c(cc3[N+](=O)[O-])OCCC4OP(=O)(N3CC3)N3CC3)cccc2C1=O] 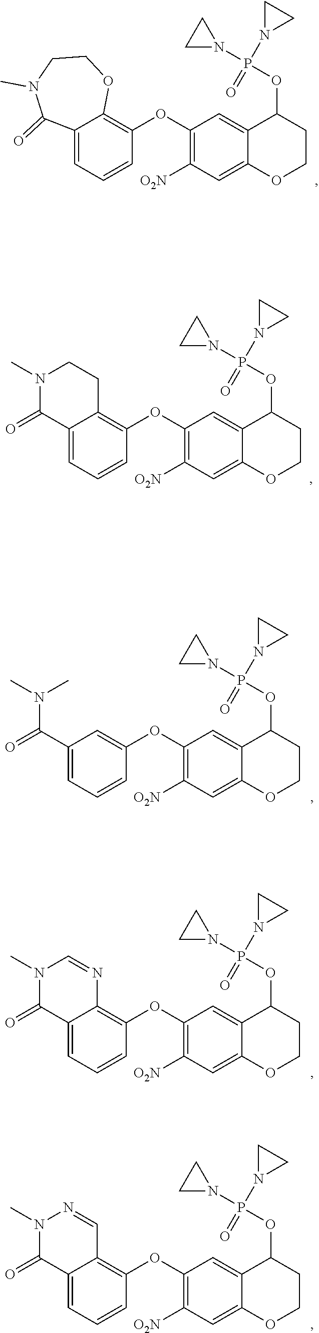 [SMILES: CN1CCOc2c(Oc3cc4c(cc3[N+](=O)[O-])OCCC4OP(=O)(N3CC3)N3CC3)cccc2C1=O ; CN1CCc2c(Oc3cc4c(cc3[N+](=O)[O-])OCCC4OP(=O)(N3CC3)N3CC3)cccc2C1=O ; CN(C)C(=O)c1cccc(Oc2cc3c(cc2[N+](=O)[O-])OCCC3OP(=O)(N2CC2)N2CC2)c1 ; Cn1cnc2c(Oc3cc4c(cc3[N+](=O)[O-])OCCC4OP(=O)(N3CC3)N3CC3)cccc2c1=O ; Cn1ncc2c(Oc3cc4c(cc3[N+](=O)[O-])OCCC4OP(=O)(N3CC3)N3CC3)cccc2c1=O] 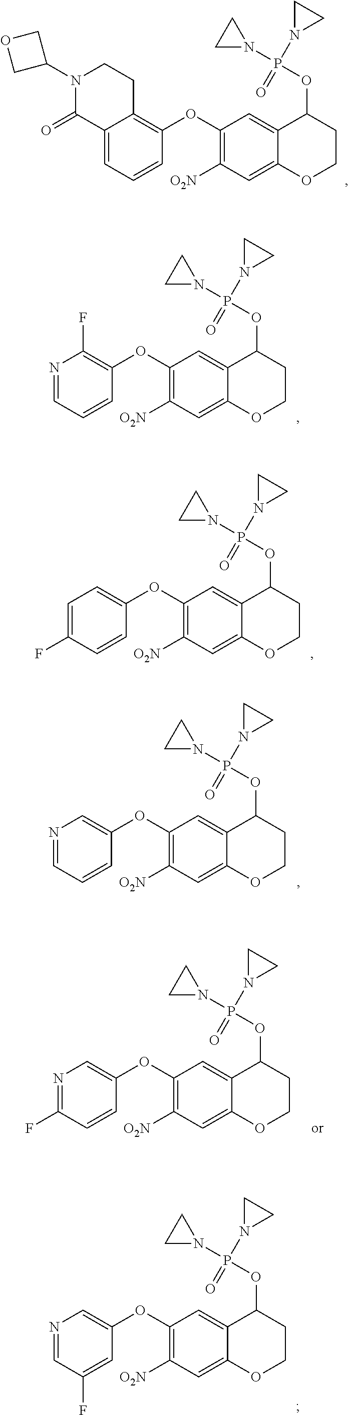 [SMILES: O=C1c2cccc(Oc3cc4c(cc3[N+](=O)[O-])OCCC4OP(=O)(N3CC3)N3CC3)c2CCN1C1COC1 ; O=[N+]([O-])c1cc2c(cc1Oc1cccnc1F)C(OP(=O)(N1CC1)N1CC1)CCO2 ; O=[N+]([O-])c1cc2c(cc1Oc1ccc(F)cc1)C(OP(=O)(N1CC1)N1CC1)CCO2 ; O=[N+]([O-])c1cc2c(cc1Oc1cccnc1)C(OP(=O)(N1CC1)N1CC1)CCO2 ; O=[N+]([O-])c1cc2c(cc1Oc1ccc(F)nc1)C(OP(=O)(N1CC1)N1CC1)CCO2 ; O=[N+]([O-])c1cc2c(cc1Oc1cncc(F)c1)C(OP(=O)(N1CC1)N1CC1)CCO2]
Compound E is selected from compounds having the following structures: 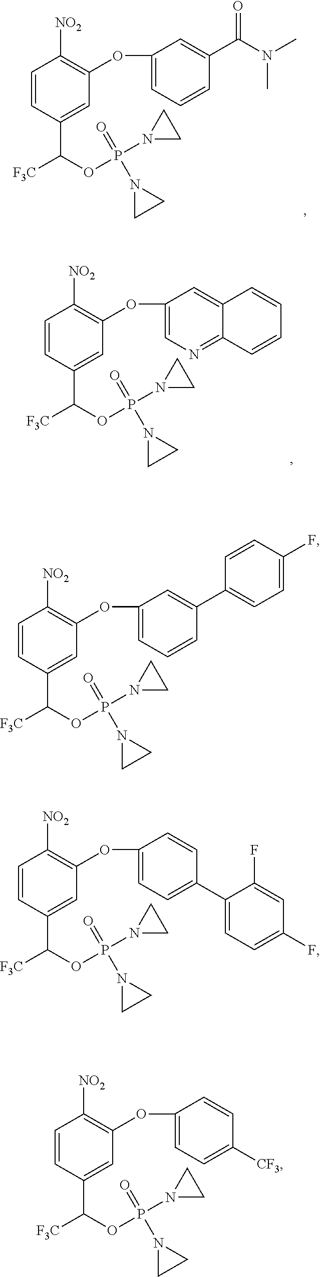 [SMILES: CN(C)C(=O)c1cccc(Oc2cc(C(OP(=O)(N3CC3)N3CC3)C(F)(F)F)ccc2[N+](=O)[O-])c1 ; O=[N+]([O-])c1ccc(C(OP(=O)(N2CC2)N2CC2)C(F)(F)F)cc1Oc1cnc2ccccc2c1 ; O=[N+]([O-])c1ccc(C(OP(=O)(N2CC2)N2CC2)C(F)(F)F)cc1Oc1cccc(-c2ccc(F)cc2)c1 ; O=[N+]([O-])c1ccc(C(OP(=O)(N2CC2)N2CC2)C(F)(F)F)cc1Oc1ccc(-c2ccc(F)cc2F)cc1 ; O=[N+]([O-])c1ccc(C(OP(=O)(N2CC2)N2CC2)C(F)(F)F)cc1Oc1ccc(C(F)(F)F)cc1] 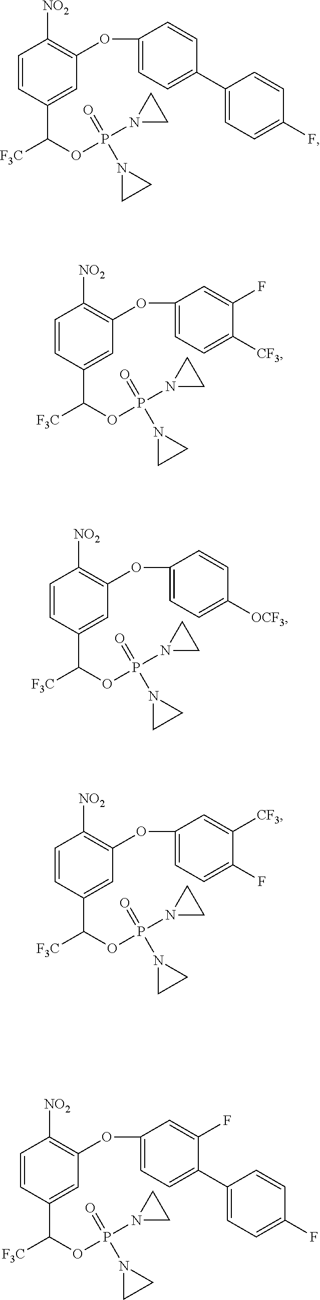 [SMILES: O=[N+]([O-])c1ccc(C(OP(=O)(N2CC2)N2CC2)C(F)(F)F)cc1Oc1ccc(-c2ccc(F)cc2)cc1 ; O=[N+]([O-])c1ccc(C(OP(=O)(N2CC2)N2CC2)C(F)(F)F)cc1Oc1ccc(C(F)(F)F)c(F)c1 ; O=[N+]([O-])c1ccc(C(OP(=O)(N2CC2)N2CC2)C(F)(F)F)cc1Oc1ccc(OC(F)(F)F)cc1 ; O=[N+]([O-])c1ccc(C(OP(=O)(N2CC2)N2CC2)C(F)(F)F)cc1Oc1ccc(F)c(C(F)(F)F)c1 ; O=[N+]([O-])c1ccc(C(OP(=O)(N2CC2)N2CC2)C(F)(F)F)cc1Oc1ccc(-c2ccc(F)cc2)c(F)c1] 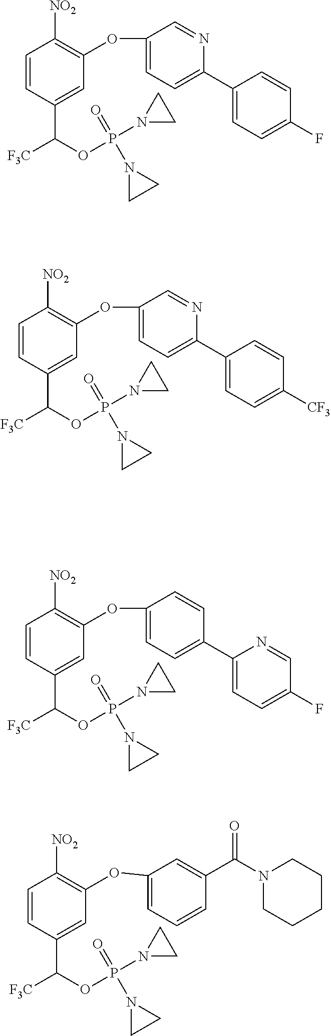 [SMILES: O=[N+]([O-])c1ccc(C(OP(=O)(N2CC2)N2CC2)C(F)(F)F)cc1Oc1ccc(-c2ccc(F)cc2)nc1 ; O=[N+]([O-])c1ccc(C(OP(=O)(N2CC2)N2CC2)C(F)(F)F)cc1Oc1ccc(-c2ccc(C(F)(F)F)cc2)nc1 ; O=[N+]([O-])c1ccc(C(OP(=O)(N2CC2)N2CC2)C(F)(F)F)cc1Oc1ccc(-c2ccc(F)cn2)cc1 ; O=C(c1cccc(Oc2cc(C(OP(=O)(N3CC3)N3CC3)C(F)(F)F)ccc2[N+](=O)[O-])c1)N1CCCCC1] 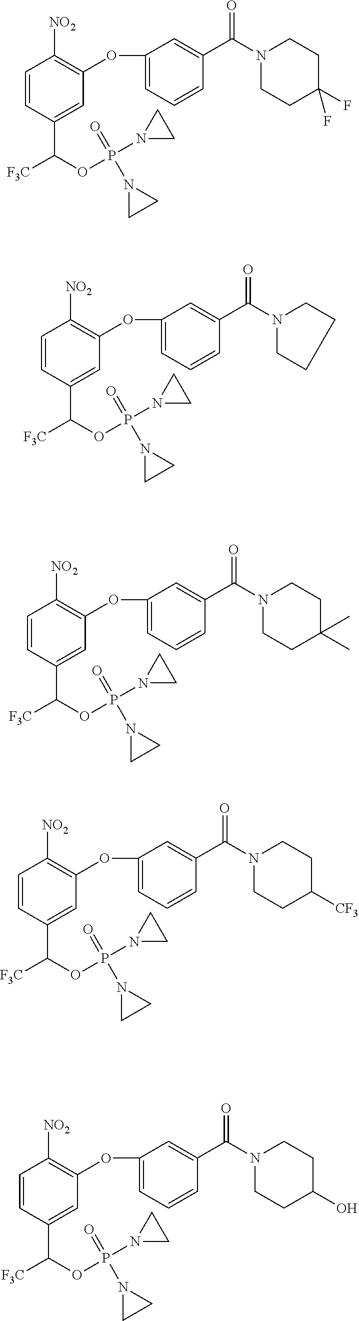 [SMILES: O=C(c1cccc(Oc2cc(C(OP(=O)(N3CC3)N3CC3)C(F)(F)F)ccc2[N+](=O)[O-])c1)N1CCC(F)(F)CC1 ; O=C(c1cccc(Oc2cc(C(OP(=O)(N3CC3)N3CC3)C(F)(F)F)ccc2[N+](=O)[O-])c1)N1CCCC1 ; CC1(C)CCN(C(=O)c2cccc(Oc3cc(C(OP(=O)(N4CC4)N4CC4)C(F)(F)F)ccc3[N+](=O)[O-])c2)CC1 ; O=C(c1cccc(Oc2cc(C(OP(=O)(N3CC3)N3CC3)C(F)(F)F)ccc2[N+](=O)[O-])c1)N1CCC(C(F)(F)F)CC1 ; O=C(c1cccc(Oc2cc(C(OP(=O)(N3CC3)N3CC3)C(F)(F)F)ccc2[N+](=O)[O-])c1)N1CCC(O)CC1] 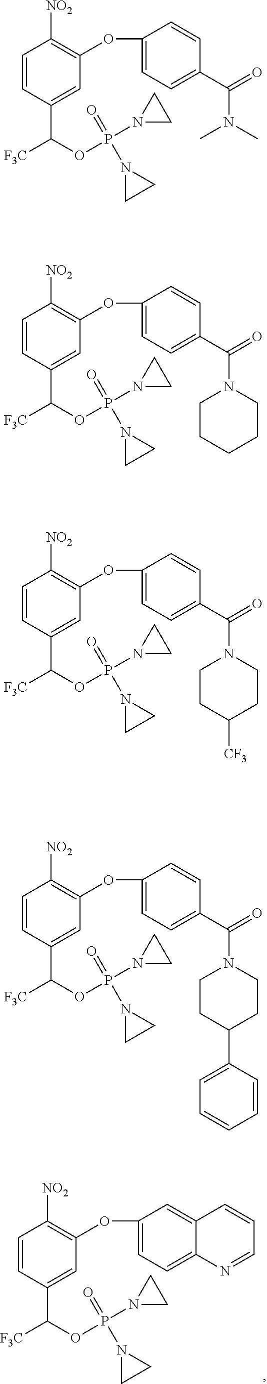 [SMILES: CN(C)C(=O)c1ccc(Oc2cc(C(OP(=O)(N3CC3)N3CC3)C(F)(F)F)ccc2[N+](=O)[O-])cc1 ; O=C(c1ccc(Oc2cc(C(OP(=O)(N3CC3)N3CC3)C(F)(F)F)ccc2[N+](=O)[O-])cc1)N1CCCCC1 ; O=C(c1ccc(Oc2cc(C(OP(=O)(N3CC3)N3CC3)C(F)(F)F)ccc2[N+](=O)[O-])cc1)N1CCC(C(F)(F)F)CC1 ; O=C(c1ccc(Oc2cc(C(OP(=O)(N3CC3)N3CC3)C(F)(F)F)ccc2[N+](=O)[O-])cc1)N1CCC(c2ccccc2)CC1 ; O=[N+]([O-])c1ccc(C(OP(=O)(N2CC2)N2CC2)C(F)(F)F)cc1Oc1ccc2ncccc2c1] 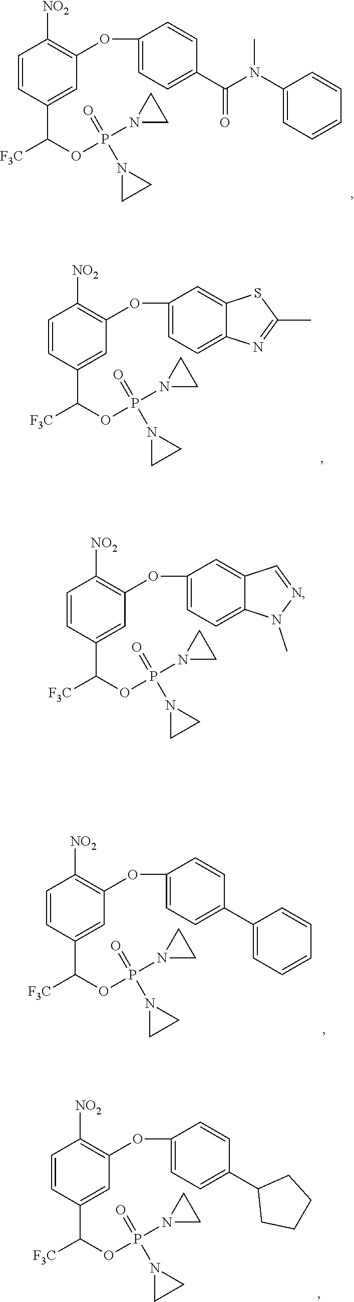 [SMILES: CN(C(=O)c1ccc(Oc2cc(C(OP(=O)(N3CC3)N3CC3)C(F)(F)F)ccc2[N+](=O)[O-])cc1)c1ccccc1 ; Cc1nc2ccc(Oc3cc(C(OP(=O)(N4CC4)N4CC4)C(F)(F)F)ccc3[N+](=O)[O-])cc2s1 ; Cn1ncc2cc(Oc3cc(C(OP(=O)(N4CC4)N4CC4)C(F)(F)F)ccc3[N+](=O)[O-])ccc21 ; O=[N+]([O-])c1ccc(C(OP(=O)(N2CC2)N2CC2)C(F)(F)F)cc1Oc1ccc(-c2ccccc2)cc1 ; O=[N+]([O-])c1ccc(C(OP(=O)(N2CC2)N2CC2)C(F)(F)F)cc1Oc1ccc(C2CCCC2)cc1] 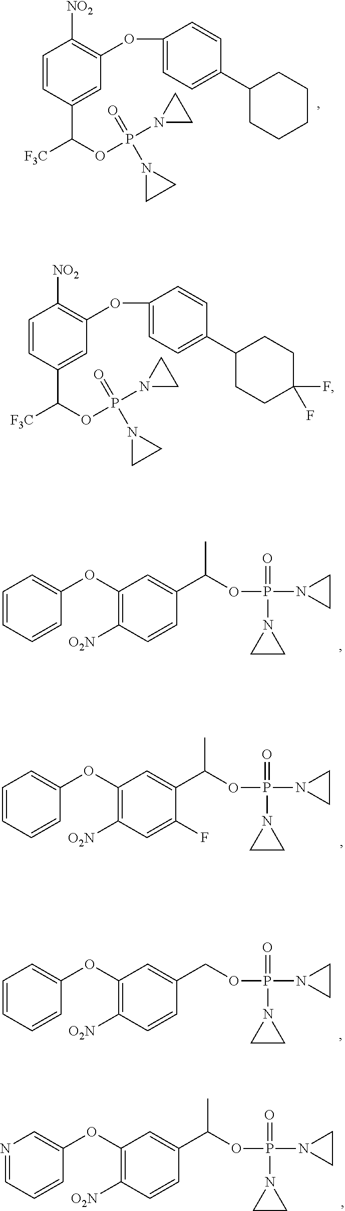 [SMILES: O=[N+]([O-])c1ccc(C(OP(=O)(N2CC2)N2CC2)C(F)(F)F)cc1Oc1ccc(C2CCCCC2)cc1 ; O=[N+]([O-])c1ccc(C(OP(=O)(N2CC2)N2CC2)C(F)(F)F)cc1Oc1ccc(C2CCC(F)(F)CC2)cc1 ; CC(OP(=O)(N1CC1)N1CC1)c1ccc([N+](=O)[O-])c(Oc2ccccc2)c1 ; CC(OP(=O)(N1CC1)N1CC1)c1cc(Oc2ccccc2)c([N+](=O)[O-])cc1F ; O=[N+]([O-])c1ccc(COP(=O)(N2CC2)N2CC2)cc1Oc1ccccc1 ; CC(OP(=O)(N1CC1)N1CC1)c1ccc([N+](=O)[O-])c(Oc2cccnc2)c1] 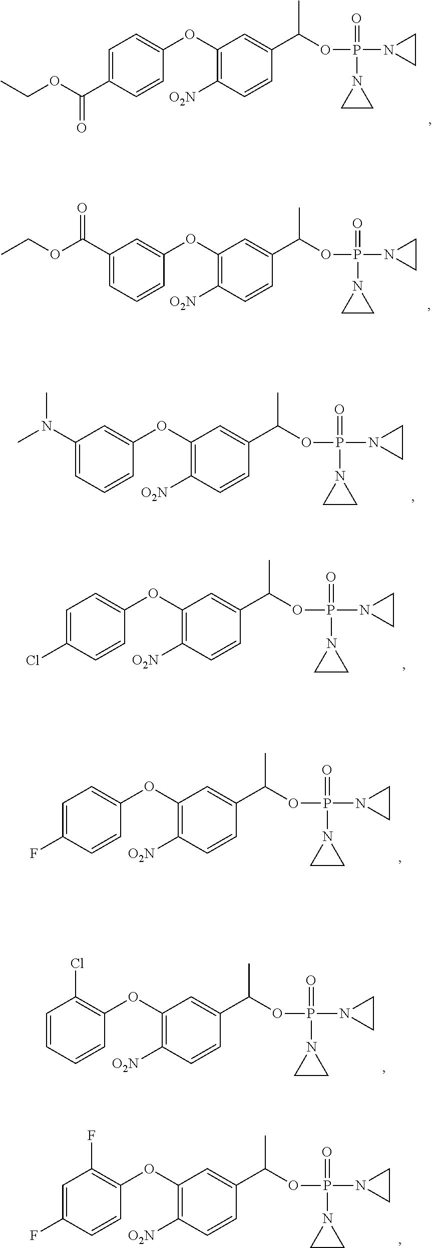 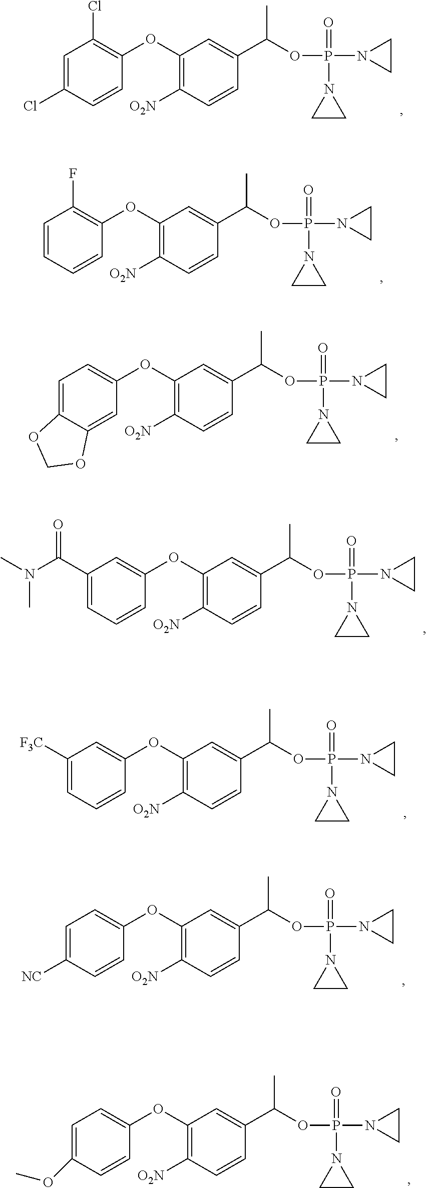 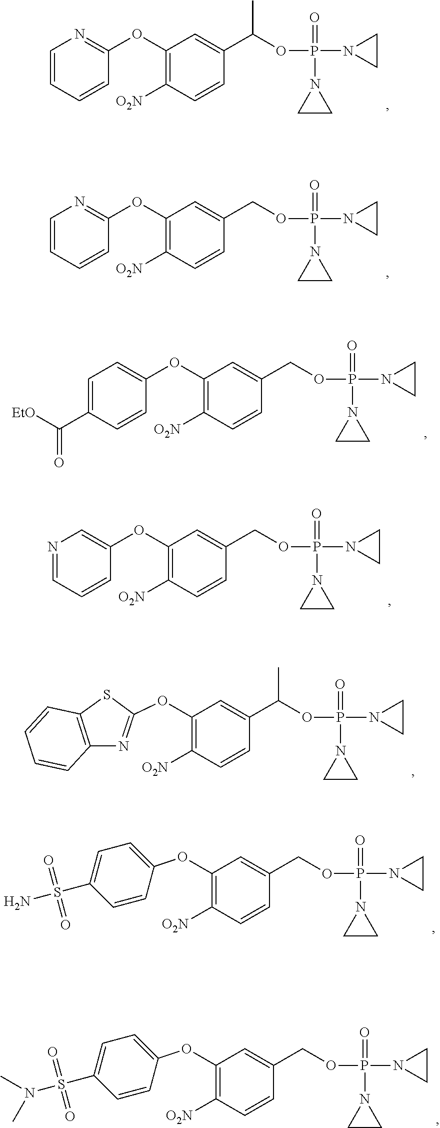 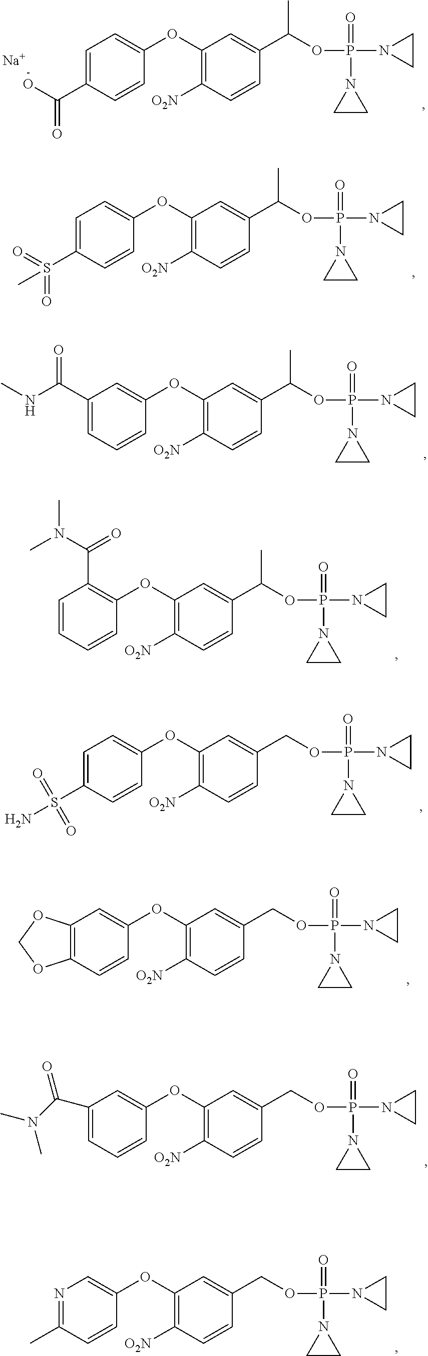 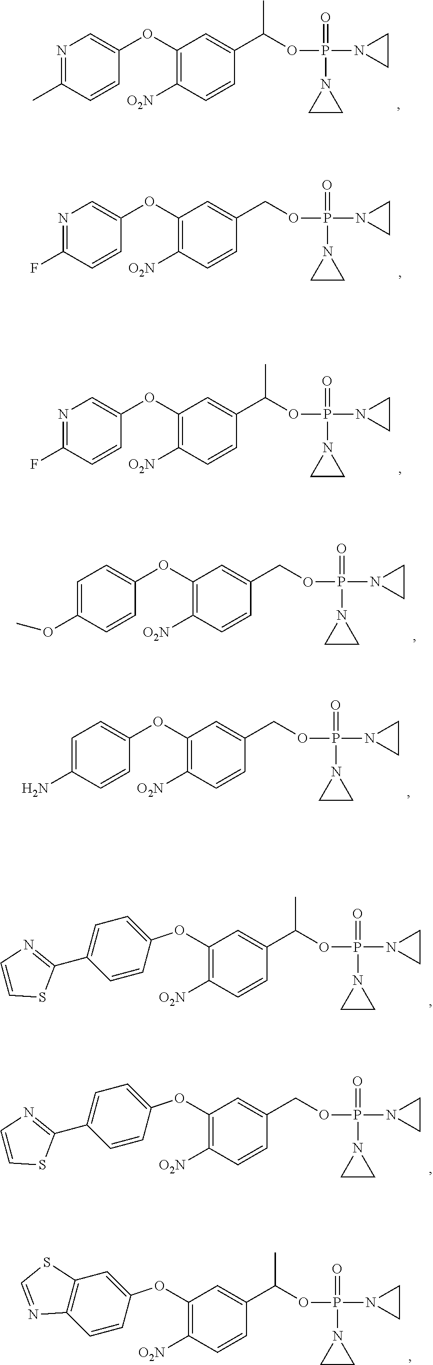 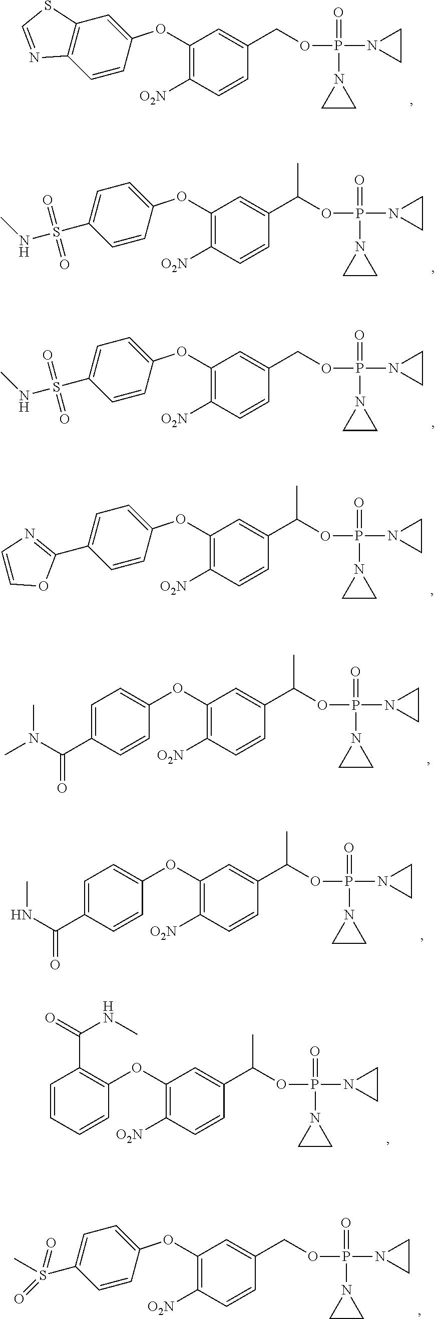 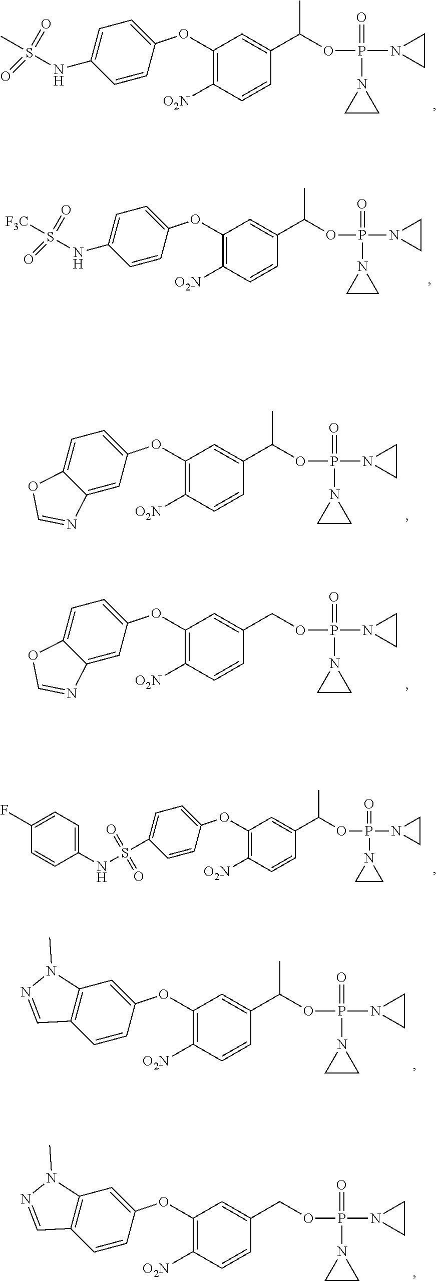 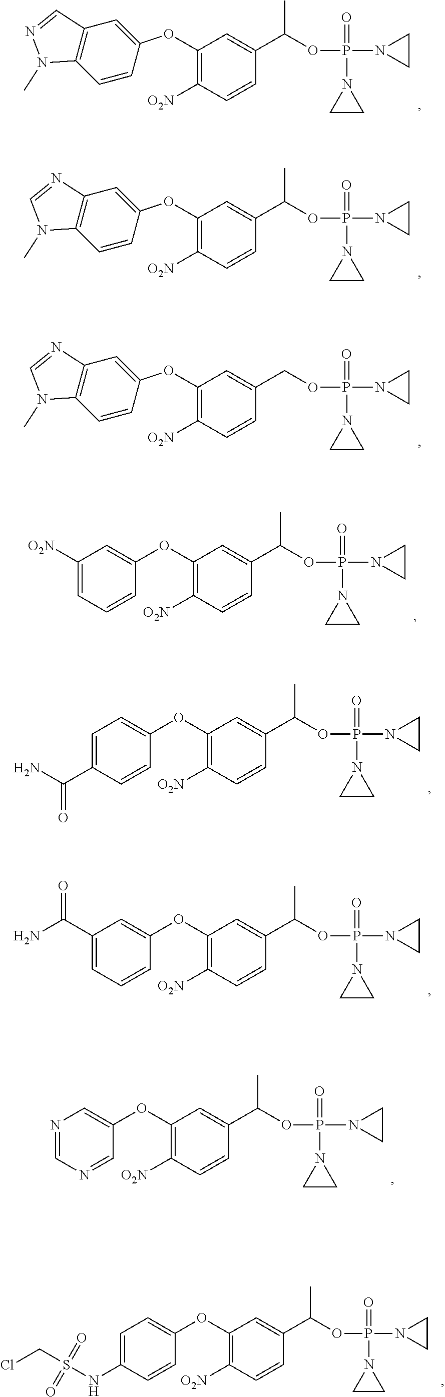 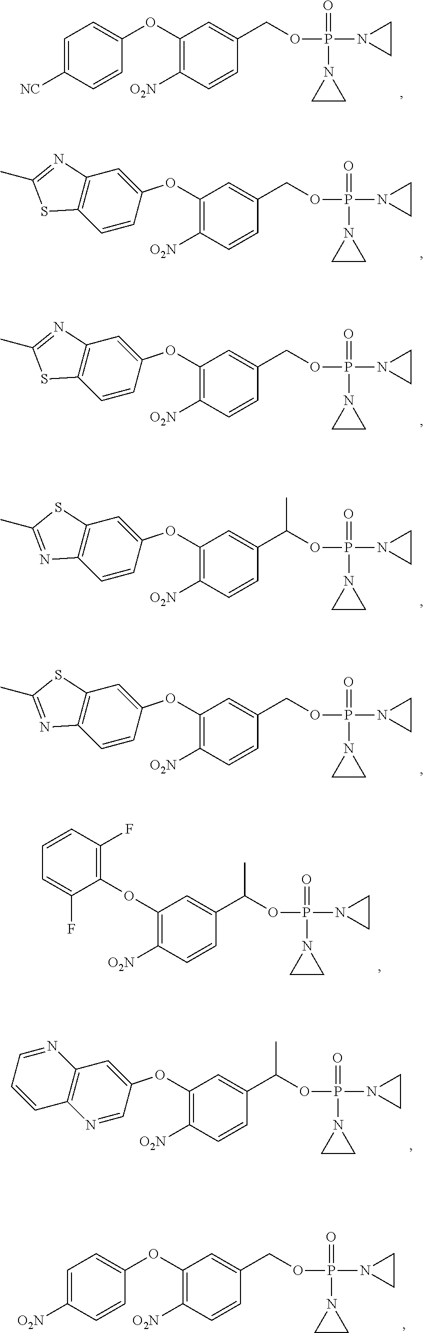 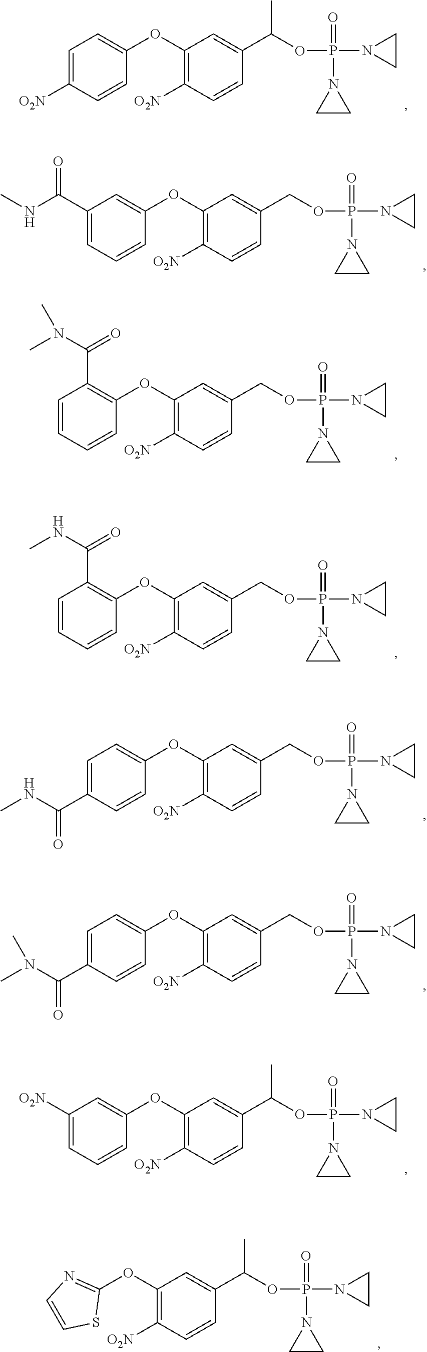 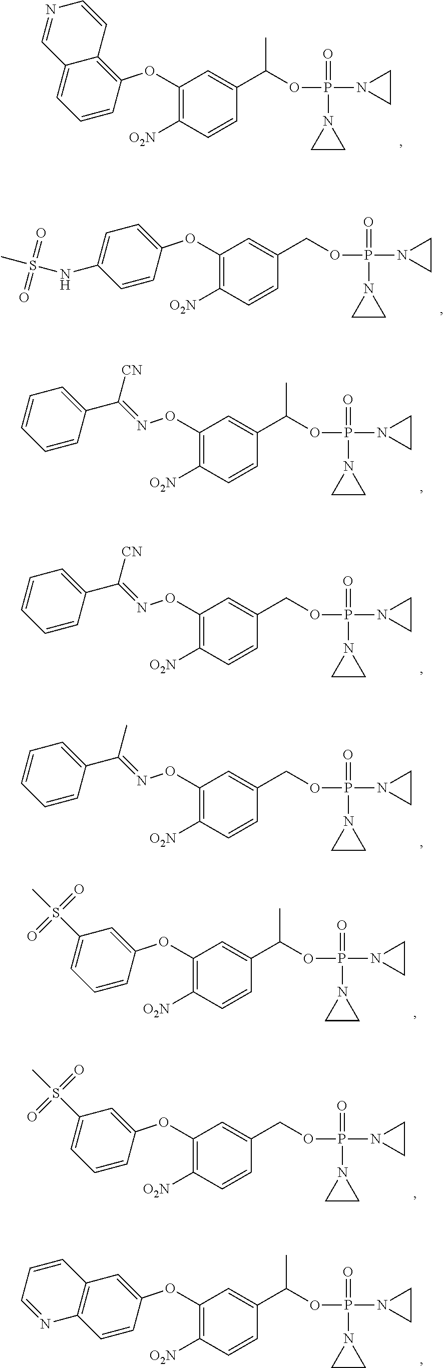 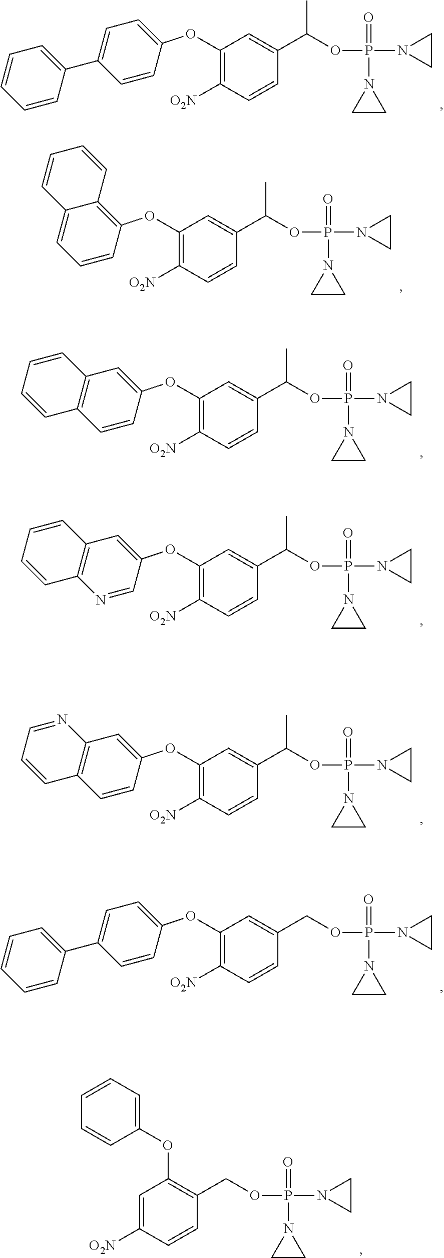 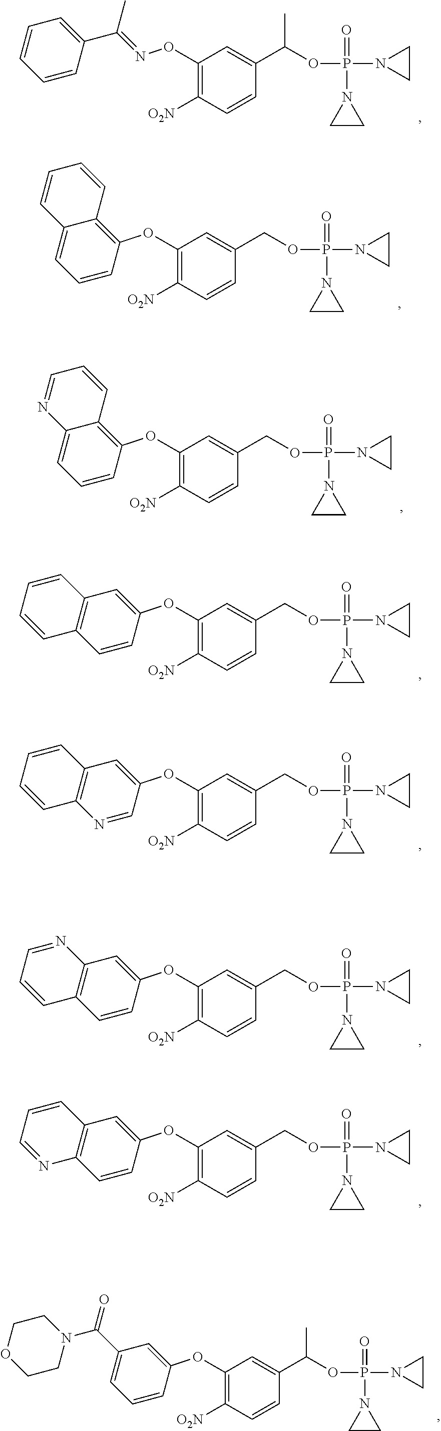 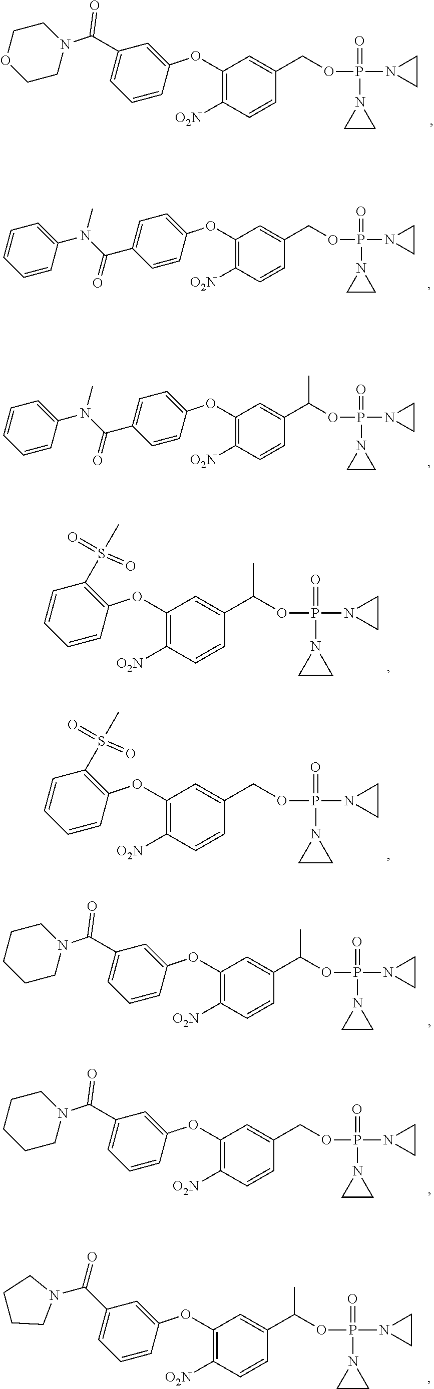 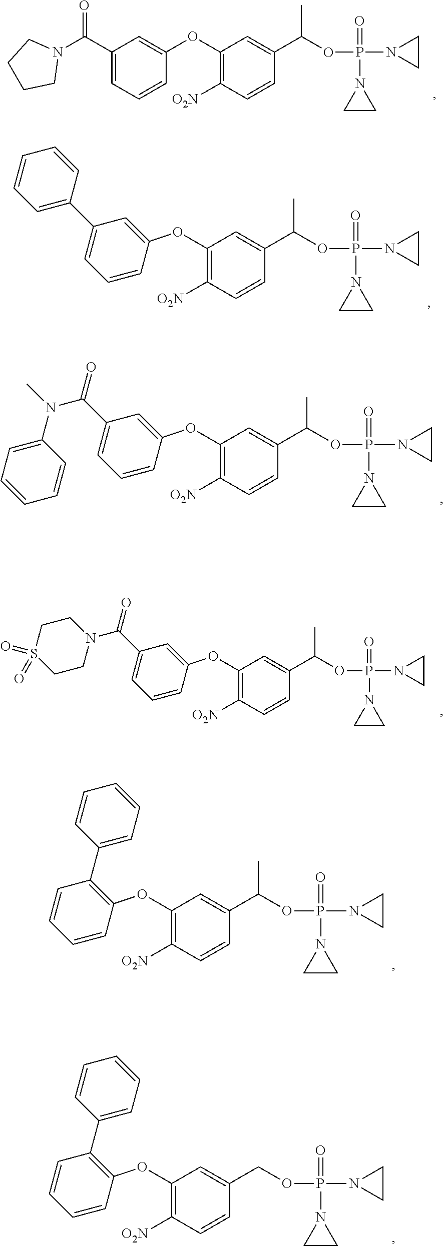 [SMILES: CC(OP(=O)(N1CC1)N1CC1)c1ccc([N+](=O)[O-])c(Oc2cccc(C(=O)N3CCCC3)c2)c1 ; CC(OP(=O)(N1CC1)N1CC1)c1ccc([N+](=O)[O-])c(Oc2cccc(-c3ccccc3)c2)c1 ; CC(OP(=O)(N1CC1)N1CC1)c1ccc([N+](=O)[O-])c(Oc2cccc(C(=O)N(C)c3ccccc3)c2)c1 ; CC(OP(=O)(N1CC1)N1CC1)c1ccc([N+](=O)[O-])c(Oc2cccc(C(=O)N3CCS(=O)(=O)CC3)c2)c1 ; CC(OP(=O)(N1CC1)N1CC1)c1ccc([N+](=O)[O-])c(Oc2ccccc2-c2ccccc2)c1 ; O=[N+]([O-])c1ccc(COP(=O)(N2CC2)N2CC2)cc1Oc1ccccc1-c1ccccc1] 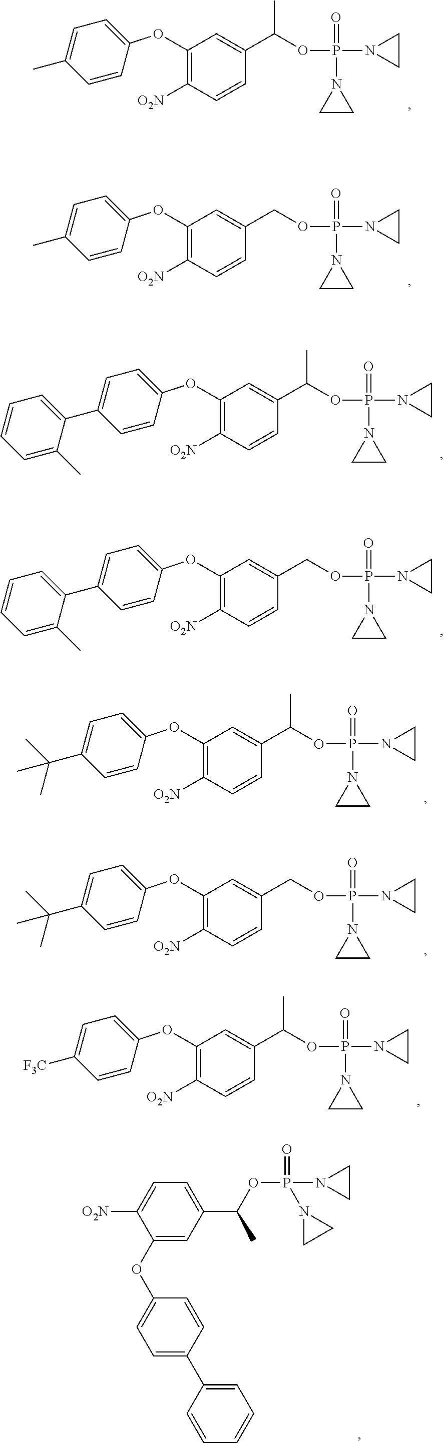 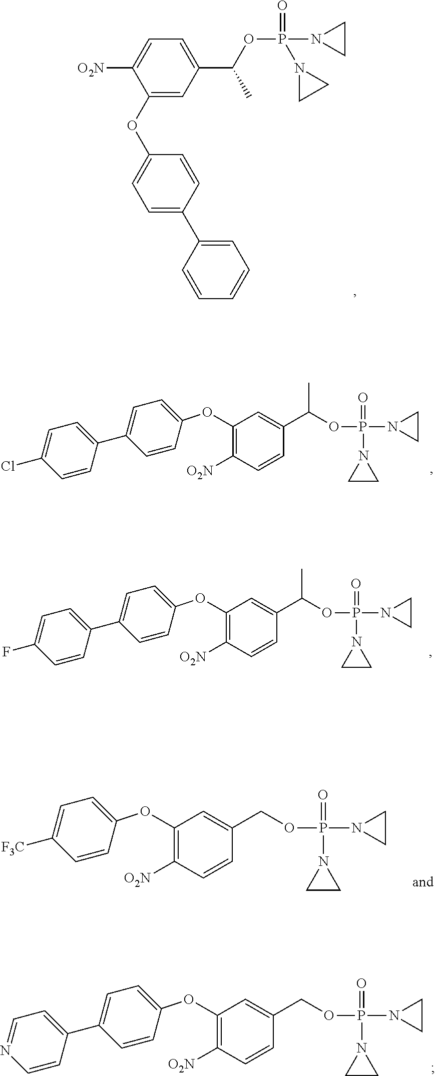 [SMILES: C[C@@H](OP(=O)(N1CC1)N1CC1)c1ccc([N+](=O)[O-])c(Oc2ccc(-c3ccccc3)cc2)c1 ; CC(OP(=O)(N1CC1)N1CC1)c1ccc([N+](=O)[O-])c(Oc2ccc(-c3ccc(Cl)cc3)cc2)c1 ; CC(OP(=O)(N1CC1)N1CC1)c1ccc([N+](=O)[O-])c(Oc2ccc(-c3ccc(F)cc3)cc2)c1 ; O=[N+]([O-])c1ccc(COP(=O)(N2CC2)N2CC2)cc1Oc1ccc(C(F)(F)F)cc1 ; O=[N+]([O-])c1ccc(COP(=O)(N2CC2)N2CC2)cc1Oc1ccc(-c2ccncc2)cc1]
Compound F is selected from compounds having the following structures: 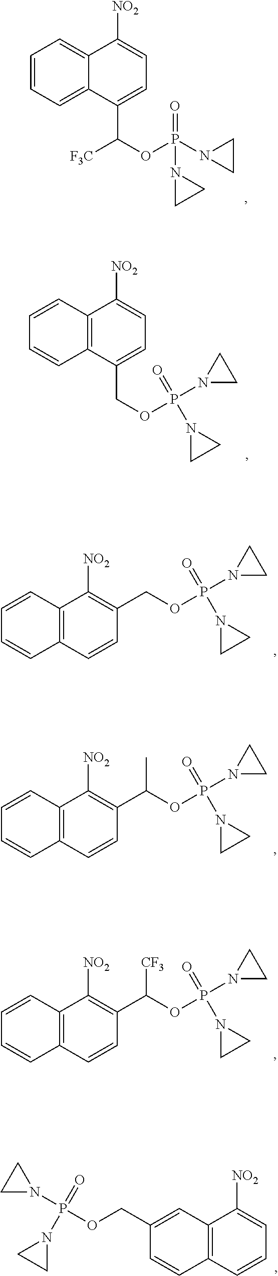 [SMILES: O=[N+]([O-])c1ccc(C(OP(=O)(N2CC2)N2CC2)C(F)(F)F)c2ccccc12 ; O=[N+]([O-])c1ccc(COP(=O)(N2CC2)N2CC2)c2ccccc12 ; O=[N+]([O-])c1c(COP(=O)(N2CC2)N2CC2)ccc2ccccc12 ; CC(OP(=O)(N1CC1)N1CC1)c1ccc2ccccc2c1[N+](=O)[O-] ; O=[N+]([O-])c1c(C(OP(=O)(N2CC2)N2CC2)C(F)(F)F)ccc2ccccc12 ; O=[N+]([O-])c1cccc2ccc(COP(=O)(N3CC3)N3CC3)cc12] 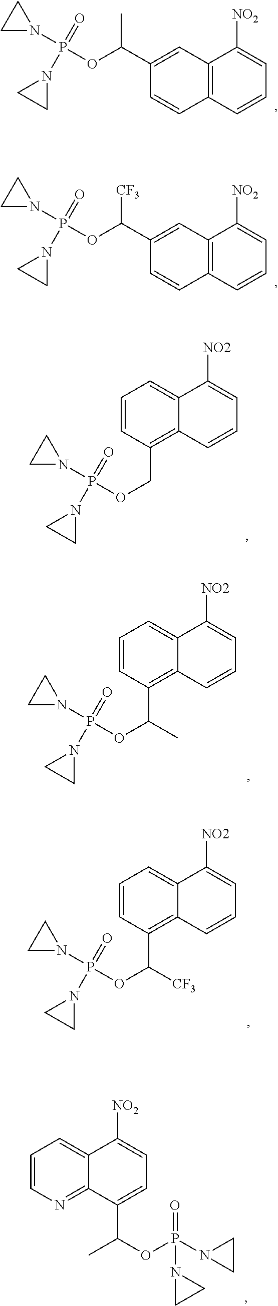 [SMILES: CC(OP(=O)(N1CC1)N1CC1)c1ccc2cccc([N+](=O)[O-])c2c1 ; O=[N+]([O-])c1cccc2ccc(C(OP(=O)(N3CC3)N3CC3)C(F)(F)F)cc12 ; O=[N+]([O-])c1cccc2c(COP(=O)(N3CC3)N3CC3)cccc12 ; CC(OP(=O)(N1CC1)N1CC1)c1cccc2c([N+](=O)[O-])cccc12 ; O=[N+]([O-])c1cccc2c(C(OP(=O)(N3CC3)N3CC3)C(F)(F)F)cccc12 ; CC(OP(=O)(N1CC1)N1CC1)c1ccc([N+](=O)[O-])c2cccnc12] 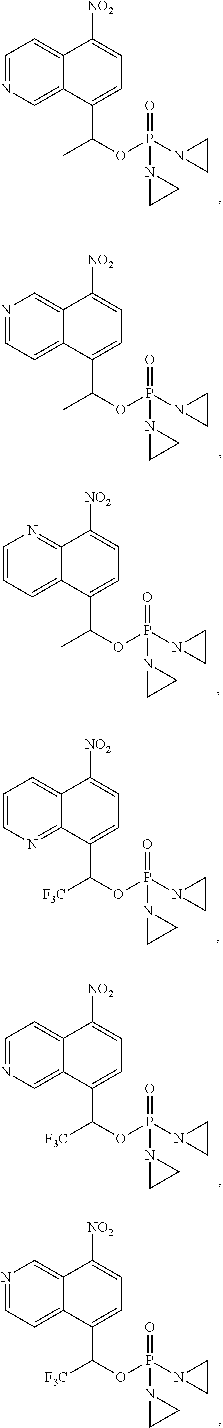 [SMILES: CC(OP(=O)(N1CC1)N1CC1)c1ccc([N+](=O)[O-])c2ccncc12 ; CC(OP(=O)(N1CC1)N1CC1)c1ccc([N+](=O)[O-])c2cnccc12 ; CC(OP(=O)(N1CC1)N1CC1)c1ccc([N+](=O)[O-])c2ncccc12 ; O=[N+]([O-])c1ccc(C(OP(=O)(N2CC2)N2CC2)C(F)(F)F)c2ncccc12 ; O=[N+]([O-])c1ccc(C(OP(=O)(N2CC2)N2CC2)C(F)(F)F)c2cnccc12 ; O=[N+]([O-])c1ccc(C(OP(=O)(N2CC2)N2CC2)C(F)(F)F)c2ccncc12] 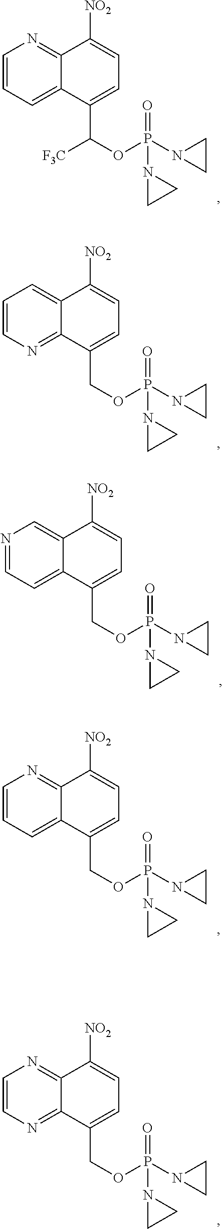 [SMILES: O=[N+]([O-])c1ccc(C(OP(=O)(N2CC2)N2CC2)C(F)(F)F)c2cccnc12 ; O=[N+]([O-])c1ccc(COP(=O)(N2CC2)N2CC2)c2ncccc12 ; O=[N+]([O-])c1ccc(COP(=O)(N2CC2)N2CC2)c2ccncc12 ; O=[N+]([O-])c1ccc(COP(=O)(N2CC2)N2CC2)c2cccnc12 ; O=[N+]([O-])c1ccc(COP(=O)(N2CC2)N2CC2)c2nccnc12] 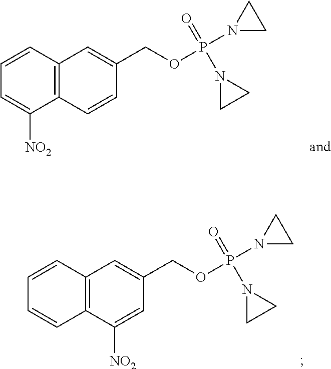 [SMILES: O=[N+]([O-])c1cccc2cc(COP(=O)(N3CC3)N3CC3)ccc12 ; O=[N+]([O-])c1cc(COP(=O)(N2CC2)N2CC2)cc2ccccc12]
Compound G is selected from compounds having the following structures: 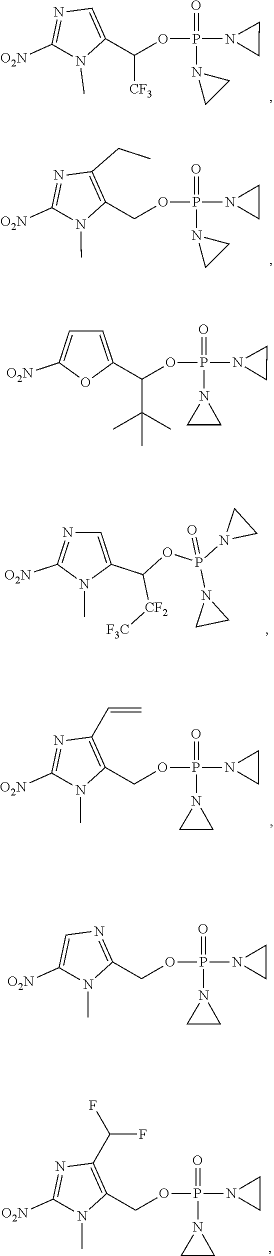 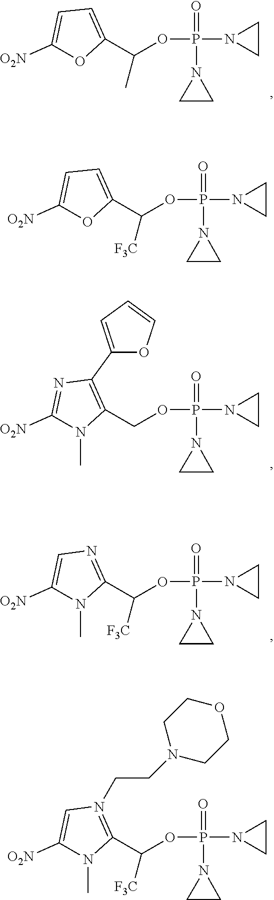 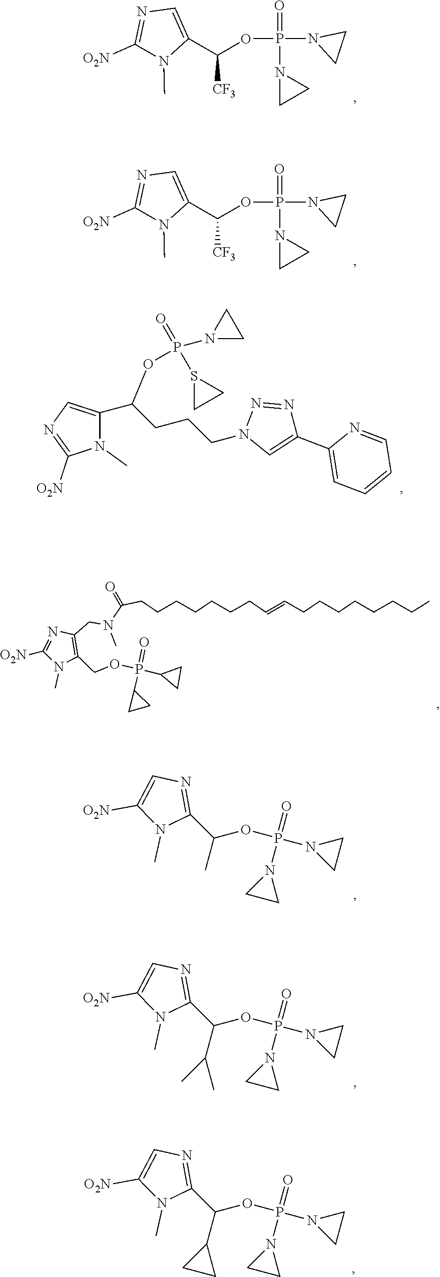 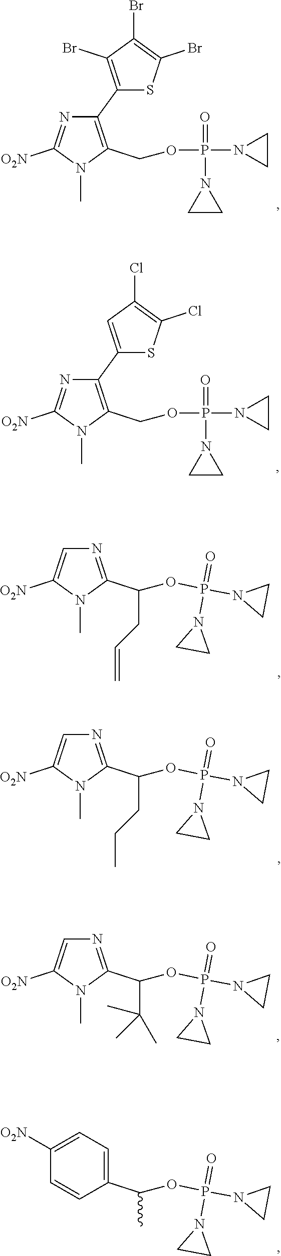 [SMILES: Cn1c([N+](=O)[O-])nc(-c2sc(Br)c(Br)c2Br)c1COP(=O)(N1CC1)N1CC1 ; Cn1c([N+](=O)[O-])nc(-c2cc(Cl)c(Cl)s2)c1COP(=O)(N1CC1)N1CC1 ; C=CCC(OP(=O)(N1CC1)N1CC1)c1ncc([N+](=O)[O-])n1C ; CCCC(OP(=O)(N1CC1)N1CC1)c1ncc([N+](=O)[O-])n1C ; Cn1c([N+](=O)[O-])cnc1C(OP(=O)(N1CC1)N1CC1)C(C)(C)C ; CC(OP(=O)(N1CC1)N1CC1)c1ccc([N+](=O)[O-])cc1] 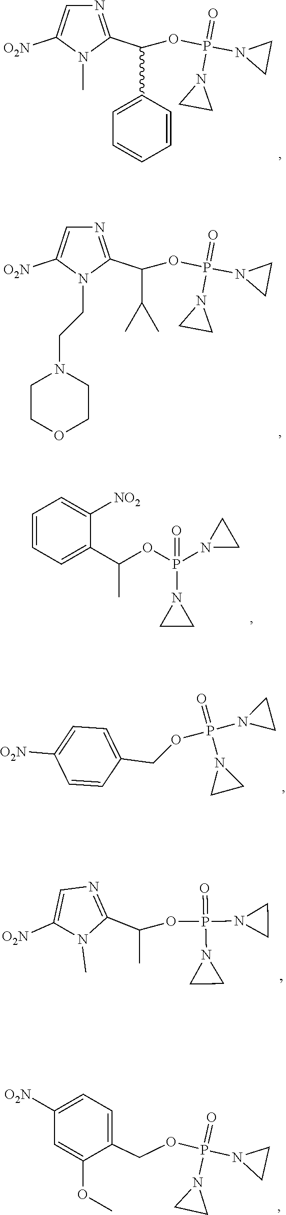 [SMILES: Cn1c([N+](=O)[O-])cnc1C(OP(=O)(N1CC1)N1CC1)c1ccccc1 ; CC(C)C(OP(=O)(N1CC1)N1CC1)c1ncc([N+](=O)[O-])n1CCN1CCOCC1 ; CC(OP(=O)(N1CC1)N1CC1)c1ccccc1[N+](=O)[O-] ; O=[N+]([O-])c1ccc(COP(=O)(N2CC2)N2CC2)cc1 ; CC(OP(=O)(N1CC1)N1CC1)c1ncc([N+](=O)[O-])n1C ; COc1cc([N+](=O)[O-])ccc1COP(=O)(N1CC1)N1CC1] 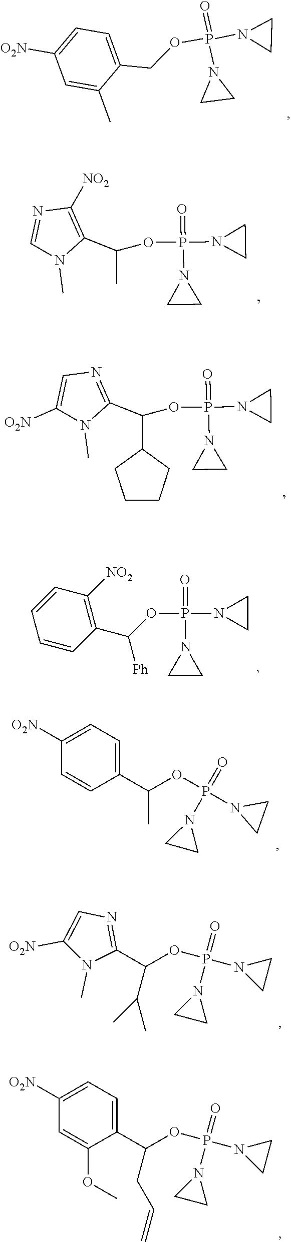 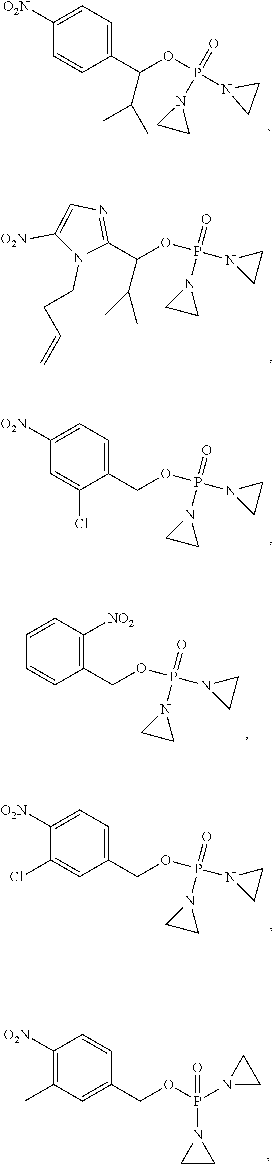 [SMILES: CC(C)C(OP(=O)(N1CC1)N1CC1)c1ccc([N+](=O)[O-])cc1 ; C=CCCn1c([N+](=O)[O-])cnc1C(OP(=O)(N1CC1)N1CC1)C(C)C ; O=[N+]([O-])c1ccc(COP(=O)(N2CC2)N2CC2)c(Cl)c1 ; O=[N+]([O-])c1ccccc1COP(=O)(N1CC1)N1CC1 ; O=[N+]([O-])c1ccc(COP(=O)(N2CC2)N2CC2)cc1Cl ; Cc1cc(COP(=O)(N2CC2)N2CC2)ccc1[N+](=O)[O-]] 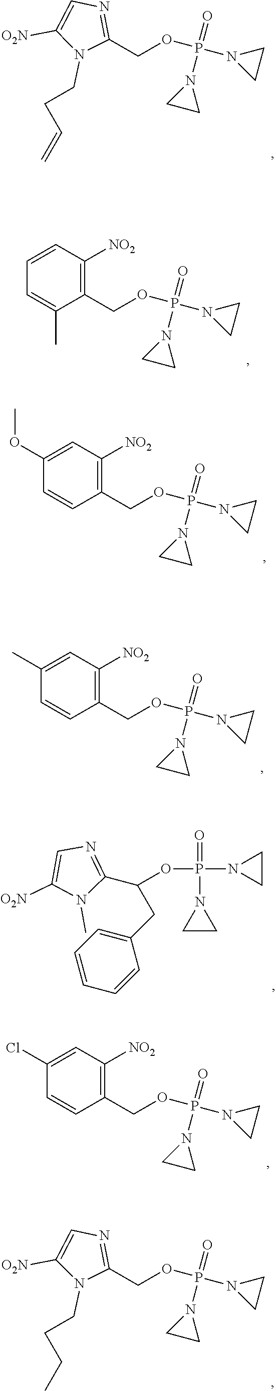 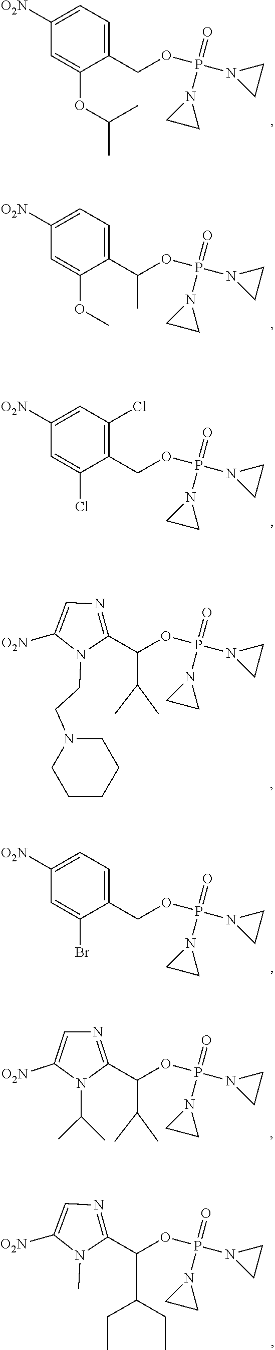 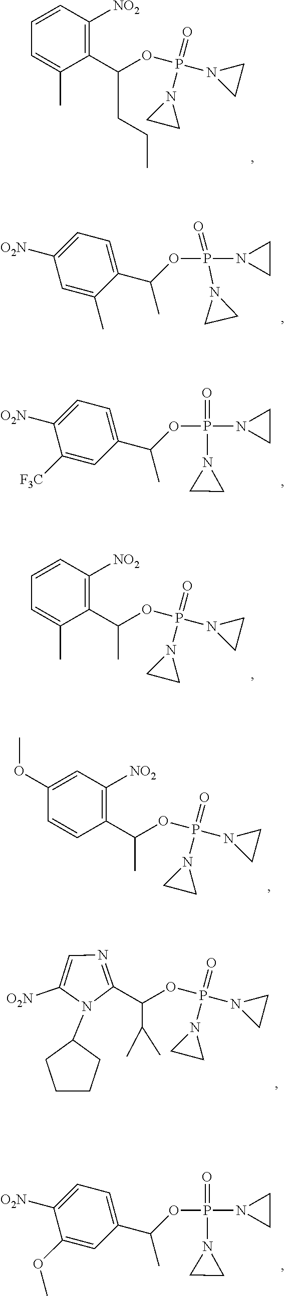 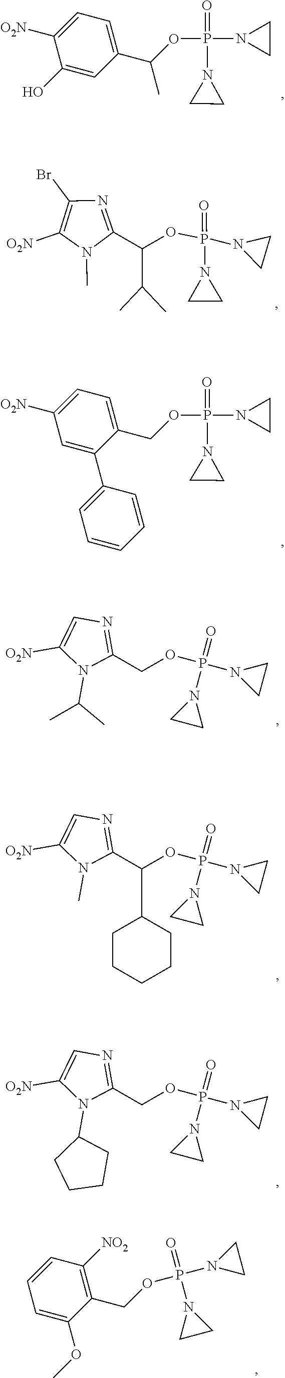 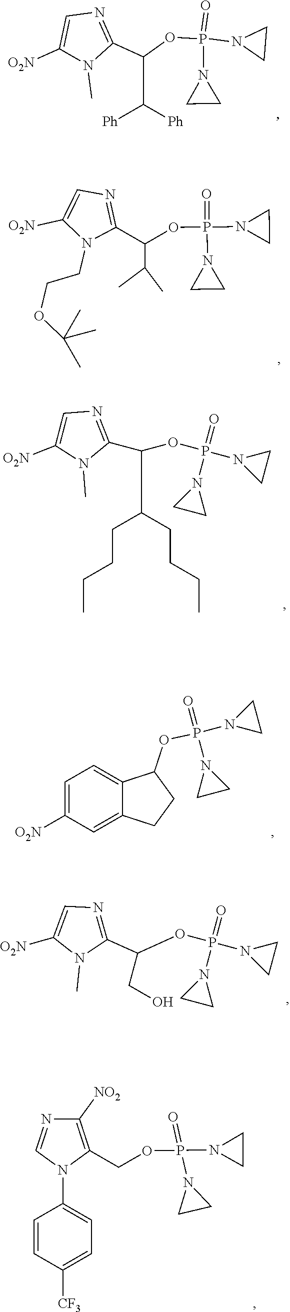 [SMILES: Cn1c([N+](=O)[O-])cnc1C(OP(=O)(N1CC1)N1CC1)C(c1ccccc1)c1ccccc1 ; CC(C)C(OP(=O)(N1CC1)N1CC1)c1ncc([N+](=O)[O-])n1CCOC(C)(C)C ; CCCCC(CCCC)C(OP(=O)(N1CC1)N1CC1)c1ncc([N+](=O)[O-])n1C ; O=[N+]([O-])c1ccc2c(c1)CCC2OP(=O)(N1CC1)N1CC1 ; Cn1c([N+](=O)[O-])cnc1C(CO)OP(=O)(N1CC1)N1CC1 ; O=[N+]([O-])c1ncn(-c2ccc(C(F)(F)F)cc2)c1COP(=O)(N1CC1)N1CC1] 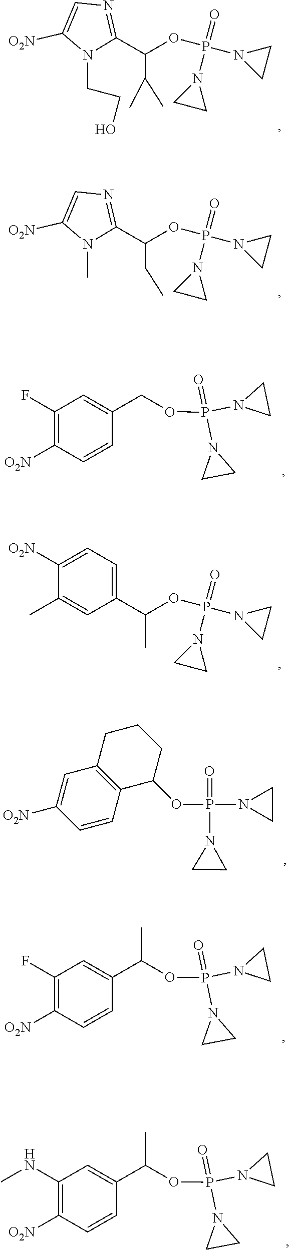 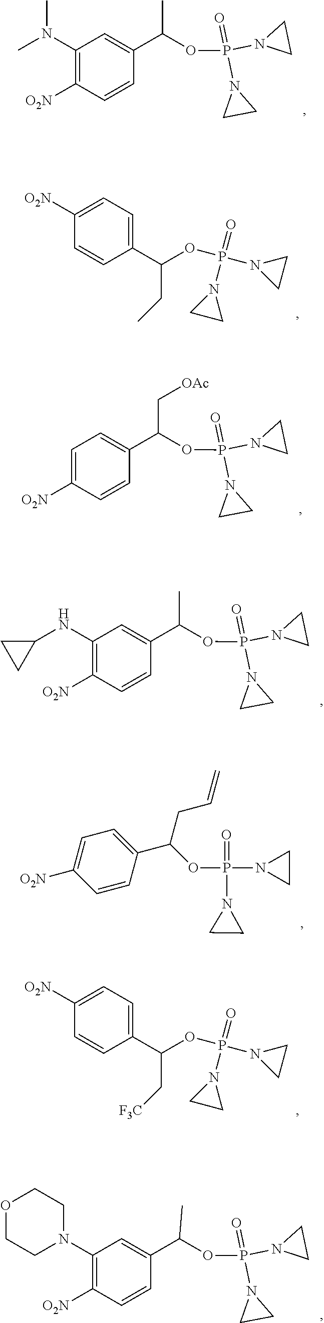 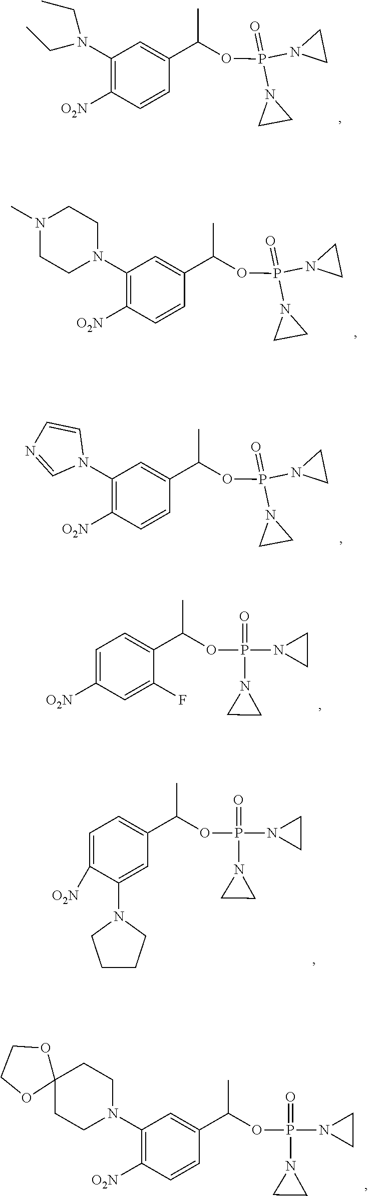 [SMILES: CCN(CC)c1cc(C(C)OP(=O)(N2CC2)N2CC2)ccc1[N+](=O)[O-] ; CC(OP(=O)(N1CC1)N1CC1)c1ccc([N+](=O)[O-])c(N2CCN(C)CC2)c1 ; CC(OP(=O)(N1CC1)N1CC1)c1ccc([N+](=O)[O-])c(-n2ccnc2)c1 ; CC(OP(=O)(N1CC1)N1CC1)c1ccc([N+](=O)[O-])cc1F ; CC(OP(=O)(N1CC1)N1CC1)c1ccc([N+](=O)[O-])c(N2CCCC2)c1 ; CC(OP(=O)(N1CC1)N1CC1)c1ccc([N+](=O)[O-])c(N2CCC3(CC2)OCCO3)c1] 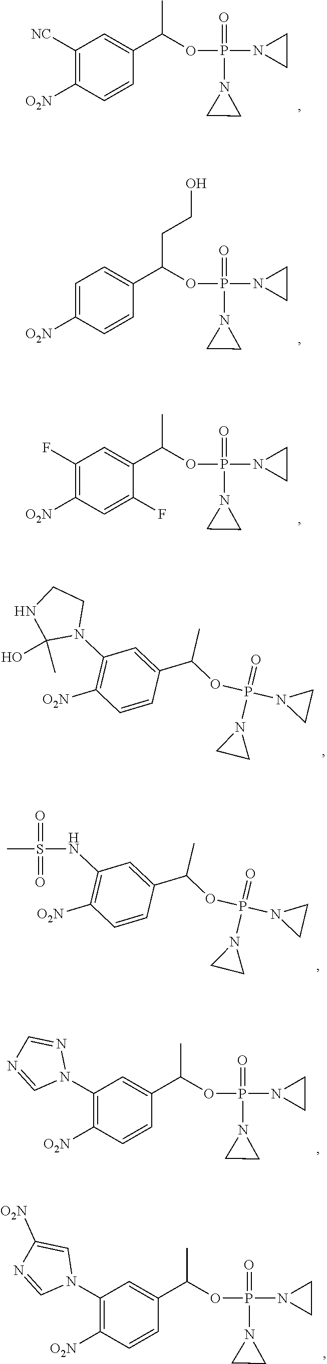 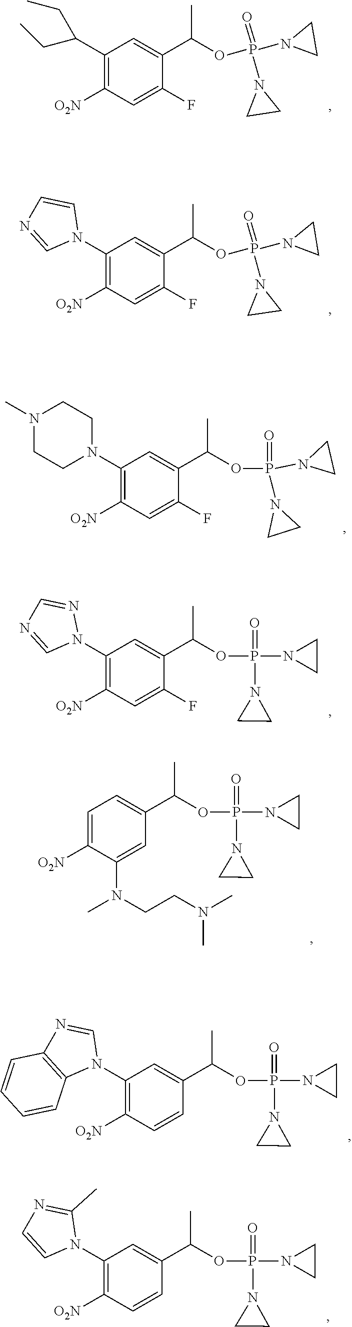 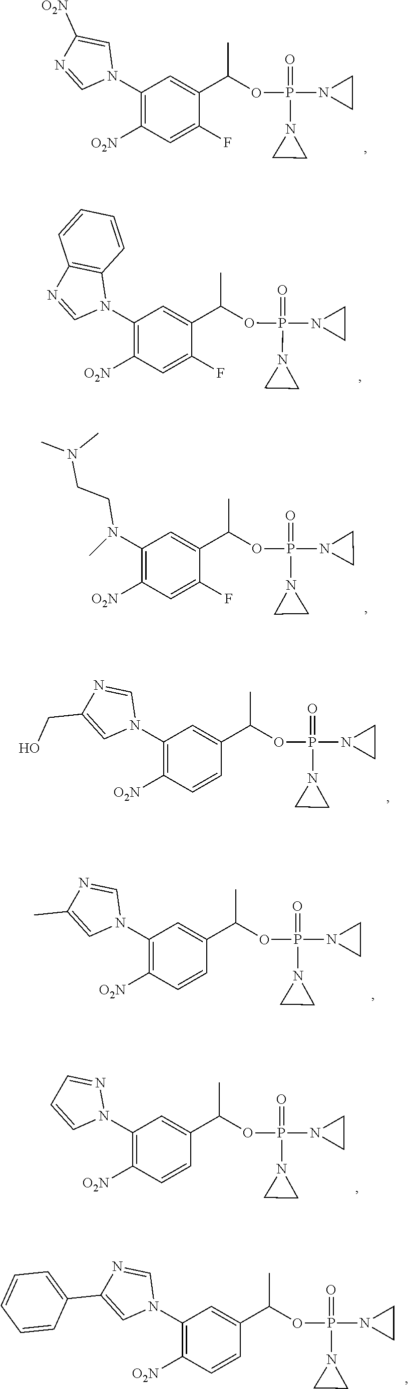 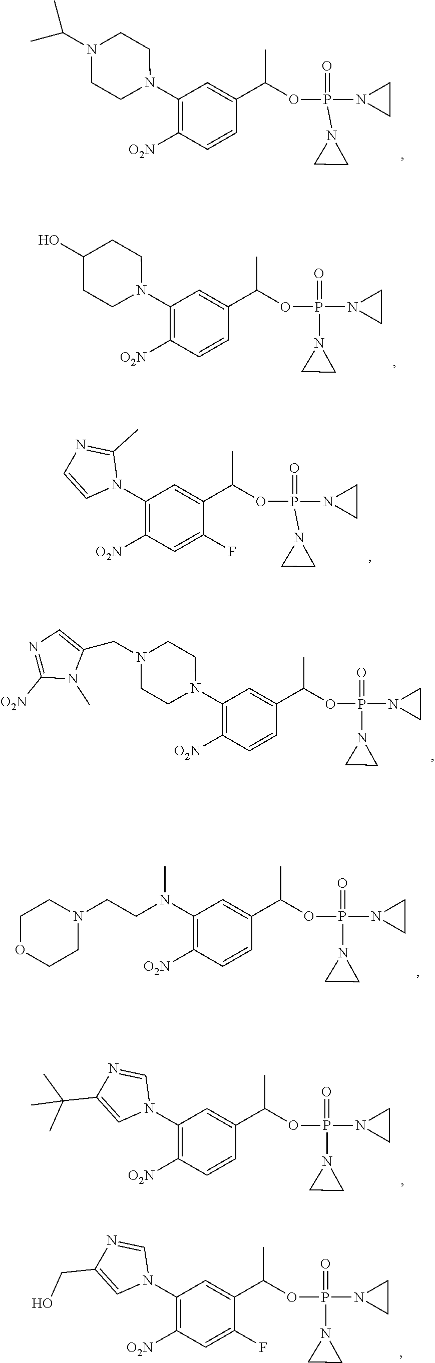 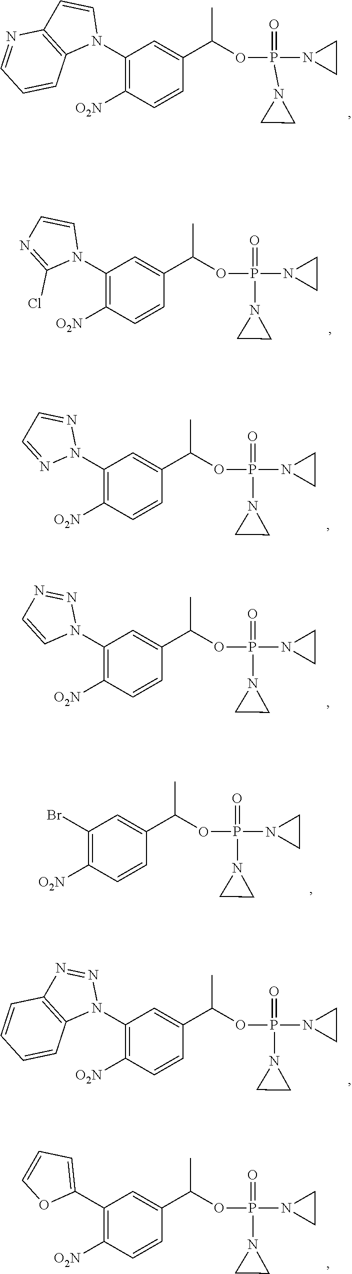 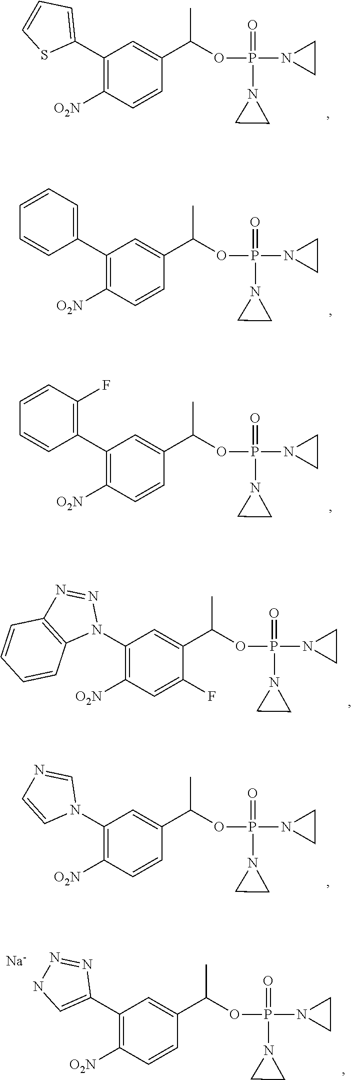 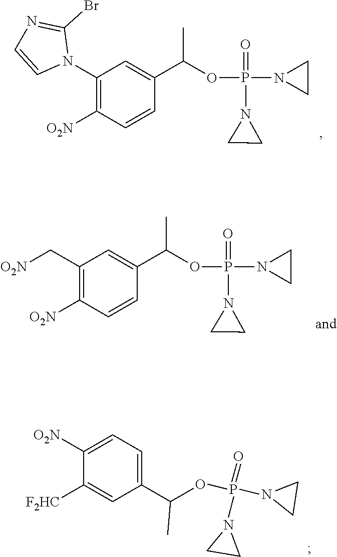 [SMILES: CC(OP(=O)(N1CC1)N1CC1)c1ccc([N+](=O)[O-])c(-n2ccnc2Br)c1 ; CC(OP(=O)(N1CC1)N1CC1)c1ccc([N+](=O)[O-])c(C[N+](=O)[O-])c1 ; CC(OP(=O)(N1CC1)N1CC1)c1ccc([N+](=O)[O-])c(C(F)F)c1]
Compound H is selected from compounds having the following structures:

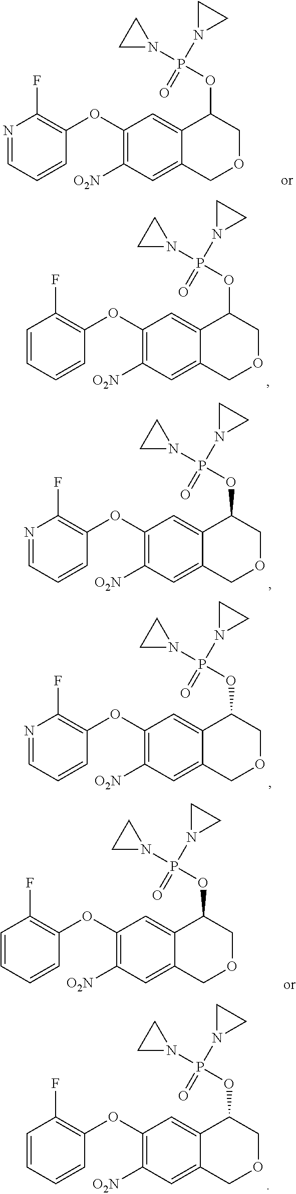

16. A method for detection of HPLC purity of Br-IPM, characterized in that the method uses any one or more of the following detection parameters:
a reversed-phase C18 column is used as a chromatographic column for separation;
an ultraviolet detector is used for detection, with a detection wavelength of 210 nm;
a two-phase eluent is used for elution, with mobile phase A being a 0.1% phosphoric acid solution, and mobile phase B being acetonitrile; and
a gradient elution procedure comprises varying the volume percentage of mobile phase A from 90% to 20%, and when the volume percentage of mobile phase A is 20%, isocratic elution is performed for a period of time.

17. The method for detection of HPLC purity according to claim 16, characterized in that the method uses any one or more of the following detection parameters:
the chromatographic column used is a Thermo Acclaim™ 120A C₁₈ column (250*4.6 mm), and the flow rate of the mobile phases is 0.7 ml/min; and
the elution procedure is as follows:

| | Volume | Volume |
|---|---|---|
| | percentage | percentage |
| | of mobile | of mobile |
| Time/min | phase A | phase B |
| 0 | 90 | 10 |
| 5 | 90 | 10 |
| 35 | 20 | 80 |
| 40 | 20 | 80 |
| 40.1 | 90 | 10 |
| 45 | 90 | 10 |

signal peaks of corresponding Br-IPM are detected by the ultraviolet detector within 12-15 minutes.

18. The method according to claim 13, characterized in that the X-IPM is a Br-IPM of a crystal form, characterized in that the crystal form of Br-IPM meets one of the following conditions:
a melting point of 106 to 107° C. as determined by melting point measurements;
an endothermic peak at 117.5-119.5° C. and an endothermic value of 1.65 to 1.85 mW/mg as determined by differential scanning calorimetry; and
an X-ray powder diffraction pattern represented by the diffraction angle 2θ with characteristic peaks at 7.77°, 15.57° and 19.01°, with an error not greater than 0.01° as determined by X-ray powder diffraction using Cu-Kα radiation.

19. The method according to claim 13, characterized in that the X-IPM is a Cl-IPM of a crystal form, characterized in that the crystal form of Cl-IPM meets one of the following conditions:
a melting point of 108 to 110° C. as determined by melting point measurements;
an endothermic peak at 120 to 128° C., and an endothermic value of 2.5 to 3.5 mW/mg as determined by differential scanning calorimetry; and
an X-ray powder diffraction pattern represented by the diffraction angle 2θ with characteristic peaks at 23.22°, 30.75° and 44.29°, with an error not greater than 0.01° as determined by X-ray powder diffraction using Cu-Kα radiation.

20. The method for detection of HPLC purity according to claim 16, characterized in that signal peaks of Br-IPM are detected by the ultraviolet detector when the volume percentage of mobile phase A is in the range of 20% to 40%.
